(19) United States
(12) Patent Application Publication
(10) Pub. No.: US 2005/0035034 A1
(43) Pub. Date: Feb. 17, 2005

(54) Currency processing device having a multiple stage transport path and method for operating the same

(76) Inventors: Richard M. Long, Bloomingdale, IL (US); Robert J. Klein, Chicago, IL (US)

Correspondence Address: Paul R. Kitch;CUMMINS-ALLISON CORP., c/o Jenkens & Gilchrist, 225 W. Washington Street, Suite 2600, Chicago, IL, 60606, US

(21) Appl. No.: 10/890,654

(22) Filed: Jul. 14, 2004

Related U.S. Application Data
(63) Continuation-in-part of application No. 10/754,044, filed on Jan. 7, 2004.
(60) Provisional application No. 60/441,148, filed on Jan. 17, 2003.

(51) Int. Cl. B07C 5/00

(52) U.S. Cl. 209/534

(57) ABSTRACT

A currency processing device is disclosed according to one embodiment of the present invention. The currency processing device comprises an input receptacle for receiving a stack of currency bills to be processed, a plurality of output receptacles for receiving currency bills that have been processed, an evaluation unit for determining information concerning each of the currency bills, a transportation mechanism for transporting each of the currency bills, one at a time, from the input receptacle past the evaluation unit to the plurality of output receptacles, and a controller for controlling the operation of the of the transport mechanism. The transportation mechanism includes. a first portion adapted to transport bills at a first speed and a second portion adapted to transport bills at a second speed.

### CROSS-REFERENCE TO RELATED APPLICATION

This application is a continuation-in-part of U.S. patent application Ser. No. 10/754,044, entitled “Currency Processing Device Having Multiple Stage Transport Path And Method For Operating The Same,” which was filed on Jan. 7, 2004. U.S. patent application Ser. No. 10/754,044 claims the benefit of U.S. Provisional Patent Application No. 60/441,148, entitled “Currency Processing Device Having Multiple Stage Transport Path And Method For Operating The Same,” which was filed on Jan. 17, 2003 and is incorporated herein by reference in its entirety.

### FIELD OF THE INVENTION

The present invention relates, in general, to document processing, and more particularly to a method and apparatus for currency processing including evaluating, discriminating, authenticating, sorting, or a combination thereof.

### BACKGROUND OF THE INVENTION

A variety of techniques and apparatus have been used in automated currency handling systems. Some currency handling systems include a plurality of output receptacles for sorting bills, off-sorting rejected bills, or both. Error conditions can arise in currency handling systems having a plurality of output receptacles when two consecutive bills targeted for different output receptacles are transported too close to one anther. Because of the insufficient distance between these closely-spaced consecutive bills, a diverter for diverting bills into different output receptacles is unable to appropriately act, and both bills are transported to one of the output receptacles resulting in an error condition often requiring the reprocessing of the entire batch of bills. The present invention is directing to reducing the occurrences of a bill being directed to an incorrect output receptacle.

### SUMMARY OF THE INVENTION

A currency processing device is disclosed according to one embodiment of the present invention. The currency processing device comprises an input receptacle for receiving a stack of currency bills to be processed, a plurality of output receptacles for receiving currency bills that have been processed, an evaluation unit for determining information concerning each of the currency bills, a transportation mechanism for transporting each of the currency bills, one at a time, from the input receptacle past the evaluation unit to the plurality of output receptacles, and a controller for controlling the operation of the of the transport mechanism. The transportation mechanism includes a first portion adapted to transport bills at a first speed and a second portion adapted to transport bills at a second speed. The controller is adapted to cause the transport mechanism to transport each of the bills to one of the plurality of output receptacles in response to the information concerning each of the bills determined by evaluation unit. The controller is adapted to cause the first portion and the second portion of the transport mechanism to transport bills at substantially the same speed when the distance between consecutive bills transported by the transport mechanism is at least a predetermined distance. The controller is adapted to cause the first portion of the transport mechanism to slow the speed at which bills are transported such that the first speed is less than the second speed when the evaluation unit determines when the distance between two consecutive bills transported by the transport mechanism is less than the predetermined distance.

The above summary of the present invention is not intended to represent each embodiment, or every aspect, of the present invention. Additional features and benefits of the present invention are apparent from the detailed description, figures, and embodiments set forth below.

### BRIEF DESCRIPTION OF THE DRAWINGS

FIG. 1a is a side view of a currency processing device having two output receptacles according to one embodiment of the present invention.

FIG. 1b is another perspective view of the currency processing device of FIG. 1a.

FIG. 2 is a side view of an currency processing device of FIG. 1a.

FIG. 3 is a side view depicting a stripping wheel according to one embodiment.

FIG. 4 is a sectional side view taken across a currency pathway depicting a bill in the region of an evaluating mechanism according to one embodiment of the present invention.

FIG. 5 is a sectional bottom view depicting a portion of a transport plate illustrating H-shaped leaf springs in conjunction with passive rolls according to one embodiment.

FIG. 6 is a top view of a currency processing device depicting various shafts according to one embodiment of the present invention.

FIG. 7a is a sectional side view of a transport plate according to one embodiment of the present invention.

FIG. 7b is a front view of a first region of a transport plate according to one embodiment of the present invention.

FIG. 7c is a sectional side view of the first region of a transport plate depicted in FIG. 7b.

FIG. 7d is a front view of a second region of a transport plate according to one embodiment of the present invention.

FIG. 7e is a sectional side view of the second region of a transport plate depicted in FIG. 7d.

FIG. 8a is a sectional side view taken across a currency pathway depicting a bill passing below a first follower plate according to one embodiment of the present invention.

FIG. 8b is a sectional side view of a first follower plate according to one embodiment of the present invention.

FIG. 8c is a front view of the first follower plate depicted in FIG. 8b.

FIG. 9a is a sectional side view taken across a currency pathway depicting a bill passing below a second follower plate according to one embodiment of the present invention.

FIG. 9b is a sectional side view of a second follower plate according to one embodiment of the present invention.

FIG. 9c is a front view of the second follower plate depicted in FIG. 9b.

FIG. 10a is a side view of a two-output-receptacle currency processing device in an open position according to one embodiment of the present invention.

FIG. 10b is another side view of a two-output-receptacle currency processing device in an open position according to one embodiment of the present invention.

FIG. 11 a is a top view of a transport plate according to one embodiment of the present invention.

FIG. 11b is a side view of a transport plate according to one embodiment of the present invention.

FIG. 12a is a side view of a currency processing device having three output receptacles according to one embodiment of the present invention.

FIG. 12b is a side view of a currency processing device having four output receptacles according to one embodiment of the present invention.

FIG. 12c is a side view of a currency processing device having six output receptacles according to one embodiment of the present invention.

FIG. 13 is a sectional view taken approximately through the center of two-output-receptacle currency processing device.

FIG. 14a is a sectional view of a scanhead according to one embodiment.

FIG. 14b is an end elevation of a upper support member which includes an upper scanhead and a sectional view of a lower support member mounted beneath a upper support member according to one embodiment.

FIG. 15 is a top view of an upper support member which includes an upper scanhead according to one embodiment.

FIG. 16 is a bottom view of an upper support member which includes an upper scanhead according to one embodiment.

FIG. 17 is a functional block diagram illustrating a currency processing device according to one embodiment of the present invention.

FIG. 18 is a functional block diagram illustrating a two-output-receptacle currency processing device according to one embodiment of the present invention;

FIG. 19 is a front view of a control panel for a currency processing device according to one embodiment of the present invention.

FIG. 20 is a touch screen display for a currency processing device for a according to one embodiment of the present invention.

FIGS. 21-33 illustrate various touch screen displays for a currency processing device according to various alternative embodiments of the present invention.

FIG. 34 is a numerical keypad for a currency processing device according to one embodiment of the present invention.

FIGS. 35-40 illustrate examples of operating parameter selection screens for a currency processing device.

FIGS. 41 and 42 are tables summarizing various embodiments of several operating modes for a currency processing device.

FIG. 43 is a side view of a currency processing device depicting the upper portion and the lower portion of a transport mechanism according to one embodiment of the present invention.

FIG. 44 is another side view of a currency processing device depicting the upper portion and the lower portion of a transport mechanism according to one embodiment of the present invention.

FIG. 45 is a function block diagram illustrating the control system of the transport mechanism according to one embodiment of the present invention.

FIG. 46. is a flow chart illustrating the operation of the currency processing device according to one embodiment of the present invention.

FIG. 47 is a flow chart illustrating the operation of the currency processing device according to another embodiment of the present invention.

FIG. 48 is a side view of a currency processing device depicting the upper portion and the lower portion of a transport mechanism according to another embodiment of the present invention.

While the invention is susceptible to various modifications and alternative forms, specific embodiments are shown by way of example in the drawings and are described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF THE ILLUSTRATED EMBODIMENTS

The transport mechanism of the present invention may be used and incorporated in a currency processing device that sorts, analyzes, transports, evaluates, authenticates, discriminates, counts or otherwise processes currency bills. In other embodiments, the transport mechanism of the present invention may be employed in devices that process other documents such as, for example, stock certificates, bonds, postage stamps, and food stamps.

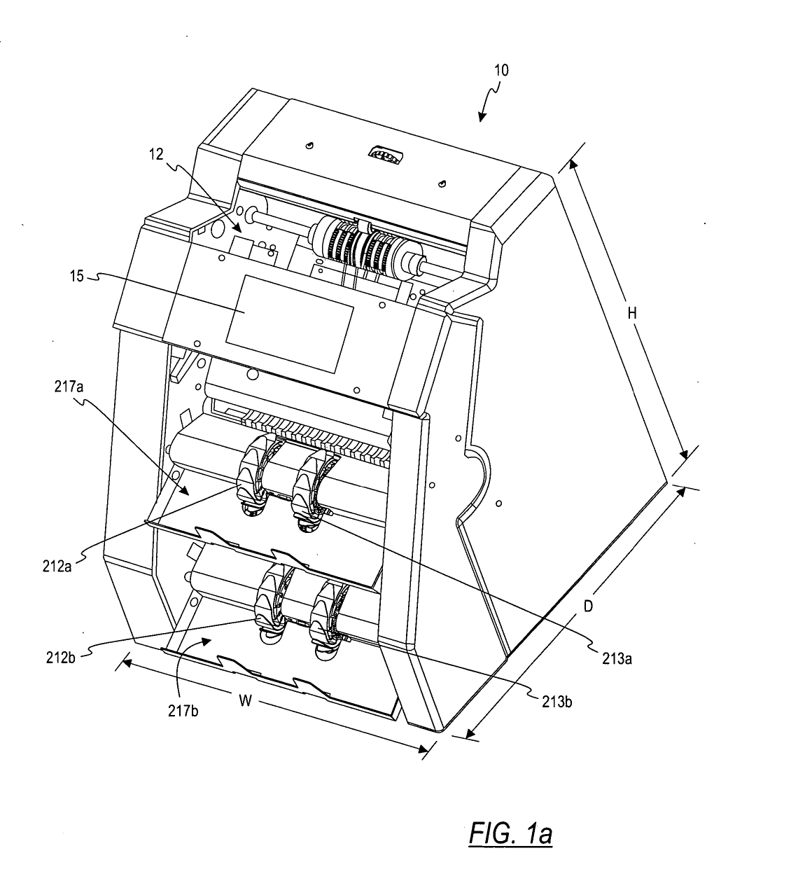

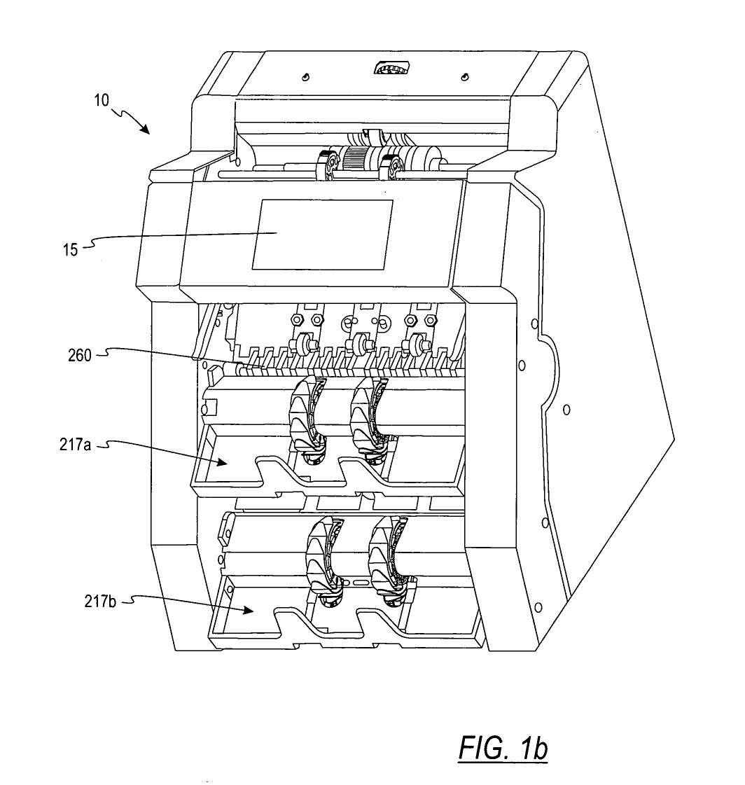

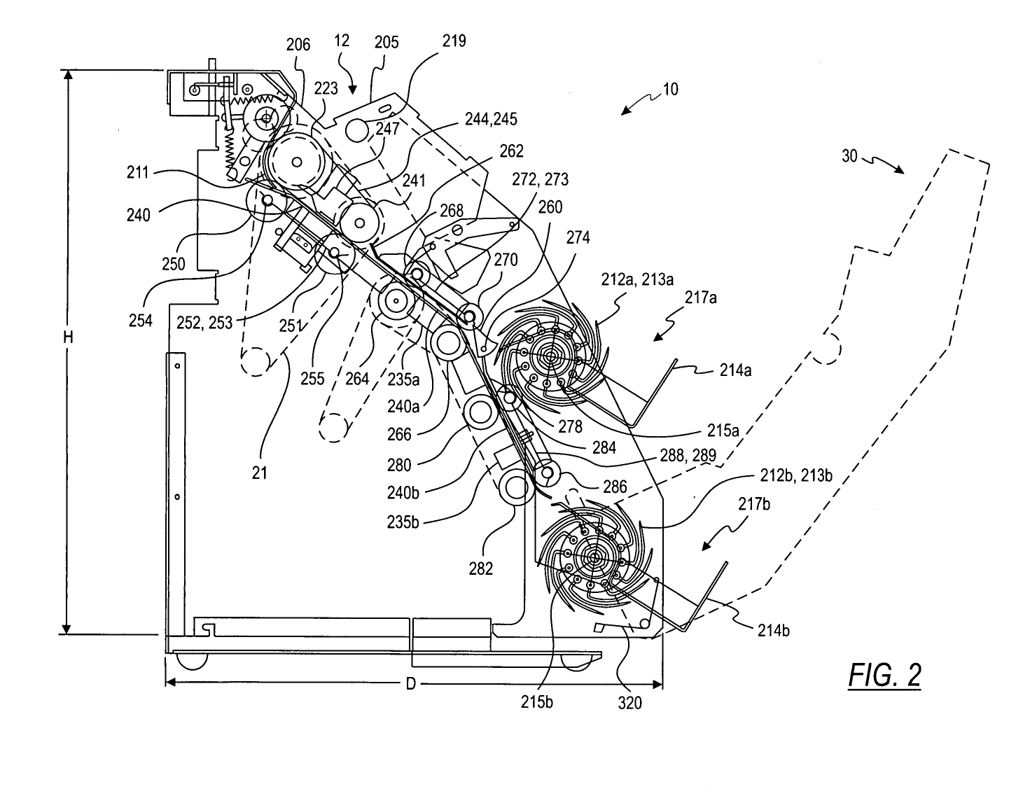

FIGS. 1a and 1b depict an exterior perspective view and FIG. 2 is a side view of a currency processing device having two output receptacles according to one embodiment of the present invention. The device 10 is compact having a height (H) of about 17½ inches (44.5 cm), width (W) of about 13½ inches (34.3 cm), and a depth (D) of about 15 inches (38.1 cm) and weighs approximately 35 lbs. (16 kg). The device 10 may be rested upon a tabletop.

In FIGS. 1a, 1b, and 2, currency bills are fed, one by one, from a stack of currency bills placed in an input receptacle 12 into a transport mechanism. The transport mechanism includes a transport plate or guide plate 240 for guiding currency bills to one of a plurality of output receptacles 217a and 217b. Before reaching the output receptacles 217a, 217b, a bill is evaluated, analyzed, authenticated, discriminated, counted and/or otherwise processed. The results of the above process or processes may be used to determine to which output receptacle 217a, 217b a bill is directed. In one embodiment, currency bills are transported, scanned, and identified at a rate equal to or greater than 600 bills per minute. In another embodiment, currency bills are transported, scanned, and identified at a rate equal to or greater than 800 bills per minute. In another embodiment, currency bills are transported, scanned, and identified at a rate equal to or greater than 1000 bills per minute. For currency bills, the identification may include the determination of the denomination of each bill.

The input receptacle 12 for receiving a stack of bills to be processed is formed by downwardly sloping and converging walls 205 and 206 (FIG. 2) formed by a pair of removable covers (not shown) which snap onto a frame. The converging wall 206 supports a removable hopper (not shown) that includes vertically disposed side walls (not shown). One embodiment of an input receptacle for a currency processing device is described and illustrated in detail in U.S. Pat. No. 5,687,963, which is incorporated herein by reference in its entirety. The currency processing device 10 in FIGS. 1a and 1b has a touch panel display 15 in one embodiment of the present invention, which displays appropriate “functional” keys when appropriate. The touch panel display 15 simplifies the operation of the multi-pocket currency processing device 10. The touch panel display 15 may be a full graphics display. Alternatively or additionally, physical keys or buttons may be employed.

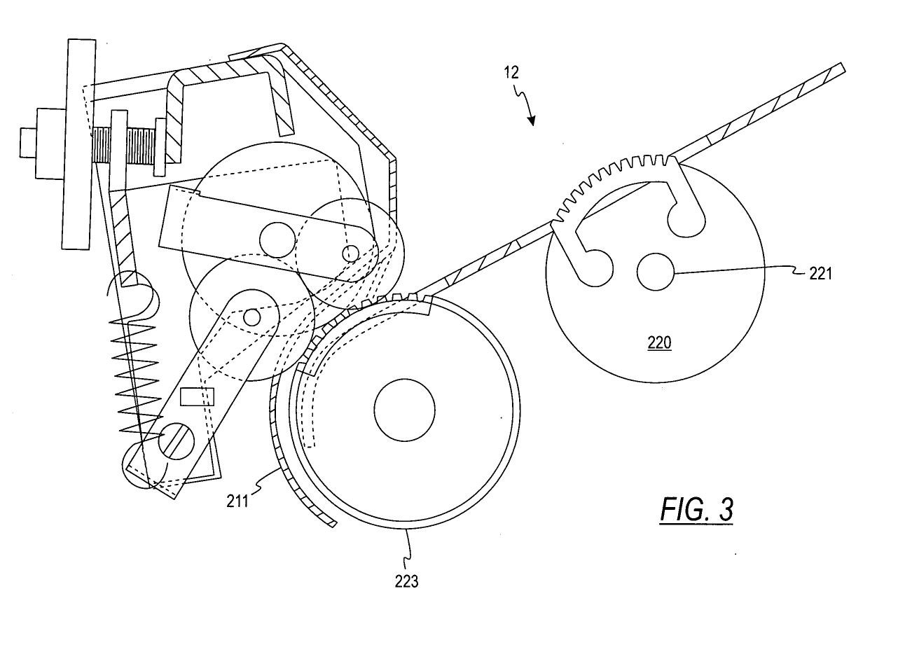

From the input receptacle 12, the currency bills are moved in seriatim from the bottom of a stack of bills along a curved guideway 211 (FIG. 2) that receives bills moving downwardly and rearwardly and changes the direction of travel to a forward direction. A stripping wheel 220 (FIG. 3) mounted on a stripping wheel shaft 219 aids in feeding the bills to the curved guideway 211. The curvature of the guideway 211 corresponds substantially to the curved periphery of a drive roll 223 so as to form a narrow passageway for the bills along the rear side of the drive roll 223. An exit end of the curved guideway 211 directs the bills onto the transport plate 240 which carries the bills through an evaluation section and to one of the output receptacles 217a, 217b.

A pair of driven stacking wheels 212a and 213a for the first or upper output receptacle 217a and by a pair of stacking wheels 212b and 213b for the second or bottom output receptacle 217b stack bills in the first 217a and second 217b output receptacles, respectively. The stacker wheels 212a,b and 213a,b are supported for rotational movement about respective shafts 215a,b journalled on a rigid frame and driven by a motor (not shown). Flexible blades of the stacker wheels 212a and 213a deliver the bills onto a forward end of a stacker plate 214a. Similarly, the flexible blades of the stacker wheels 212b and 213b deliver the bills onto a forward end of a stacker plate 214b.

A diverter 260 directs the bills to either the first or second output receptacle 217a, 217b. When the diverter is in a lower position, bills are directed to the first output receptacle 217a. When the diverter 260 is in an upper position, bills proceed in the direction of the second output receptacle 217b.

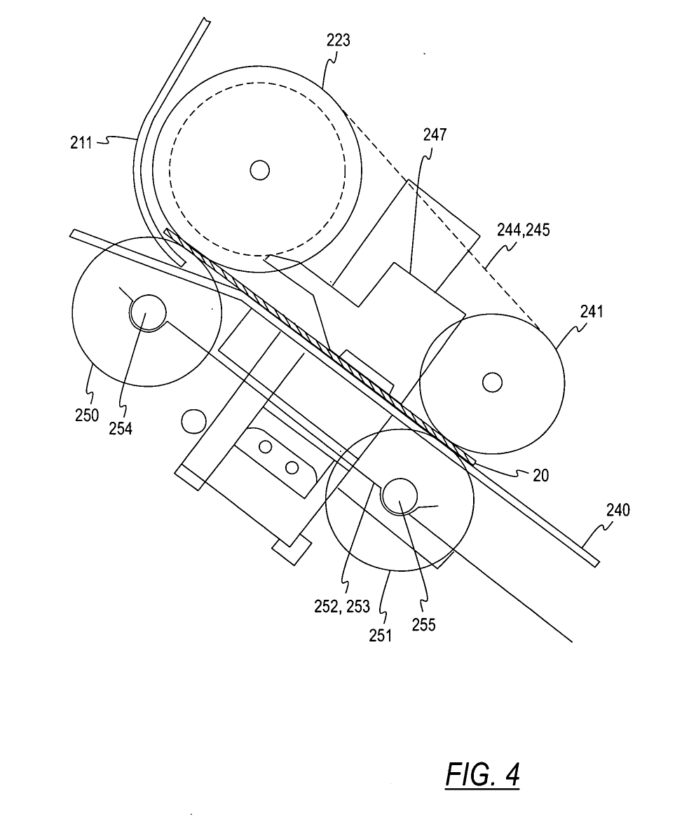

Referring also to FIG. 4, at a lower end of the curved guideway 211, a bill 20 being transported by the drive roll 223 engages the transport plate 240. Bills are positively driven along the transport plate 240 by means of a transport roll arrangement comprising both driven and passive rolls. A pair of O-rings 244 and 245 fit into grooves formed in a drive roll 241 and in the drive roll 223. The pair of O-rings 244 and 245 engage the bill 20 continuously between the two driven upper rolls 223 and 241 and assist in holding the bill 20 flat against the transport plate 240. Such an embodiment aids to the performance of the sensors of the evaluation region 247. Rolls 223 and 241 are driven by a motor (not shown) via a belt 21. Such an arrangement is illustrated in more detail in U.S. Pat. No. 5,687,963 referred to above.

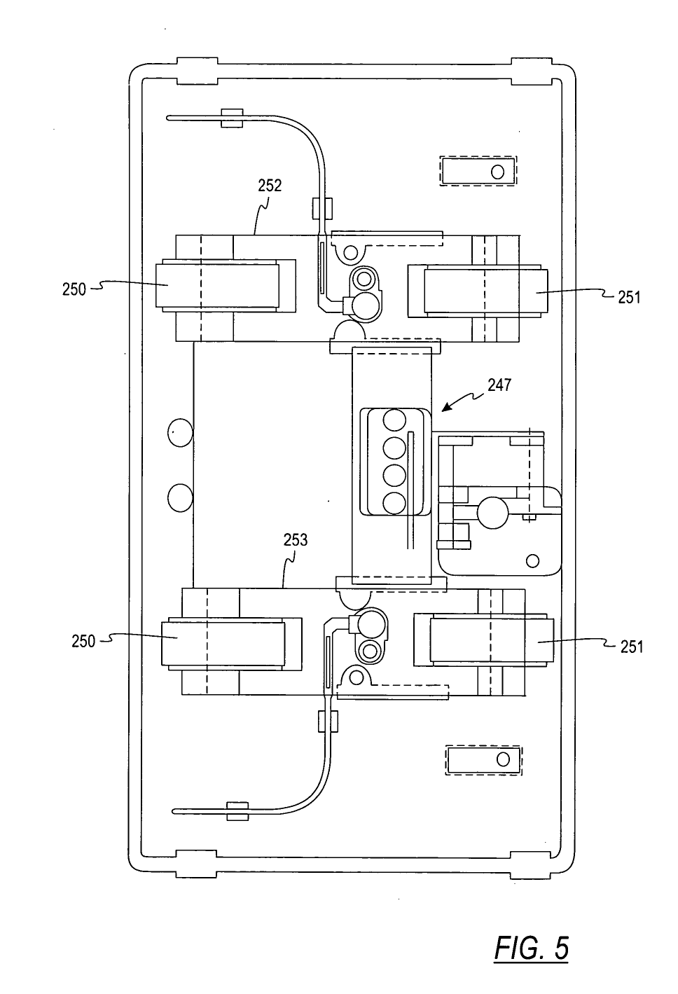

Passive rolls 250, 251 are mounted on an underside of the transport plate 240 in such a manner as to be freewheeling about their respective axes 254 and 255 and biased into counter-rotating contact with their corresponding driven upper rolls 223 and 241. The passive rolls 250 and 251 have high-friction rubber surfaces and are biased into contact with their respective driven upper rolls 223 and 241 by a pair of H-shaped leaf springs 252 and 253 (FIG. 5). The central portion of each leaf spring is fastened to the transport plate 240, which is fastened rigidly to the device frame so that the relatively stiff arms of the H-shaped springs exert a constant biasing pressure against the passive rolls 250 and 251 and push them against the corresponding upper rolls 223 and 241.

The driven and passive transport rolls are coplanar with a flat upper surface of the transport plate 240 so that currency bills can be positively driven along the top surface of the plate in a flat manner. To minimize the possibility of bill skew and to enhance the reliability of the overall scanning and recognition process, the bills are firmly gripped under uniform pressure between the driven and passive rolls. The H-shaped leaf springs 252 and 253 aid in reducing bill twisting or skewing. The O-rings 244, 245 are also effective in ensuring that central portions of the bills are held flat. The distance between the axes of the two driven upper rolls 223 and 241 and the corresponding counter-rotating passive rolls 250 and 251 is selected to be just short of a length of a narrow dimension of the currency bills.

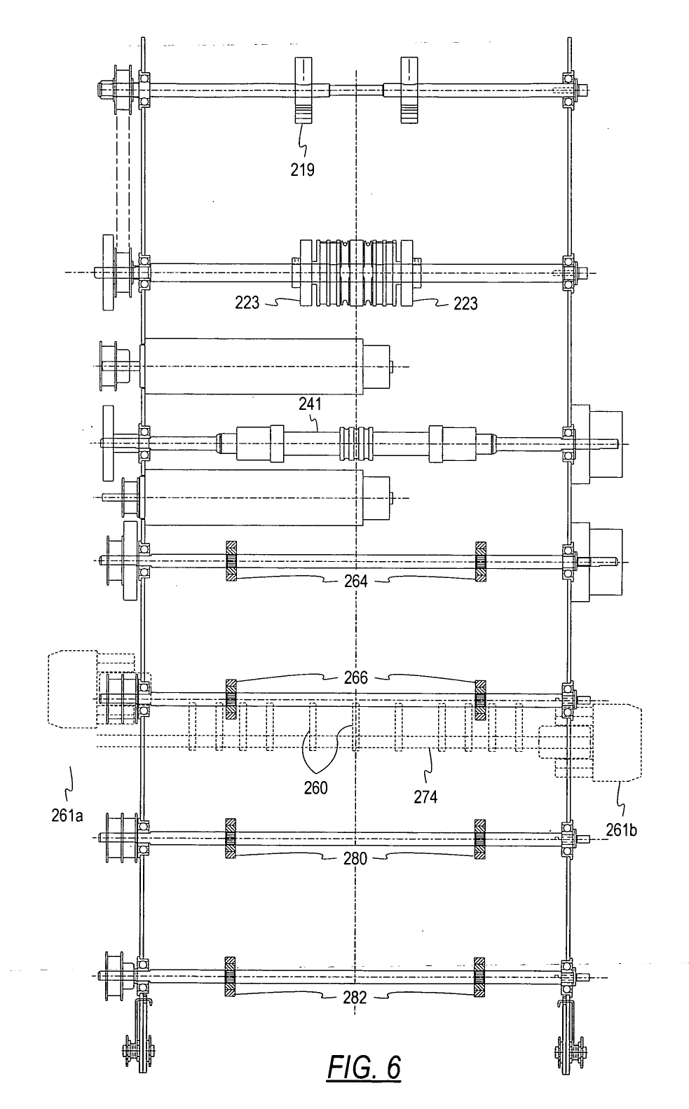

FIG. 6 depicts various shafts of the multi-pocket document evaluation device 10 according to one embodiment of the present invention. The distance between the shafts should preferably be less than the width of the bills that are to be evaluated.

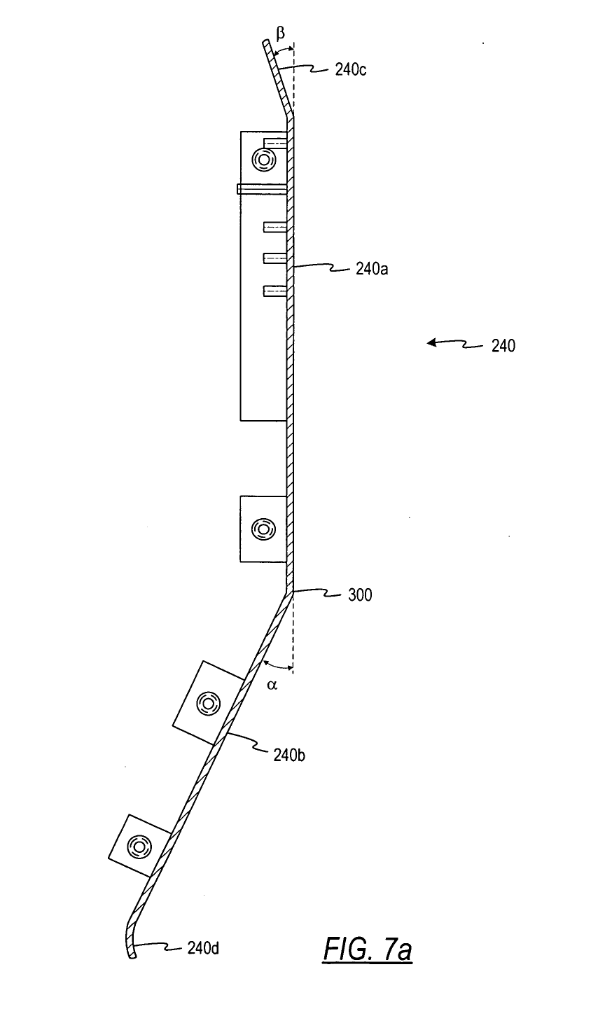

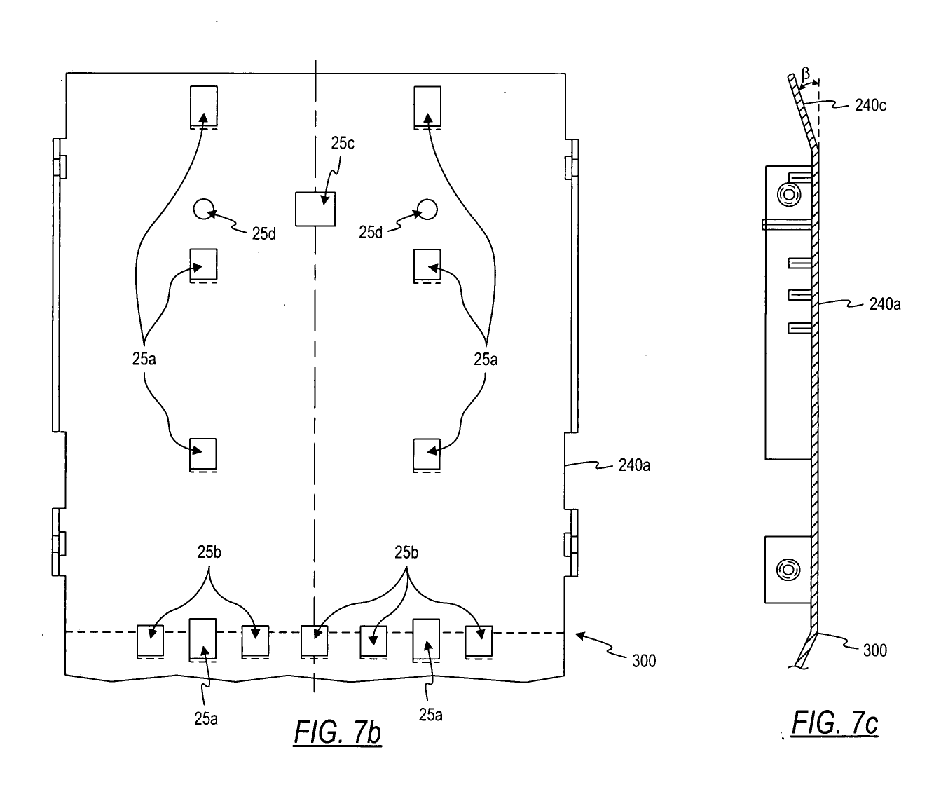

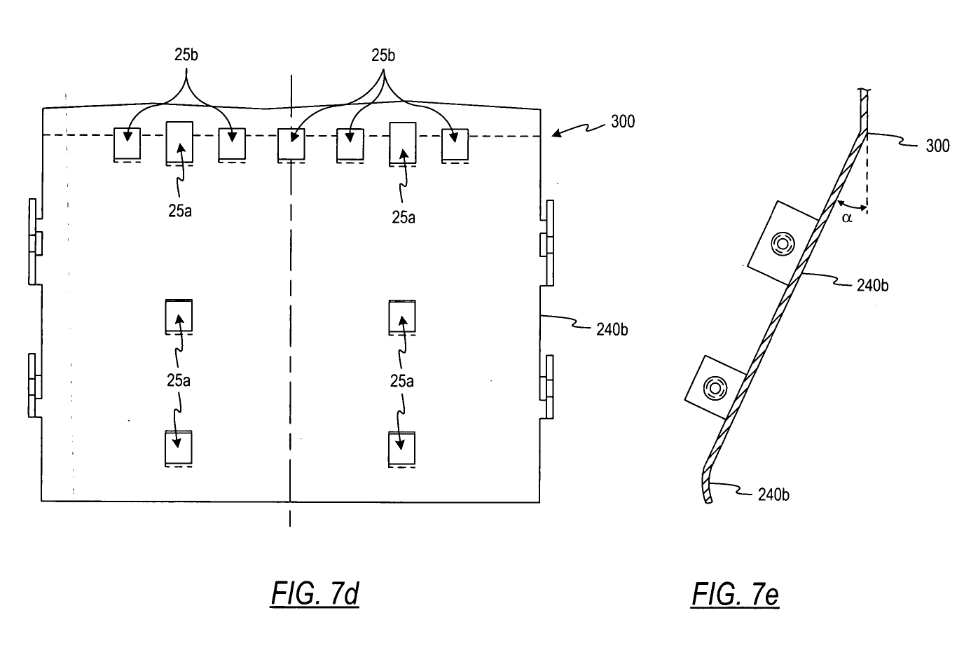

As best illustrated in FIG. 7a, according to one embodiment of the present invention the transport plate 240 is substantially flat and linear. The uncomplicated surfaces of the transport plate 240 have no protruding features. In one embodiment, there are no belts employed to engage and advance bills after they have been evaluated in the evaluation region 247. In this embodiment, the bills are delivered to an appropriate output receptacle 217a or 217b after being evaluated without the use of belts contacting the bills.

The transport plate 240 has a first substantially planar region 240a defining a first plane. The evaluation of bills is performed in the first substantially planar region 240a. The first substantially planar region 240a ends at a point 300. The transport plate 240 also has a second substantially planar region 240b defining a second plane. The second substantially planar region 240b begins at the point 300. The second substantially planar region extends up to a diverting flange 240d. In one embodiment, the first and second substantially planar regions 240a and 240b substantially define the entire region of the transport path from the evaluation mechanism to the plurality of output receptacles 217a,b.

In one embodiment, the second substantially planar region 240b does not deviate from the first substantially planar region 240a by more than about 90 degrees. In a second embodiment, the second region 240b does not deviate from the first region 240a by more than about 60 degrees. In a third embodiment, the second region 240b does not deviate from the first region 240a by more than about 45 degrees. In a fourth embodiment, the second region 240b does not deviate from the first region 240a by more than about 30 degrees. As depicted in FIG. 7a, the second region 240b is substantially planar with the first region 240a, deviating from the first region 240a by an angle of a degrees where a is about 26 degrees.

The transport plate 240 also has a third substantially planar region 240c defining a third plane. In one embodiment, the third substantially planar region 240c does not deviate by more than about 45 degrees from the first region 240a. In another embodiment, the third region 240c does not deviate by more than about 25 degrees from the first region 240a. As depicted in FIG. 7a, the third region 240c deviates from the first region 240a by an angle of β degrees where β is about 16 degrees.

The transport plate 240 has a plurality of apertures 25 therein. According to one embodiment, the apertures 25 are present only where necessary to facilitate the functioning of passive rolls and driven rolls and a diverter 260. According to another embodiment, the apertures 25 are present only where necessary to facilitate the functioning of passive and driven rolls, the diverter 260, and the various sensors such as scanheads, doubles detectors, and document location sensors. Apertures for sensors may covered with materials that do not interfere with the functioning of corresponding sensors while nonetheless facilitating the transport plate in appearing smooth and continuous to passing bills. For example, when optical sensors are being employed, corresponding apertures may contain lenses that are flush with the transport surface of the transport plate. Likewise, materials that do not interfere with the operation of magnetic sensors may be employed to cover any apertures created to facilitate their operation. Accordingly, such coverings essentially become part of the transport plate, effectively negating the existence of the corresponding apertures. Alternatively, the transport plate may be constructed from a material that does not interfere with the operation of such sensors so that no apertures need be created in the first place, e.g., a substantially optically clear plastic transport plate permitting the functioning of optical sensors.

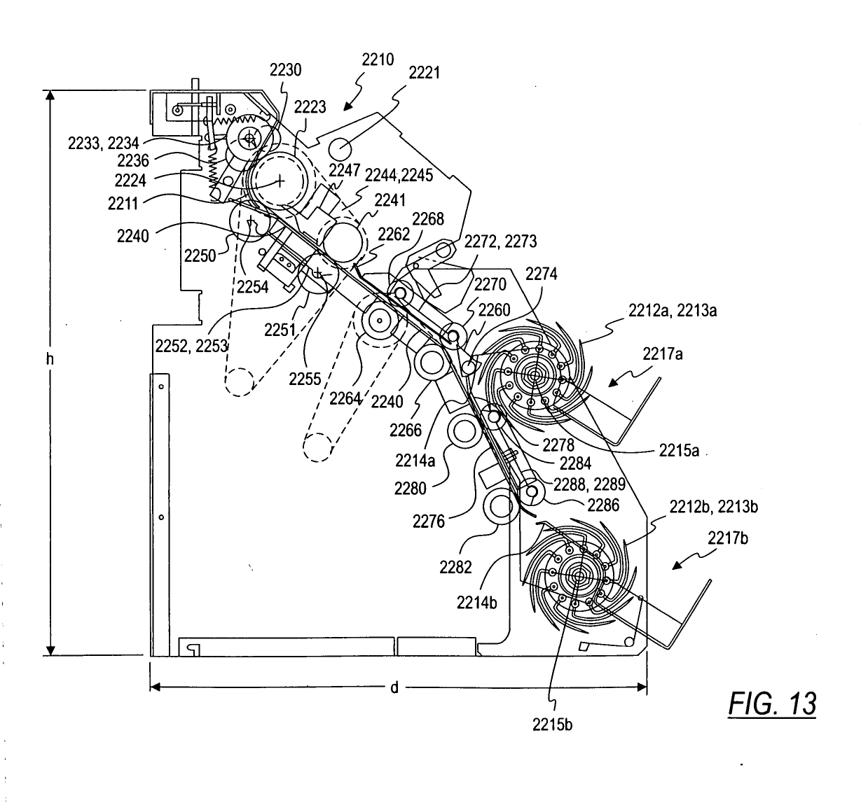

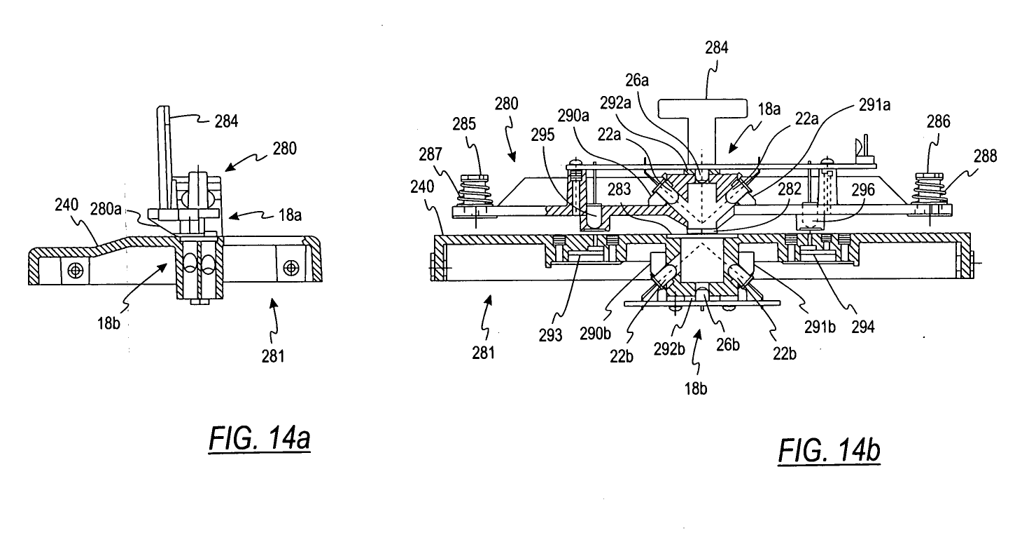

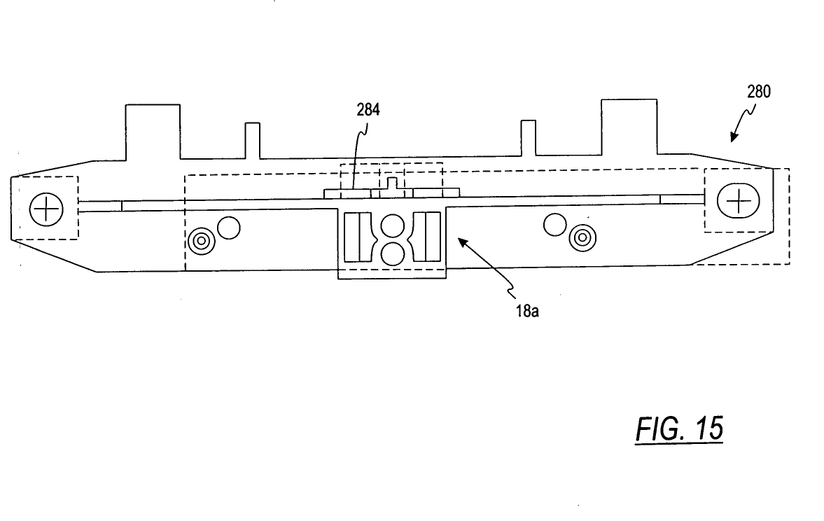

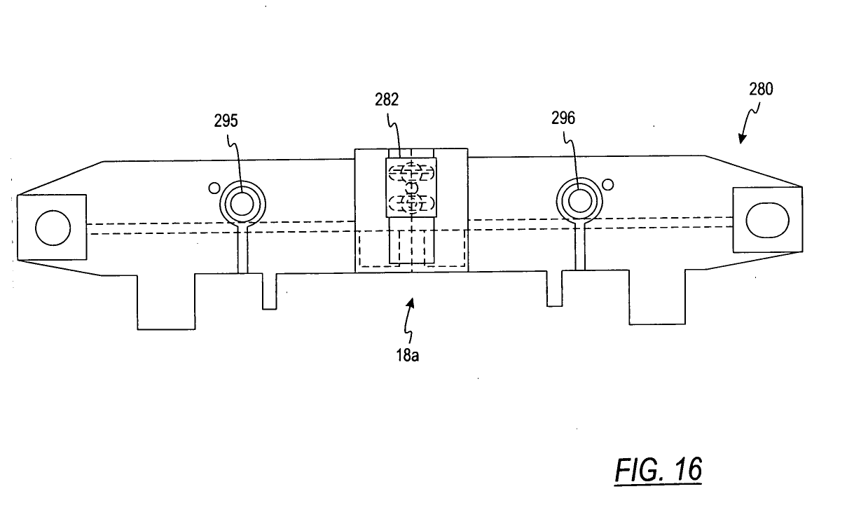

Apertures 25 in first region 240a of the transport plate 240 are shown in FIG. 7b. Apertures 25a permit passive and driven rolls to protrude into the currency pathway to thereby advance bills along the pathway. Apertures 25b permit ends of the diverter 260 to rotate below the upper surface of the transport plate 240. Aperture 25c permits a lower scanhead to read the underside of a passing document. The lower scanhead may be, for example, an optical scanhead. Apertures 25d provide access for doubles-detection sensors that determine whether two or more bills are being transported in a stacked or overlapping manner. An example of optical scanheads and double detection sensor are described in more detail in conjunction with FIGS. 13-16. Apertures 25c and 25d may contain lenses that are flush with the transport surface of the transport plate. Where apertures 25c and 25d contain such lenses, the transport plate 240a effectively contains only apertures 25a and 25b (i.e., apertures only for the transport rolls and the diverter).

Apertures 25a and 25b in a second region 240b of the transport plate 240 are shown in FIG. 7d. This clean and unobstructed transport plate 240 facilitates a reduction in the jamming of the currency bills as well as facilitating the ease with which jammed bills can be removed from the device 10.

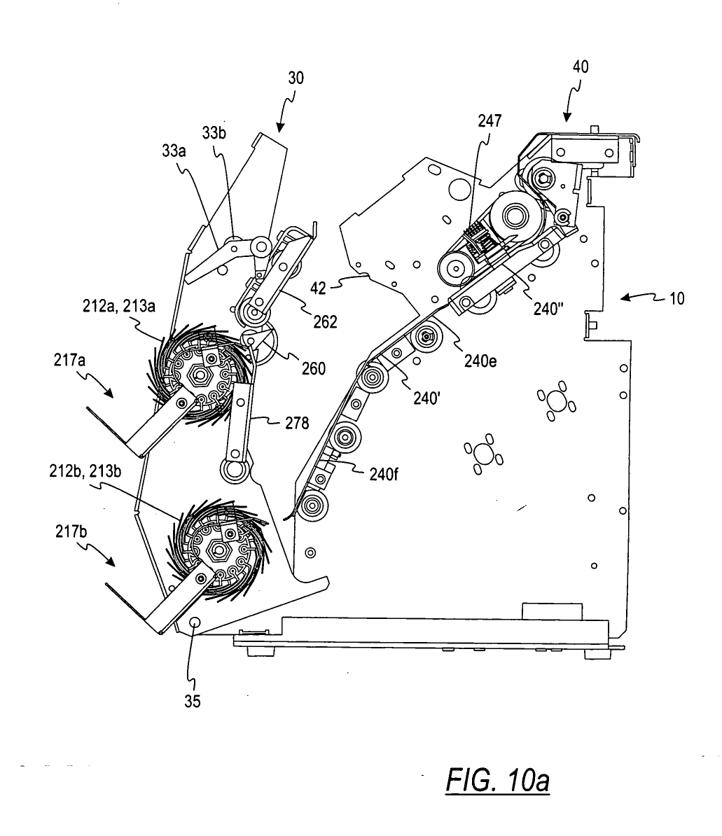

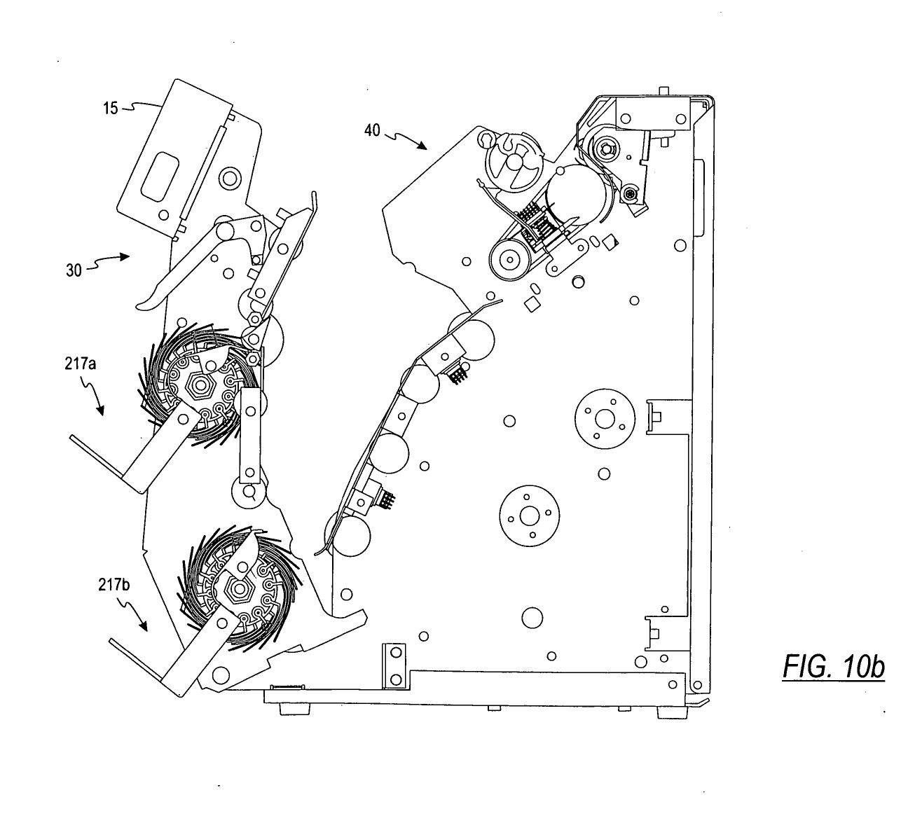

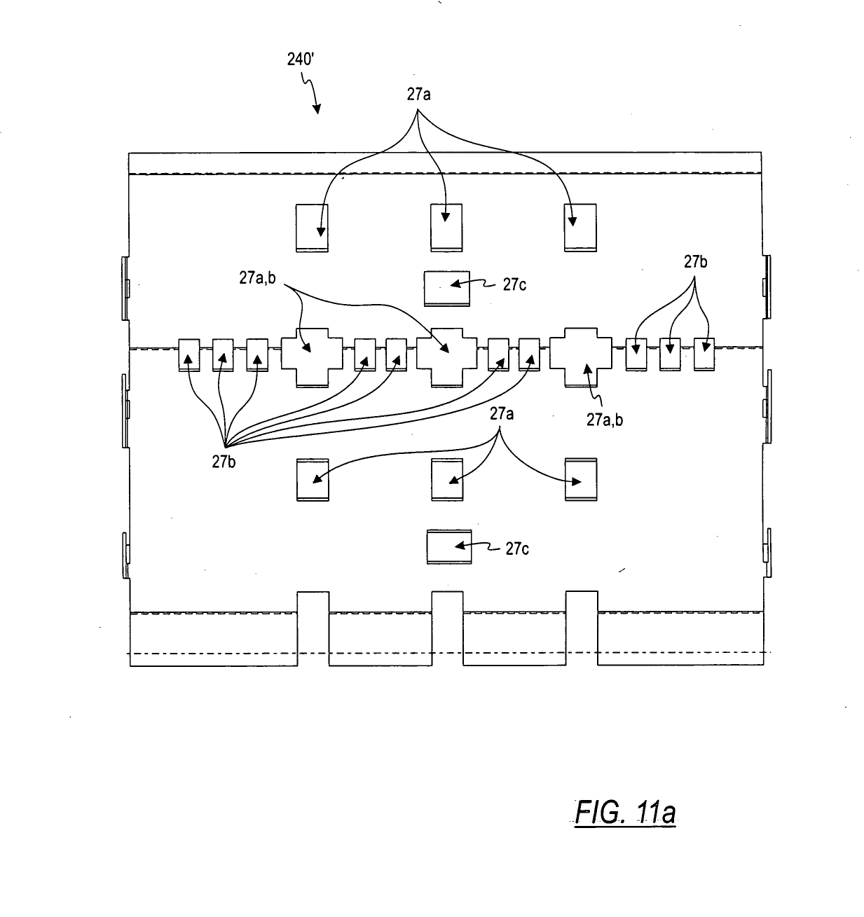

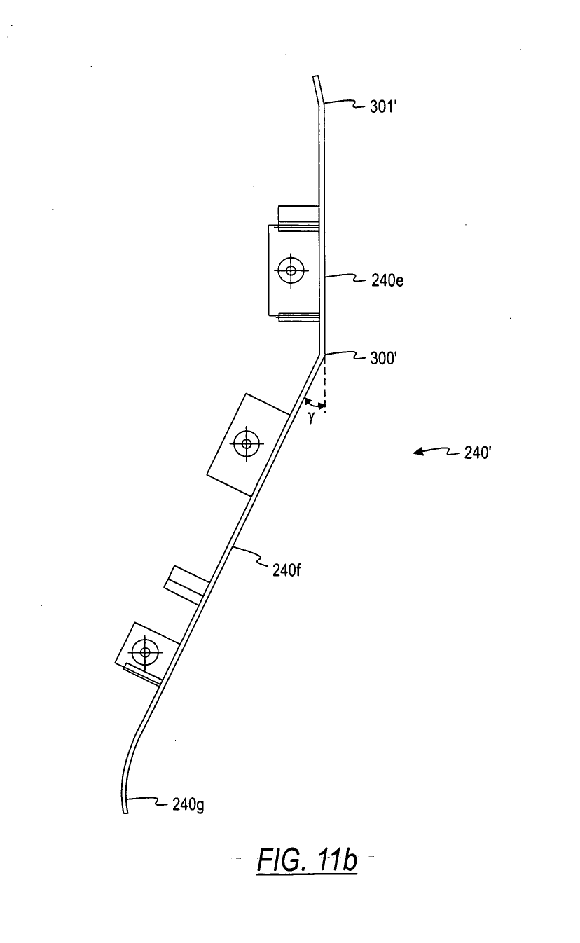

According to one embodiment, the transport plate 240 has a unitary and integral construction. Such an embodiment is depicted in FIGS. 2 and 7a-7e. However, the transport plate 240 may be constructed of a plurality of individual plates. Such an alternate embodiment is illustrated in FIGS. 10a-10b and 11a-11b.

Referring to FIG. 11b, a portion of a transport plate 240′ is depicted in which one of a plurality of individual plates is illustrated. The transport plate 240′ includes the portion depicted in FIG. 11b and another portion 240″ (FIG. 10a) in the vicinity of the evaluation region. In one embodiment, the transport plate 240″ is comprised of a molded plastic plate. Both portions of the transport plate 240′ and 240″ in this embodiment are substantially flat and linear. As depicted, the surfaces of the transport plate 240′ have no protruding features. As described above in connection with plate 240, in this embodiment, the bills are delivered to an appropriate output receptacle 217a or 217b after being evaluated without the use of belts contacting the bills.

The portion of the transport plate 240′ depicted in FIG. 11b has a first substantially planar region 240e defining a first plane. The substantially planar region 240e according to this embodiment begins after the bills have been evaluated. The substantially planar region 240e may optionally be slightly angled at a point 301′ to assist in preventing bills from getting caught in the area between the evaluating mechanism and the substantially planar region 240e. As illustrated, the first substantially planar region 240e ends at a point 300′. The transport plate 240′ also has a second substantially planar region 240f defining a second plane. The second substantially planar region 240f begins at the point 300′. The second substantially planar region extends up to a diverting flange 240g. In one embodiment, the first and second substantially planar regions 240e and 240f substantially define the entire path from the evaluation region to the plurality of output receptacles 217a,b.

In one embodiment, the second substantially planar region 240f does not deviate from the first substantially planar region 240e by more than about 90 degrees. In a second embodiment, the second region 240f does not deviate from the first region 240e by more than about 60 degrees. In a third embodiment, the second region 240f does not deviate from the first region 240e by more than about 45 degrees. In a fourth embodiment, the second region 240f does not deviate from the first region 240e by more than about 30 degrees. As depicted in FIG. 11b, the second region 240f is substantially planar with the first region 240e, deviating from the first region 240e by an angle of γ degrees where γ is about 26 degrees.

As with the transport plate 240, transport plate 240′ has a plurality of apertures 27 formed therein. According to one embodiment, apertures 27 are present only where necessary to facilitate the functioning of passive rolls and driven rolls and a diverter 260. According to another embodiment, apertures 27 are present only where necessary to facilitate the functioning of the passive and driven rolls, the diverter 260, and the various sensors such as scanheads, doubles detectors, and document location sensors. Apertures for sensors may filled with materials that do not interfere with the functioning of corresponding sensors while nonetheless facilitating the transport plate in appearing smooth and continuous to passing bills. For example, when optical sensors are being employed, corresponding apertures may contain lenses that are flush with the transport surface of the transport plate.

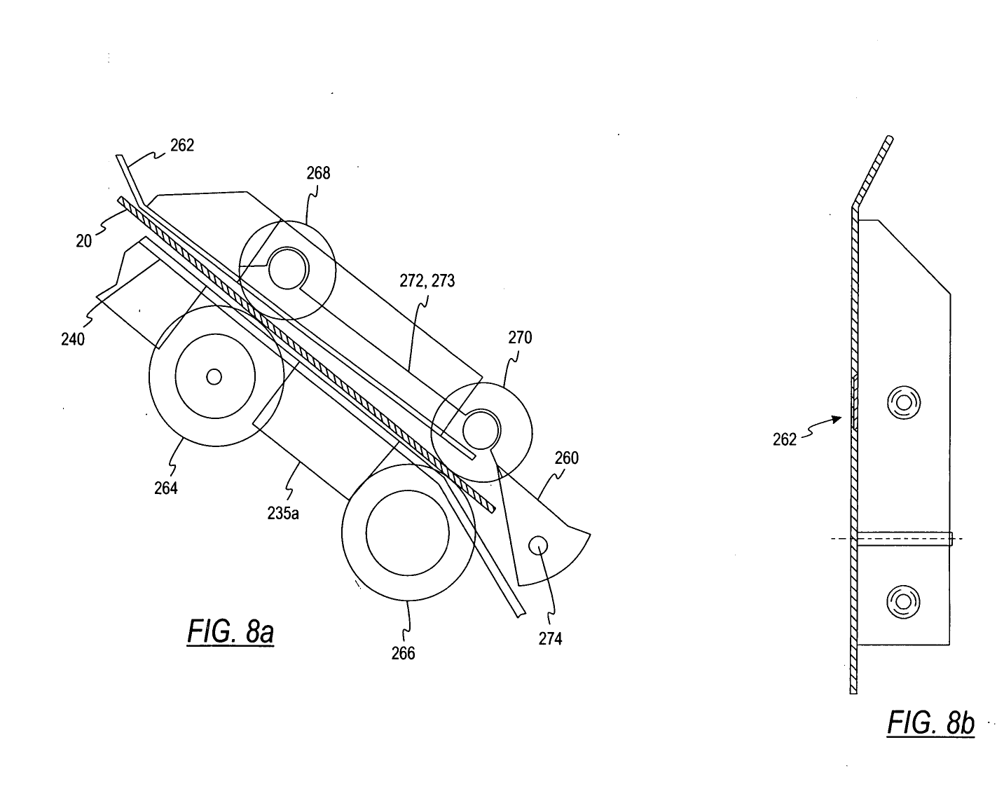

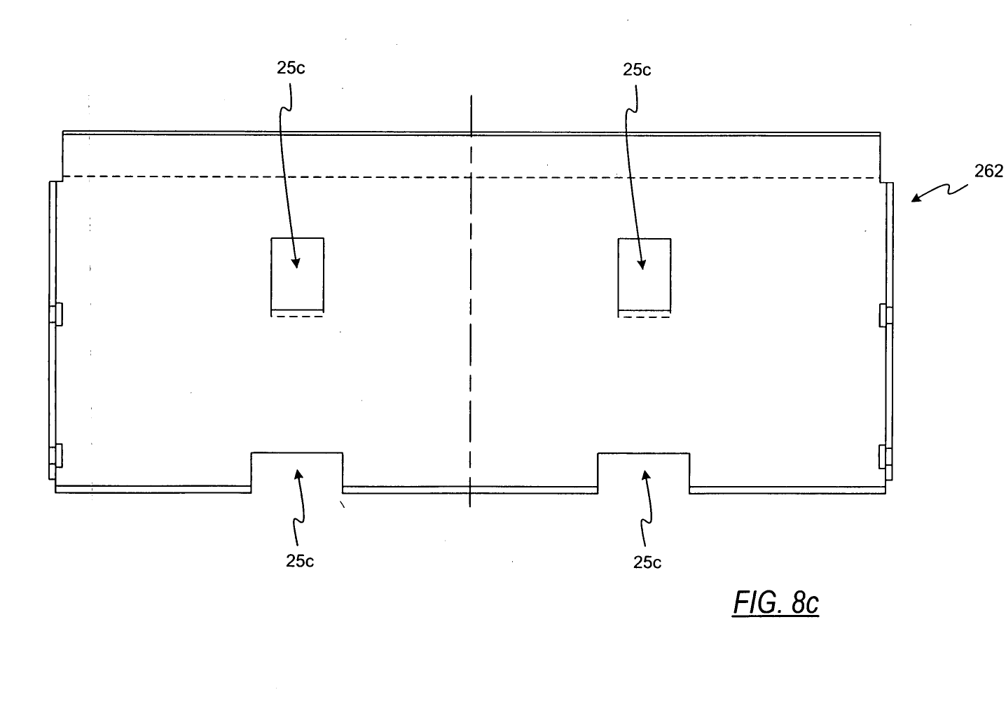

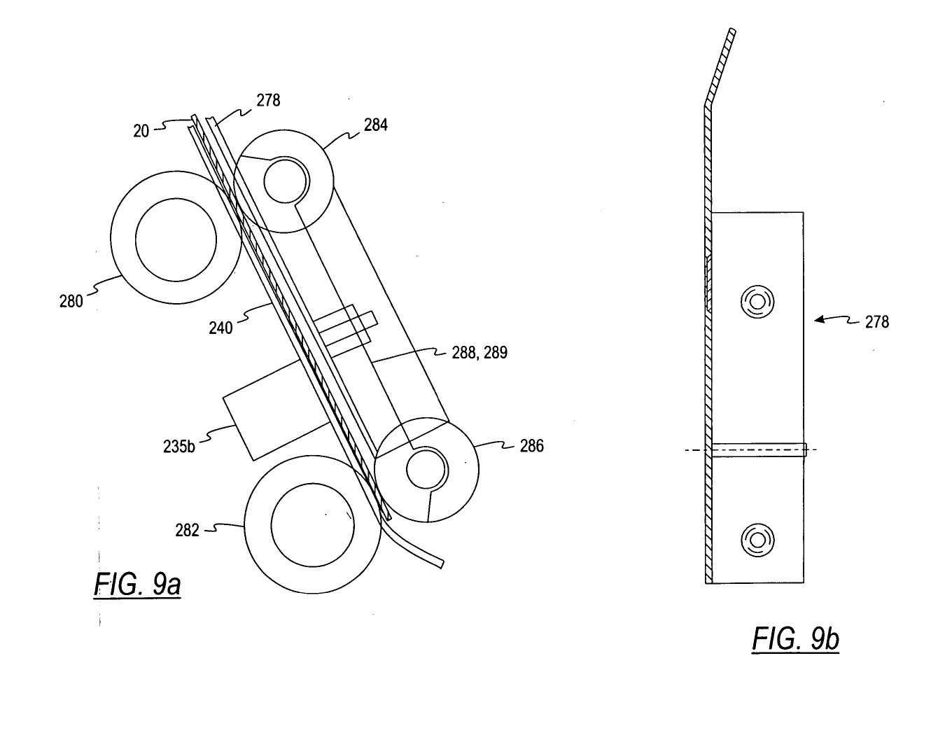

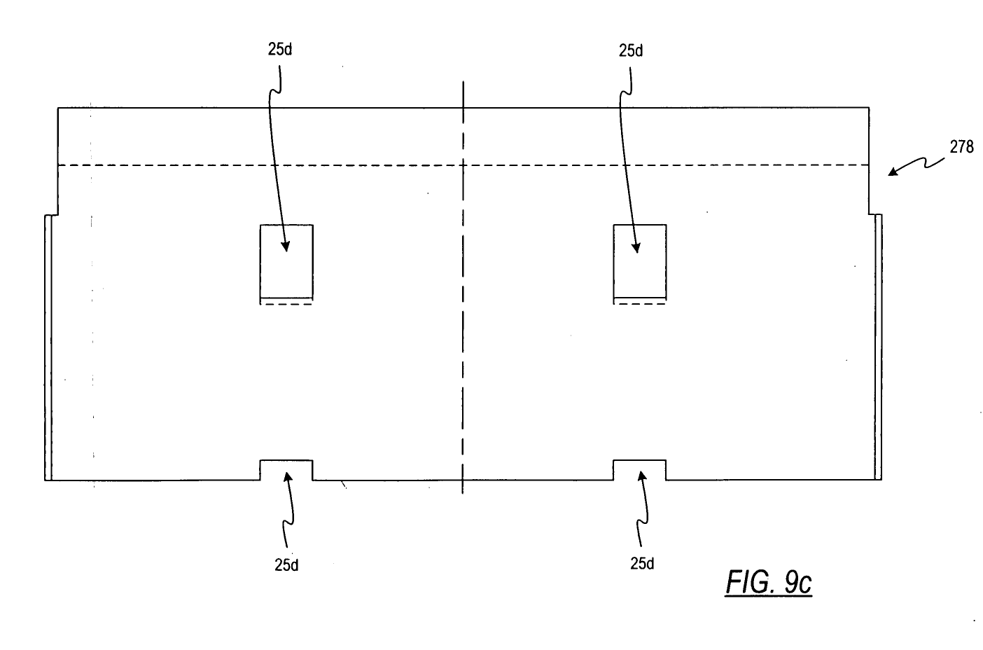

The apertures 27 of the transport plate 240′ are shown in FIG. 11a. The apertures 27a permit the passive and driven rolls to protrude into the currency pathway. The apertures 27b permit ends of the diverter 260 to rotate below the upper surface of the transport plate 240′. Apertures 27c facilitate the functioning of sensors such as sensors 235a and 235b described below in connection with FIGS. 8a and 9a. This clean and unobstructed transport plate 240′ facilitates a reduction in the jamming of the currency bills as well as facilitating the ease with which jammed bills can be removed from the device 10.

FIGS. 8a-8c and 9a-9c illustrate, respectively, first and second follower plates 262 and 278. As illustrated, these plates are substantially free from surface features and are substantially smooth like the transport plate 240. The follower plates 262 and 278 are positioned in spaced relation to transport plate 240 so as to define a currency pathway there between. The follower plates 262 and 278 and the transport plate such a 240 or 240′ contribute to defining a pathway that is free and unencumbered between the roll 251 and the output receptacles 217a and 217b for the bill. As illustrated, the follower plates 262 and 278 have apertures only where necessary for accommodation of passive rolls 268, 270, 284, and 286. The apertures 25c accommodating passive rolls 268 and 270 in the follower plate 262 are shown in FIG. 8c, while the apertures 25d accommodating passive rolls 284 and 286 are shown in FIG. 9c. Thus according to one embodiment a transport mechanism is employed that uses no belts to advance bills from the evaluation region to a plurality of output receptacles.

Referring to FIG. 8a, the follower plate 262 in conjunction with the upper portion of the transport plate 240 guide a bill 20 from the passive roll 251 to a driven roll 264 and then to a driven roll 266. The passive rolls 268, 270 are biased by H-springs 272 and 273 into counter-rotating contact with the corresponding driven rolls 264 and 266 in a manner similar as described above in connection with passive rolls 250 and 251.

A diverter 260 is employed to direct the bill 20 to the appropriate one of the first 217a or the second 217b output receptacles. The bill 20 encounters the diverter 260 after emerging from between the driven roll 266 and the passive roll 270. Diverter 260 includes a plurality of flanges mounted across the transport path on a shaft 274. Two solenoids 261a,b, one mounted on each end of the shaft 274 (FIG. 6), cause the shaft and the attached diverter flanges to rotate into either a lower position or an upper position. The two solenoids drive the shaft 274 in opposite directions and an appropriate one of the two solenoids is energized depending upon whether the diverter 260 is to be moved from its lower position to its upper position or vice versa. The use of a separate solenoid for each rotational direction enhances the performance of the diverter 260 by increasing of the speed at which the position of the diverter 260 is changed.

When the diverter 260 is in the lower position, the ends of the flanges are positioned below the upper surface of the transport plate 240. Apertures 25b in transport plate 240 (FIGS. 7b and 7d) facilitate this position while apertures 27b in transport plate 240′ (FIGS. 11a) facilitate this position. The apertures 25b and 27b correspond in location and size to the diverter 260 which enables the diverter 260 to protrude through the transport plate 240 and create a smooth ramp for directing the bills into the upper output receptacle 217a.

When the diverter 260 is in the upper position (FIG. 8a), bills are directed between the transport plate 240 and the follower plate 278 (see FIG. 9a). The transport plate 240 and the follower plate 278 guide bills after the diverter 260 to a driven roll 280 and then to a driven roll 282.

Also illustrated in FIG. 8a is a sensor 235a. Sensor 235a may be used to detect when bills passes the sensor. This sensor may be used to aid in determining when the position of diverter 260 is to be changed and/or used to detect when bills have become jammed either upstream of this sensor or over this sensor. For example, if no bills pass this sensor for a predetermined period of time when bills are expected to be passing this sensor, a jam condition error may be generated to stop the transport mechanism and prompt the operator as to the existence and location of a jam. Sensor 235a may be, for example, an optical sensor that detects light reflected off the follower plate 262. A change in the amount of light being reflected back to the sensor 235a may then indicate that a bill is passing by this sensor.

FIG. 9a illustrates a bill 20 between the driven rolls 280 and 282 and their respective passive rolls 284 and 286. The passive rolls 284, 286 are biased by H-springs 288, 289 into passive counter-rotating contact with the driven rolls 280, 282, respectively, in a manner similar to that described above in connection with passive rolls 250, 251. Bills are then directed to the lower output receptacle 217b via the stacker wheels 212b and 213b. Also illustrated in FIG. 9a is a sensor 235b. Sensor 235b may be used to detect when bills pass by the sensor. The above description of sensor 235a in connection with FIG. 8a likewise applies to sensor 235b.

As shown in FIG. 10a in one embodiment of the invention, the follower plates 262 and 278 are part of an assembly 30 that also includes the output receptacles 217a,b including pairs of stacker wheels 212a,b and 213a,b (a moveable assembly 30 can also be seen in phantom in FIG. 2). As shown in FIG. 10a, this assembly 30 can be moved away from the remainder 40 of the currency processing device. Assembly 30 is hingedly connected to the remainder of document evaluation device 40 about pivot 35. This arrangement allows the assembly 30 to rotate outward and away from the remainder of currency processing device 40 and to expose the transport plate 240′, thereby permitting access to the transport plate 240′ after the evaluation region 247. In one embodiment, assembly 30 is maintained in its open position by its own weight. Alternatively, springs 320 (FIG. 2) may be used in conjunction with the pivot 35 to maintain this assembly in its open position. The resulting unobstructed access allows users of the device to easily clear jams without a complicated procedure or the need to put a hand into a restricted, difficult to access, and sometimes dirty region. Likewise, the smooth transport and follower plates contribute to the easy removal of bills.

The assembly 30 in one embodiment of the present invention also includes a pivoting mechanism or lever 33a adjacent to follower plate 262. When in its closed position, the lever 33a is biased upward by a spring (not shown) with a hub 33b fitting into a notch 42 that maintains the assembly 30 in its closed position and the follower plate 262 in spaced relation to transport plate 240e. To move assembly 30 into its open position, the lever 33a is moved downward so that hub 33b is not engaging notch 42. The assembly 30 may then be rotated away from the remainder of the document evaluation device. The lever 33a also assists in moving the assembly 30 away from the remainder of currency processing device 40.

FIG. 10b is a side view depicting an evaluation device in an open position according to another embodiment of the present invention that is similar to that shown in FIG. 10a.

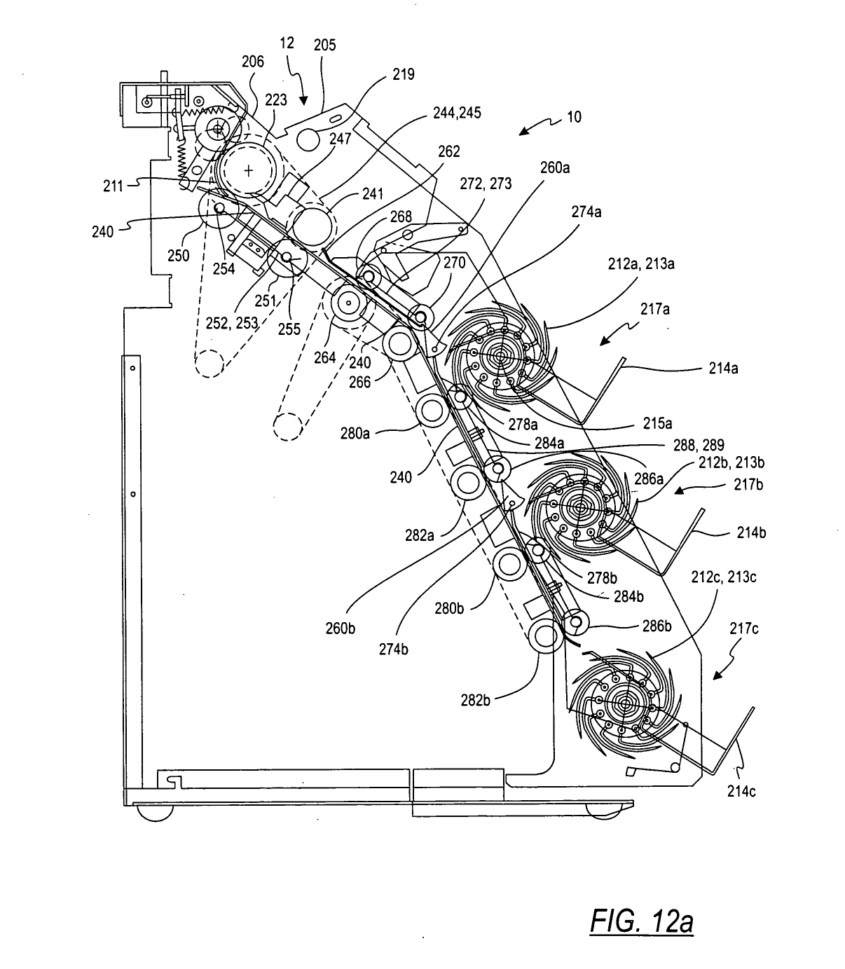

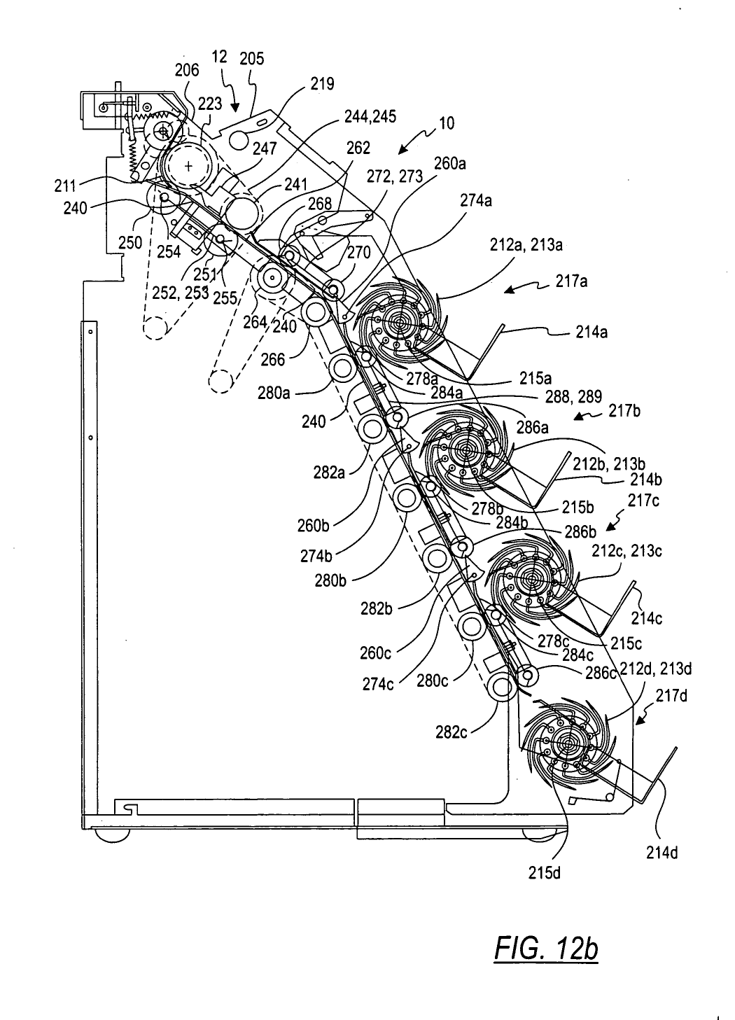

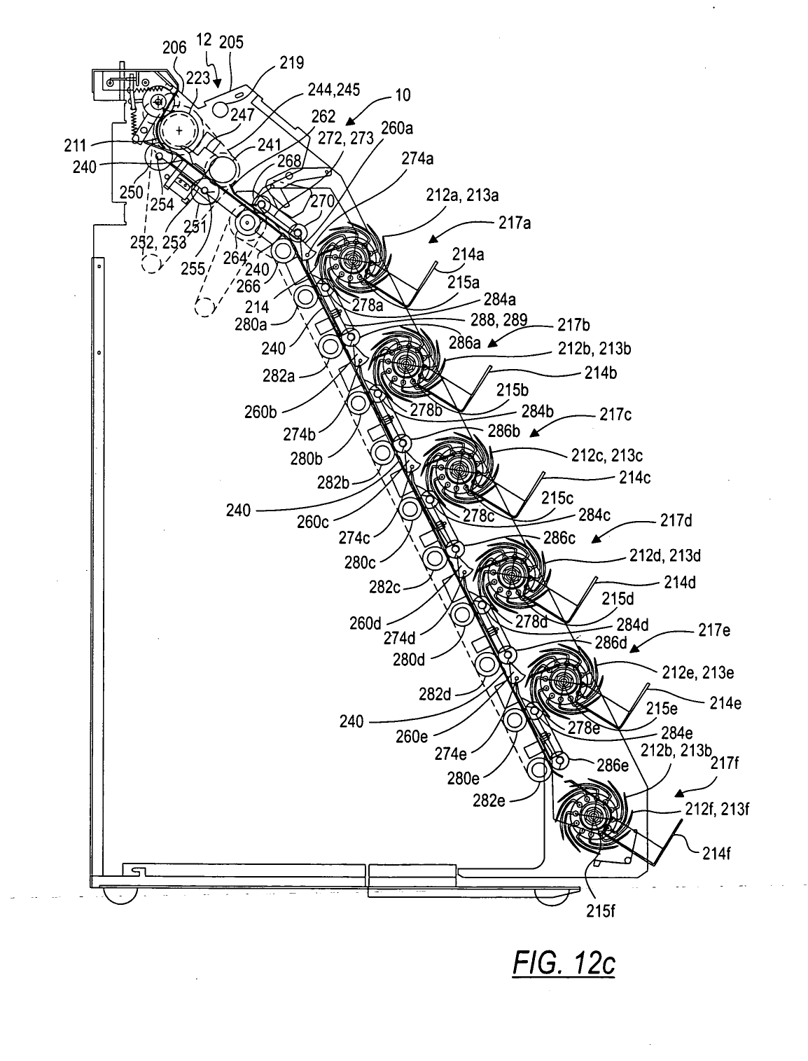

FIGS. 12a-c depict currency processing devices 10 having multiple output receptacles (also referred to as “multi-pocket devices”), according to other embodiments of the present invention. FIG. 12a depicts a currency processing device 10 having three output receptacles 247a-c. FIG. 12b depicts a currency processing device 10 having four output receptacles 217a-d. FIG. 12c depicts a currency processing device 10 having six output receptacles 217a-f.

The multi-pocket currency processing devices 10 in FIGS. 12a-c have a transport mechanism that includes a transport plate or guide plate 240 for guiding currency bills to one of a plurality of output receptacles 217. The transport plate 240 according to one embodiment is substantially flat and linear without any protruding features. Before reaching the output receptacles 217, a bill can be, for example, evaluated, analyzed, authenticated, discriminated, counted, and/or otherwise processed.

The multi-pocket currency processing devices 10 of FIGS. 12a-c move the currency bills in seriatim from the bottom of a stack of bills along the curved guideway 211 which receives bills moving downwardly and rearwardly and changes the direction of travel to a forward direction. An exit end of the curved guideway 211 directs the bills onto the transport plate 240 that carries the bills through an evaluation section and to one of the output receptacles 217. A plurality of diverters 260 direct the bills to the output receptacles 217. When a diverter 260 is in its lower position, bills are directed to the corresponding output receptacle 217. When a diverter 260 is in its upper position, bills proceed in the direction of the remaining output receptacles.

The multi-pocket currency processing devices 10 of FIGS. 12a-c according to one embodiment includes passive rolls 250, 251 that are mounted on an underside of the transport plate 240 and are biased into counter-rotating contact with their corresponding driven upper rolls 223 and 241. Other embodiments includes a plurality of follower plates that are substantially free from surface features and are substantially smooth like the transport plate 240. The follower plates 262 and 278 are positioned in spaced relation to transport plate 240 so as to define a currency pathway there between. In one embodiment, follower plates 262 and 278 have apertures only where necessary for accommodation of passive rolls 268, 270, 284, and 286.

The follower plate 262 works in conjunction with the upper portion of the transport plate 240 to guide a bill 20 from the passive roll 251 to a driven roll 264 and then to a driven roll 266. The passive rolls 268, 270 are biased by H-springs into counter-rotating contact with the corresponding driven rolls 264 and 266.

FIG. 13 is an enlarged vertical section taken approximately through the center of another embodiment of a currency processing device having two output receptacles 2217a and 2217b showing various transport rolls in side elevation. A diverter 2260 is provided to direct bills into either receptacle 2217a or 2217b depending upon the results of the denomination discriminating unit and any authenticating means that may be present.

The input region of the device as shown in FIG. 13 the same as that described in connection with FIG. 3 and according not be described again here. From the input receptacle 2210, the currency bills are moved in seriatim from the bottom of the stack along a curved guideway 2211 that receives bills moving downwardly and rearwardly and changes the direction of travel to a forward direction. The curvature of the guideway 2211 corresponds substantially to the curved periphery of the drive roll 2223 so as to form a narrow passageway for the bills along the rear side of the drive roll. The exit end of the guideway 2211 directs the bills onto a linear path where the bills are scanned. The bills are transported and stacked with the narrow dimension of the bills maintained parallel to the transport path and the direction of movement at all times.

A pair of driven stacking wheels 2212a and 2213a in output receptacle 2217a and stacking wheels 2212b and 2213b in output receptacle 2217b stack the bills in each output receptacle. These wheels project upwardly through a pair of openings in respective stacker plates 2214a,b. The stacker wheels 2212a,b and 2213a,b are supported for rotational movement about respective shafts 2215a,b journalled on a rigid frame and driven by a motor. The flexible blades of the stacker wheels deliver the bills into a respective one of the output receptacles 2217a,b at the forward end of the respective stacker plates 2214a,b. During operation, a currency bill that is delivered to a respective stacker plate 2214a,b is picked up by the flexible blades and becomes lodged between a pair of adjacent blades which, in combination, define a curved enclosure which decelerates a bill entering therein and serves as a means for supporting and transferring the bill into a respective output receptacle 2217a,b as the stacker wheels 2212a,b and 2213a,b rotate. The mechanical configuration of the stacker wheels, as well as the manner in which they cooperate with the stacker plate, is conventional and, accordingly, is not described in detail herein.

The stripping wheels mounted on shaft 2221 feed each bill onto a drive roll 2223 mounted on a driven shaft 2224 supported across the side walls. The drive roll 2223 is the same as drive roll 223 (FIG. 2) described above. Likewise the operation of the stripping wheel and drive roll 2223 is the same as described above in connection with stripping wheels 220 and drive roll 223 (FIG. 3). Likewise, in order to ensure firm engagement between the drive roll 2223 and the currency bill being fed, an idler roll 2230, stripper wheels 2233,2234, and pressure roll 2236 operate as described above in connection with FIG. 3. and in U.S. Pat. No. 5,687,963, incorporated by reference above.

At the lower end of the curved guideway 2211, the bill being transported by the drive roll 2223 engages a flat guide plate 2240. Currency bills are positively driven along the flat plate 2240 by means of a transport roll arrangement which includes the drive roll 2223 at one end of the plate and a smaller driven roll 2241 at the other end of the plate. Both the drive roll 2223 and the smaller roll 2241 include pairs of smooth raised cylindrical surfaces which hold the bill flat against the plate 2240. A pair of O rings 2244 and 2245 fit into grooves formed in both the roll 2241 and the roll 2223 to engage the bill continuously between the two rolls 2223 and 2241 to transport the bill while helping to hold the bill flat against the guide plate 2240.

The flat guide plate 2240 is provided with openings through which the raised surfaces of both the drive roll 2223 and the smaller driven roll 2241 are subjected to counter-rotating contact with corresponding pairs of passive transport rolls 2250 and 2251 having high-friction rubber surfaces. The passive rolls 2250, 2251 are mounted on the underside of the flat plate 2240 in such a manner as to be freewheeling about their axes 2254 and 2255 and biased into counter-rotating contact with the corresponding upper rolls 2223 and 2241. The passive rolls 2250 and 2251 are biased into contact with the driven rolls 2223 and 2241 by means of a pair of H-shaped leaf springs 2252 and 2253. Each of the four rolls 2250, 2251 is cradled between a pair of parallel arms of one of the H-shaped leaf springs 2252 and 2253.

The points of contact between the driven and passive transport rolls are preferably coplanar with the flat upper surface of the plate 2240 so that currency bills can be positively driven along the top surface of the plate in a flat manner. The distance between the axes of the two driven transport rolls, and the corresponding counter-rotating passive rolls, is selected to be just short of the length of the narrow dimension of the currency bills. Accordingly, the bills are firmly gripped under uniform pressure between the upper and lower transport rolls within the area of scanhead 2247, thereby minimizing the possibility of bill skew and enhancing the reliability of the overall scanning and recognition process. The positive guiding arrangement described above is advantageous in that uniform guiding pressure is maintained on the bills as they are transported through the scanhead area, and twisting or skewing of the bills is substantially reduced. This positive action is supplemented by the use of the H-springs 2252, 2253 for uniformly biasing the passive rollers into contact with the active rollers so that bill twisting or skew resulting from differential pressure applied to the bills along the transport path is avoided. The O-rings 2244, 2245 function as simple, yet extremely effective means for ensuring that the central portions of the bills are held flat.

The guide plate 2240 extends from the region of curved guideway 2211 to a region in the vicinity the diverter 2260. A guide plate 2262 in conjunction with the lower portion of the guide plate 2240 guide bills from between rolls 2241 and 2251 to driven roll 2264 and then to driven roll 2266. Passive rolls 2268, 2670 are biased by H-springs 2272, 2273 into counter-rotating contact with the rolls 2264 and 2266, respectively, in a manner similar to that described above in connection with the rolls 2250, 2251. Bills emerge from between rolls 2266 and 2270 and are directed into the diverter 2260. The diverter 2260 comprises a plurality of flanges mounted across the transport path on shaft 2274. Two solenoids, one mounted on each end of shaft 2274, cause the shaft and the attached diverter flanges to rotate into either a lower position or an upper position. The two solenoids drive the shaft 2274 in opposite directions and an appropriate one of the two solenoids is energized depending upon whether the diverter 2260 is to be moved from its lower position to its upper position or vice versa. The use of a separate solenoid for each rotational direction enhances the performance of the diverter by increasing the speed with which the position of the diverter may be changed.

When the diverter is in its lower position, bills are directed to the upper output receptacle 2217a via stacker wheels 2212a and 2213a. When the diverter is in its upper position, the bills are directed between guide plates 2276 and 2278. The guide plates 2276 and 2278 guide bills from the diverter 2260 to driven roll 2280 and then to driven roll 2282. The passive rolls 2284, 2286 are biased by H-springs 2288,2289 into counter-rotating contact with rolls 2280 and 2282, respectively, in a manner similar to that described above in connection with rolls 2250, 2251. The bills are then directed to the lower output receptacle 2217b via stacker wheels 2212b and 2213b.

Evaluation Region

The characteristics of the evaluation region 247, 2247 of the currency processing device may vary according to the particular application and needs of the user. The evaluation region can accommodate a number and variety of different types of sensors depending on a number of variables. These variables are related to whether the currency processing device is authenticating, counting, or discriminating and what distinguishing characteristics are being examined (e.g., size, color, magnetism, reflectivity, absorbability, transmissivity, electrical conductivity, etc.).

The evaluation region 247, 2247 may employ a variety of detection means such as magnetic or optical sensors. For example, a variety of currency characteristics can be measured using magnetic sensing. These include detection of patterns of changes in magnetic flux (U.S. Pat. No. 3,280,974), patterns of vertical grid lines in the portrait area of bills (U.S. Pat. No. 3,870,629), the presence of a security thread (U.S. Pat. No. 5,151,607), total amount of magnetizable material of a bill (U.S. Pat. No. 4,617,458), patterns from sensing the strength of magnetic fields along a bill (U.S. Pat. No. 4,593,184), and other patterns and counts from scanning different portions of the bill such as the area in which the denomination is written out (U.S. Pat. No. 4,356,473). Additionally, a magnetoresistive sensor or a plurality of such sensors including an array of magnetoresistive sensors may be employed to detect, for example, magnetic flux. Examples of magnetoresistive sensors are described in, for example, U.S. Pat. Nos. 5,119,025, 4,683,508, 4,413,296, 4,388,662, and 4,164,770. Another example of a magnetoresistive sensor that may be used is the Gradiometer available from NVE Nonvolatile Electronics, Inc., Eden Prairie, Minn. Additionally, other types of magnetic sensors may be employed for detecting magnetic flux such as Hall effect sensors and flux gates.

With regard to optical sensing, a variety of currency characteristics can be measured such as detection of density (U.S. Pat. No. 4,381,447), color (U.S. Pat. Nos. 4,490,846; 3,496,370; 3,480,785), length and thickness (U.S. Pat. No. 4,255,651), the presence of a security thread (U.S. Pat. No. 5,151,607) and holes (U.S. Pat. No. 4,381,447), and other patterns of reflectance and transmission (U.S. Pat. Nos. 3,496,370; 3,679,314; 3,870,629; 4,179,685). Color detection techniques may employ color filters, colored lamps, and/or dichroic beamsplitters (U.S. Pat. Nos. 4,841,358; 4,658,289; 4,716,456; 4,825,246, 4,992,860 and EP 325,364). The use of ultraviolet light is also a useful discrimination and authentication tool. An optical sensing system using ultraviolet light is described in the assignee's co-pending U.S. patent application Ser. No. 08/317,349, filed Oct. 4, 1994, and incorporated herein by reference in its entirety.

In addition to magnetic and optical sensing, other techniques of detecting characteristic information of currency include electrical conductivity sensing, capacitive sensing (U.S. Pat. No. 5,122,754 [watermark, security thread]; U.S. Pat. No. 3,764,899 [thickness]; U.S. Pat. No. 3,815,021 [dielectric properties]; U.S. Pat. No. 5,151,607 [security thread]), and mechanical sensing (U.S. Pat. No. 4,381,447 [limpness]; U.S. Pat. No. 4,255,651 [thickness]); U.S. Pat. application Ser. No. 10/379,365 [fitness]. Alternatively or additionally, sensors may be employed to detect bills or security threads printed or coated with thermochromatic materials (materials that change color with a change in temperature). Examples of threads incorporating thermochromatic materials are described in U.S. Pat. No. 5,465,301, which is incorporated herein by reference in its entirety.

Although not illustrated in the drawings, it should be noted that corresponding photodetectors (not shown) may be provided within the evaluation area in immediate opposition to corresponding light sources. These detectors detect the beam of coherent light directed downwardly onto the bill transport path from corresponding the light sources and generate an analog output which corresponds to the sensed light. Two-sided scanning may be used to permit bills to be fed into a currency discrimination system according to the present invention with either side face up. An example of a two-sided scanhead arrangement is disclosed in U.S. Pat. No. 5,467,406, which is incorporated herein by reference in its entirety. Another example of a two-sided scanhead arrangement is described in co-pending U.S. Pat. No. 5,687,963, referred to above and incorporated by reference above. Further, to accommodate scanning in areas other than the central portion of a bill, multiple scanheads may be laterally positioned next to each other. Examples of multiple scanhead arrangements are described in U.S. Pat. No. 5,652,802, which is incorporated herein by reference in its entirety.

Some examples of scanheads are depicted in FIGS. 13-16. These scanheads may be, for example, incorporated into the currency processing devices depicted in FIGS. 1, 3, 10a-10b and 12a-12c. As illustrated in FIGS. 13-16, the housing for each scanhead is formed as an integral part of a unitary molded plastic support member 280 or 281. The lower member 281 also forms the transport plate 240 that receives the bills from the drive roll 223 and supports the bills as they are driven past the scanheads 18a and 18b. The two support members 280 and 281 are mounted facing each other so that the lenses 282 and 283 of the two scanheads 18a, 18b define a narrow gap through which each bill is transported. The upper support member 280 includes a tapered entry guide 280a which guides an incoming bill into the gaps between the various pairs of opposed lenses.

The lower support member 281 is attached rigidly to the device frame. The upper support member 280, however, is mounted for limited vertical movement when it is lifted manually by a handle 284, to facilitate the clearing of any paper jams that occur beneath the member 280. To allow for such vertical movement, the member 280 is slidably mounted on a pair of posts 285 and 286 on the device frame, with a pair of springs 287 and 288 biasing the member 280 to its lowermost position.

Each of the two optical scanheads 18a and 18b housed in the support members 280, 281 includes a pair of light sources acting in combination to uniformly illuminate light strips of the desired dimension on opposite sides of a bill as it is transported across the plate 240. Thus, the upper scanhead 18a includes a pair of LEDs 22a, directing light downwardly through an optical mask on top of the lens 282 onto a bill traversing the flat guide plate 240 beneath the scanhead. The LEDs 22a are angularly disposed relative to the vertical axis of the scanhead so that their respective light beams combine to illuminate the desired light strip defined by an aperture in the mask. The scanhead 18a also includes a photodetector 26a mounted directly over the center of the illuminated strip for sensing the light reflected off the strip. A lower scanhead 18b includes a pair of LEDs 22b, directing light upwardly through an optical mask on top of the lens 283 onto a bill traversing the flat guide plate 240 above the scanhead.

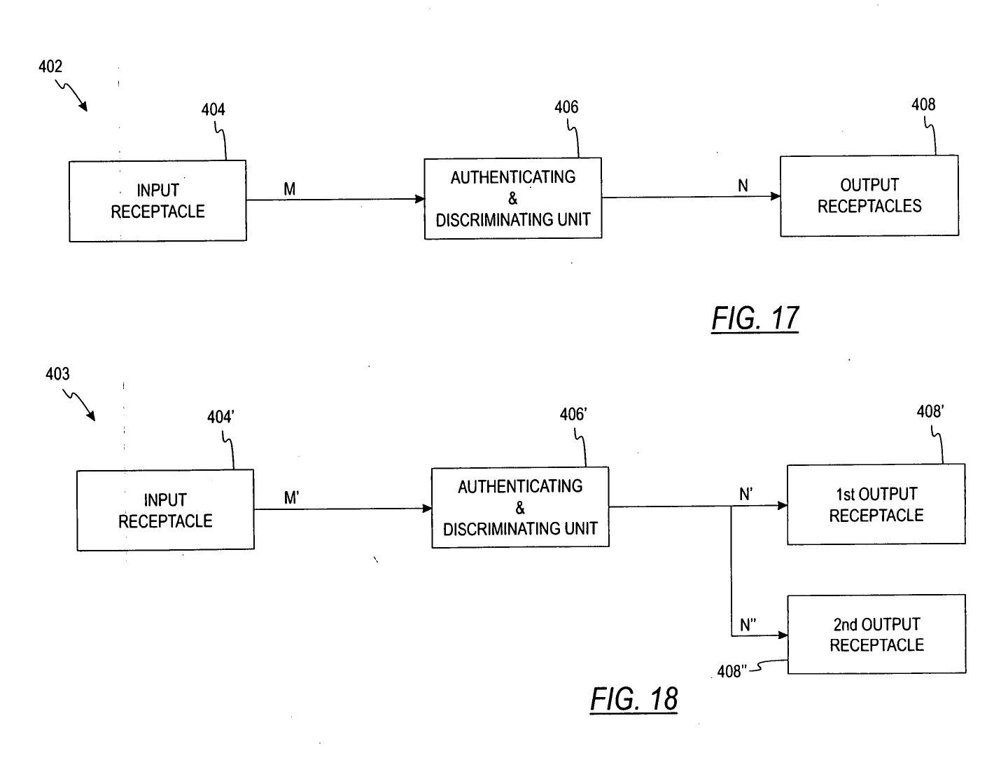

Turning now to FIG. 17, there is shown a functional block diagram illustrating an embodiment of a currency processing device according to one embodiment of the present invention. The processing system 402 comprises an input receptacle 404 for receiving a stack of currency bills. A transport mechanism defining a transport path (as represented by arrow M) transports the bills in the input receptacle, one at a time, past one or more sensors of an authenticating and discriminating unit 406. Bills are then transported to one of a plurality of output receptacles 408 (arrow N). The system 402 may correspond, for example, to the currency processing devices described above having multiple output pockets such as those shown in FIGS. 1-2, 10a-10b, and 12a-12c. The authenticating and discriminating unit scans and determines the denomination of each passing bill. Any variety of discriminating techniques may be used. For example, the discriminating method disclosed in U.S. Pat. No. 5,295,196 (incorporated by reference herein in its entirety) may be employed to optically scan each bill. Depending on the characteristics of the discriminating unit employed, the device may be able to recognize bills only if fed face up or face down, regardless of whether fed face up or face down, only if fed in a forward orientation or reverse orientation, regardless of whether fed in a forward or reverse orientation, or some combination thereof. Additionally, the discriminating unit may be able to scan only one side or both sides of a bill. In addition to determining the denomination of each scanned bill, the authenticating and discriminating unit 406 may additionally include various authenticating tests such as an ultraviolet authentication test as disclosed in U.S. Pat. No. 5,640,463, which is incorporated herein by reference in its entirety. Likewise, the authenticating and discriminating unit 406 may additionally include other authentication tests such as thread detection, enhanced magnetics tests, and color authentication tests including those described in U.S. Pat. No. 5,992,601, which is incorporated herein by reference in its entirety.

Signals from the authenticating and discriminating unit 406 are sent to a signal processor such as a central processor unit (CPU). The CPU records the results of the authenticating and discriminating tests in a memory. When the authenticating and discriminating unit 406 is able to confirm the genuineness and denomination of a bill, the value of the bill is added to a total value counter in memory that keeps track of the total value of the stack of bills that were inserted in the input receptacle 404 and scanned by the authenticating and discriminating unit 406. Additionally, depending on the mode of operation of the processing system 402, counters associated with one or more denominations may be maintained in the memory. For example, a $1 counter may be maintained to record how many $1 bills were scanned by the authenticating and discriminating unit 406. Likewise, a $5 counter may be maintained to record how many $5 bills were scanned, and so on. In an operating mode where individual denomination counters are maintained, the total value of the scanned bills may be determined without maintaining a separate total value counter. The total value of the scanned bills and/or the number of each individual denomination may be displayed on a display such as a monitor or LCD display.

A discriminating unit such as the authenticating and discriminating unit 406 may not be able to identify the denomination of one or more bills in the stack of bills loaded into the input receptacle 404. For example, if a bill is excessively worn or soiled, or if the bill is torn, a discriminating unit may not be able to identify the bill. Furthermore, some known discrimination methods do not have a high discrimination efficiency and thus are unable to identify bills which vary even somewhat from an “ideal” bill condition or which are even somewhat displaced by the transport mechanism relative to the scanning mechanism used to discriminate bills. Accordingly, such poorer performing discriminating units may yield a relatively large number of bills which are not identified. Alternatively, some discriminating units may be capable of identifying bills only when they are fed in a predetermined manner. For example, some currency processing devices may require a bill to be faced in a predetermined manner. Accordingly, when a bill is fed face down past a discriminating unit that can only identify bills fed face up, the discriminating unit can not identify the bill. Likewise, other devices require a specific edge of a bill to be fed first, for example, the top edge of a bill. Accordingly, bills which are not fed in the forward direction, that is, those that are fed in the reverse direction, are not identified by such a discriminating unit.

According to one embodiment, the processing system 402 is designed so that when the authenticating and discriminating unit 406 is unable to identify a bill, the unidentified note is “presented” in one of the output receptacles, that is, the transport mechanism is stopped so that the unidentified bill is located at a predetermined position within one of the output receptacles 408, such as being the last bill transported to one of the output receptacles. For example, where the unidentified bill is the last bill transported to an output receptacle 408, it may be positioned within the stacker wheels or positioned at the top of or at the rear of the stack of bills resting on a stacker plate in the output receptacle 408. The output receptacles 408 are preferably positioned within the processing system 402 so that the operator may conveniently see the flagged bill and/or remove it for closer inspection. Accordingly, the operator is able to easily see the bill which has not been identified by the authenticating and discriminating unit 406. The operator may then either visually inspect the flagged bill while it is resting on the top of or at the rear of the stack, or alternatively, the operator may chose to remove the bill from the output receptacle in order to examine the flagged bill more closely.

According to another embodiment, when a bill is flagged, the transport mechanism may be stopped before the flagged bill is transported to one of the output receptacles. Such an embodiment is particularly suited for situations in which the operator need not examine the bill flagged, such as upon the occurrence of a denomination change or separate series error described below. For example, upon the occurrence of a denomination change where all available output receptacles already have received one or more bills, the device may stop with the denomination change bill residing within the transport mechanism. The device may then prompt the operator to remove all the bills from a given output receptacle. When the operator does so, the device automatically resumes operation (or alternatively, the device may resume operation after the selection of a continue key) and delivers the denomination change bill into the cleared output receptacles.

The processing system 402 may be designed to continue operation automatically when a flagged bill is removed from the output receptacle or, according to one embodiment of the present invention, may be designed to require a selection element to be depressed. Upon examination of a flagged bill by the operator, it may be found that the flagged bill is genuine even though it was not identified by the discriminating unit. However, because the bill was not identified, the total value and/or denomination counters in the memory does not reflect its value. According to one embodiment, such an unidentified bill is removed from the output stack and either re-fed through the currency processing device or set aside. In the latter case, any genuine set aside bills are counted by hand.

In order to avoid problems associated with re-feeding bills, counting bills by hand, and adding together separate totals, according to one embodiment of the present invention, a number of selection elements associated with individual denominations are provided. These selection elements may be in the form of keys or buttons of a keypad. Other types of selection elements such as switches or displayed keys in a touch-screen environment may be employed. When an operator determines that a flagged bill is acceptable, the operator may simply depress the selection element associated with the denomination of the flagged bill and the corresponding denomination counter and/or the total value counter are appropriately incremented and the processing system 402 resumes operating again. In non-automatic restart devices, where an operator has removed a genuine flagged bill from the output receptacle for closer examination, the bill is first replaced into the output receptacle before a corresponding selection element is chosen.

An advantage of the above described procedure is that appropriate counters are incremented and the device is restarted with the touch of a single key, which simplifies the operation of the processing system 402 while reducing the opportunities for human error. When an operator determines that a flagged bill is not acceptable, the operator may remove the unacceptable flagged bill from the output receptacle without replacement and depress a continuation key on the keypad. When the continuation key is selected, the denomination counters and the total value counter are not affected and the processing system 402 resumes operating again. In automatic restart devices, the removal of a bill from the output receptacle is treated as an indication that the bill is unacceptable and the device automatically resumes operation without affecting the denomination counters and/or total value counters.

With respect to FIG. 17, in one embodiment, where the authenticating and discriminating unit determines that a bill is a fake, the flagged bill is routed to a separate one of said output receptacles. The operation of the processing system 402 may or may not then be suspended. When a bill is not determined to be fake but for some reason the authenticating and discriminating unit 406 is not able to identify the denomination of the bill, the no call bill may be transported one of the output receptacles. In one embodiment, no call bills are transported to a separate one of the output receptacles. In another embodiment, no calls are not delivered to a special separate output receptacle. The operation of the device may or may not then be suspended.

In another embodiment according to FIG. 17, no call bills are delivered to an output receptacle separate from the one or more output receptacles receiving identified bills. The operation of the device need not be suspended until all the bills placed in the input receptacle have been processed. The value of any no call bills may then be added to the appropriate counters after the stack of bills has been processed through a reconciliation process.

One embodiment that may be used for stopping the transport mechanism in response to the detection of an unidentified bill or a bill meeting some other criteria such as being a suspect bill, denomination change, etc., is described in detail in U.S. Pat. No. 5,295,196, which incorporated herein by reference in its entirety. Basically, one or more sensors retrieve information from passing bills. This information is processed by a signal processor such as a CPU. The position of bills in the transport mechanism is monitored. This monitoring of bill positioned is accomplished via the use of an optical encoder as described in U.S. Pat. No. 5,295,196. If the denomination of the bill is identified, the signal processor generates a signal indicative of the determined denomination. If the denomination of the bill is not determined, the signal processor generates a no call signal. If the signal processor determines the bill to be suspect, a suspect signal is generated or a particular type of suspect signal is generated indicative of the reason why the bill is believed to be suspect, e.g., failure of a magnetic test, failure of a UV test, etc.

Additionally, error signals may be generated for other reasons including the detection of various minor errors such as a denomination change or stranger condition or the detection a major error such as doubles or chains. As a result of the generation of one or more of these error signals, the signal processor can be programmed to generate one or more signals that cause the transport mechanism to halt in a particular manner such as by sending appropriate signals to the motor driving the transport mechanism and/or to cause one or more diverters to direct bills toward an appropriate output receptacle such as by sending appropriate signals to the diverter driving mechanisms such as the solenoids described above. Positional information obtained from the encoder may be employed to stop a bill in a controlled manner and so that the bill is stopped in a predetermined position or identifiable location.

Turning now to FIG. 18, there is shown a functional block diagram illustrating a two-pocket currency processing device according to one embodiment of the present invention. The currency processing system system 403 comprises an input receptacle 404□ for receiving a stack of currency bills. A transport mechanism defining a transport path (as represented by arrow M□) transports the bills in the input receptacle, one at a time, past one or more sensors of an authenticating and discriminating unit 406□. Bills are then transported to one of two output receptacles 408□, 408□(as represented by arrows N□, N□).

In one embodiment, where the authenticating and discriminating unit 406 determines that a bill is a fake, the flagged bill is routed to a specific one of the output receptacles. The operation of the currency processing system may or may not then be suspended. When a bill is not determined to be fake but for some reason the authenticating and discriminating unit 406 is not able to identify the denomination of the bill, the no call bill may be transported to one of the output receptacles 408′, 408″.

In one embodiment, no call bills are transported to a specific one of the output receptacles 408′, 408″. In another embodiment, no call bills are not delivered to a special separate output receptacle. The operation of the currency processing system may or may not then be suspended. For example, in a two output pocket currency processing system, all bills may be transported to the same output receptacle regardless of whether they are determined to be suspect, no call, or properly identified. In this example, the operation of the system may be suspended and an appropriate message displayed when a suspect or no call bill is encountered. Alternatively, suspect bills may be delivered to a specific one of the two output receptacles (i.e., a reject receptacle) and no calls and identified bills may be sent to the other output receptacle. In this example, the operation of the system need not be suspended when a suspect bill is encountered but may be suspended when a no call bill is encountered. If the operation is suspended at the time the no call bill is detected and the operator determines that the no call bill is acceptable, the operator returns the bill to the output receptacle from which it was removed (if it was removed) and selects a selection element (not shown) corresponding to the denomination of the flagged bill. Appropriate counters (not shown) are incremented, the processing system 403 resumes operation. On the other hand, if the operator determines that the flagged bill is unacceptable, the operator removes the bill without replacement from the output receptacle and selects a continuation element (not shown). The processing system 403 resumes operation without incrementing the counters associated with the various denomination and/or the total value counters.

In another embodiment, no call bills are delivered to a specific output receptacle separate from the output receptacle receiving identified bills. The operation of the currency processing system need not be suspended until all the bills placed in the input receptacle 404 have been processed. Alternatively, the operation of the currency processing system need not be suspended when a no call is encountered but may be suspended when a suspect bill is detected so that the operator may remove any suspect bills from the currency processing device. The value of any no call bills may then be added to the appropriate counters after the stack of bills has been processed through a reconciliation process. In an alternate embodiment, suspect and no call bills may be delivered to a specific one of the two output receptacles (i.e., a reject receptacle) and identified bills may be sent to the other output receptacle. Additionally, according to this embodiment, the operation of the currency processing device may be suspended and an appropriate message displayed when a suspect or no call bill is encountered.

As described above in connection with FIG. 17, when the transport mechanism is to be stopped in response to a bill being flagged, the flagged bill may be located at a predetermined position within an output receptacle, e.g., last bill, in stacker wheel, or alternatively, the transport mechanism may be stopped before the flagged bill is transported to one of the output receptacles.

The system 403 may correspond, for example, to the currency processing devices described above having two output pockets such as those shown in FIGS. 1, 2, 10a, and 10b. In one embodiment, the processing system is selectively programmable among several operating modes so that an operator may select, for example, which bills to flag, in which pocket to direct the flagged or unflagged bills, and/or which stopping conditions to activate or de-activate. The several operating modes are described below. In any of the selected operating modes, the system 403 may be programmed to deliver a flagged bill into a selected pocket and suspend operation of the device to allow for inspection of the bill, as described in relation to FIG. 17, or the device may be programmed to “off-sort” flagged or unflagged bills into a different pocket and either stop to allow for inspection of the “off-sorted” bill or continue processing the stack of bills without stopping.

A bill may be flagged and the currency processing systems described above such as those in conjunction with FIGS. 1, 2, 10a, 10b, 12a-12c, 17, and 18 may be stopped upon encountering an unidentified or “no call” bill, as discussed above, or for any number of other stopping conditions. In general, these currency processing systems may stop upon the occurrence of minor errors or major errors, both of which are described in detail below. These currency processing systems may include an audio alarm to provide an audible signal upon the occurrence of one or more of the minor or major error conditions. Preferably, the audio alarm is programmable to permit the operator to selectively activate or de-activate the audio alarm for any or all of the minor or major error conditions. The following description including the description relating to error conditions, operating modes, and touch panel screens are applicable to these currency processing systems and particularly to the above described currency processing systems having two output receptacles such as shown in FIGS. 1, 2, 10a, 10b, 13, and 18. Furthermore, such systems transport and divert bills to one of the output receptacles at speeds equal to or greater than 600 bills per minute. According to another embodiment, such systems transport and divert bills to one of the output receptacles at speeds equal to or greater than 800 bills per minute. According to another embodiment, such systems transport and divert bills to one of the output receptacles at speeds equal to or greater than 1000 bills per minute. These systems may also employ flash card memories as described in U.S. Pat. No. 5,909,502, which is incorporated herein by reference in its entirety.

Minor Error Conditions

Minor errors are conditions that may or may not cause the device to stop depending on the set-up, mode of operation, and error involved. Minors errors do not involve the review of more than one, if any, note. Minor errors do not disrupt running totals such as batch or sub-totals. According to one embodiment, the detection of the minor error conditions may be selectively activated or de-activated as desired by the user. For example, the device may be programmed stop upon the occurrence of a “no call” document but not upon the occurrence of a “suspect document.” The minor error conditions include the following:

| | |
|---|---|
| 1) | No Call (NC) |
| 2) | Suspect Document (SD) |
| 3) | Denomination Change (DC) |
| 4) | Stranger (S) |
| 5) | Separate Series (SS) |
| 6) | Improper Size (SZ) |
| 7) | Unfit Document (UD) |
| 8) | Reverse-Faced (RF) |
| 9) | Reverse-Oriented (RO) |
| 10) | Strap Limit (SL) |
| 11) | Stacker Full (SF) |

No Call

A “no call” condition occurs when the currency processing device is unable to identify or determine the denomination of a note, the unidentified note being termed a no call.

Suspect Document

A “Suspect Document” is a note that fails one or more authentication tests based on a variety of monitored parameters. A currency processing device may permit the operator to enable or disable the detection of Suspect Documents, by for example, enabling or disabling one or more the authentication tests.

Denomination Chance

A “Denomination Change” condition occurs when a note is identified having a denomination other than prior bills or a target denomination while the device is operating in one of the sort modes described below. For example, when a $100 bill is scanned in a stack of previously scanned $50 bills, the condition “Denomination Change” may occur under certain circumstances while the device is operating in a sort mode.

Stranger

The “Stranger” condition occurs when a note is identified having a denomination other than prior bills or a target denomination while the device is operating in one of the stranger modes described below. The stranger mode is generally used when it is expected that most bills in a stack are of the same denomination. The stranger condition is described in greater detail hereinafter in connection with several stranger modes of operation.

Separate Series (SS)

A “Separate Series” condition occurs when a note is identified as having a different series than prior bills or a target series. For example, when a new-series $100 bill (i.e., a 1996-series $100 bill) is scanned in a stack of previously scanned old-series $100 bills, the condition “Separate Series” may occur. This function may be employed in conjunction with the modes described below where it is desired to discriminate of notes based on their series, e.g., to discriminate between a 1993-series $50 bills and 1950-series $50 bills or to discriminate between all pre-1996 series U.S. notes from all 1996 and later series U.S. notes.

Improper Size

An “Improper Size” condition occurs when a bill has a size that does not correspond to the size of one of the genuine bills that the device is programmed to recognize. For example, if the device is set to process U.S. bills, then all bills should have the same size and any document that is not the same size as genuine U.S. currency causes an “improper size” condition to occur. Likewise, for foreign bills, any document having a size other than one of the sizes of genuine foreign currency causes an “improper size” condition to occur.

Unfit Document

An “Unfit Document” condition occurs when a bill fails one or more fitness tests. Such fitness tests may detect, for example, the degree to which a bill is soiled, torn, or otherwise damaged. Likewise, the limpness of a bill may also be employed as a fitness test.

Reverse-Faced

An “Reverse-Faced” condition occurs when a currency processing device is operating in a facing mode and a bill having a face orientation other than a target face orientation is detected.

Reverse-Oriented

An “Reverse-Oriented” condition occurs when a currency processing device is operating in a Forward/Reverse Orientation mode and a bill having a forward/reverse orientation other than a target forward/reverse orientation is detected.

Strap Limit

The currency processing device may permit the setting of limits on the number of bills based on various conditions. For example, it may be desirable to gather $20 bills into stacks of fifty bills. Accordingly, if for example bills are being processed such that $20 bills and only $20 are being directed into the first output receptacle, the device may halt after fifty $20 bills have been delivered into the first pocket. The display may then indicate that a strap limit has been reached for the first output pocket. Various strap limits may be factory-preset or user-set. Alternatively, “Strap Limits” may be determined by combining the number of notes delivered to two or more of the output pockets.

Stacker Full

The “Stacker Full” condition occurs when either or both of the output receptacles are at or near capacity and are not to receive additional notes. For example, in an embodiment in which the output receptacles are designed to receive a maximum of 300 currency notes, the currency processing device may be programmed to halt after 300 notes have been delivered to either of the pockets. The “stacker full” condition thereby occurs upon delivery of the 300th note. Similarly, in an embodiment in which the output receptacles are designed to receive 600 currency notes, the “stacker full” condition occurs upon delivery of the 600th note.

Major Error Conditions

Major errors are conditions that typically stops the device and may require the operator to remove and re-process more than one note. According to one embodiment, major error conditions include Jam (J), Double (D), and Chain (C). The condition “Jam” occurs when one or more sensors detect that a jam is occurring when notes are being transported between the input receptacle and the output receptacles. The condition “Double” occurs when two or more notes are fed by the transport mechanism in a stacked manner. The condition “Chain” occurs when two or more notes are fed by the transport mechanism in an overlapping manner.

Operating Modes

The currency processing device may be selectively programmed to operate in any of several operating modes. In general, these operating modes may be categorized as “stranger modes,” “sort modes,” “mixed modes,” and “count modes” As described in greater detail below, the operating mode categories generally include two or three specific operating modes. An operator may select an individual operating mode or combination of operating modes as desired.

A. Stranger Modes

In general, stranger modes are used to process a stack of notes expected to be of the same denomination, in which the operator desires to remove “stranger” notes, or notes not having the same denomination. For example, a stranger mode may be selected to process a stack of notes substantially comprised of $10 bills so that all non-$10 bills may be removed from the stack. In a stranger mode, the device processes the stack and place the “target” $10 notes into a selected pocket (e.g., pocket 1). Upon encountering a stranger note (or upon encountering another selected error condition), the device may “present” the flagged note into the same pocket as the target note (i.e., stop the device after the flagged bill is delivered into an output pocket, e.g., pocket 1) to allow the operator to inspect the note, or the device may be programmed to off-sort the flagged note into the other pocket (e.g., pocket 2). Upon off-sorting the stranger note into pocket 2, the device may be designed to either stop (present the note into pocket 2) and allow the operator to inspect the note, or continue processing the remaining notes in the stack.

A display, such as a touch panel display, may indicate the number or aggregate value of notes having the target denomination, e.g., $10 bills. In one embodiment, the display is also capable of including totals associated with stranger notes via operator selection choices. For example, if a $5 stranger bill is detected in a stack of $10 bills, the operator may be prompted via the display as to whether the $5 bill should be incorporated into the running totals. If the operator responds positively, the $5 bill is incorporated into appropriate running totals, otherwise it is not. Alternatively, a set-up selection may be chosen whereby all stranger notes are automatically incorporated into appropriate running totals. The device may include the following stranger modes as described below: stranger 1, stranger 2, stranger facing, and stranger orientation.

Stranger 1 (STR 1)

In “Stranger 1” mode, the currency processing device processes a stack of notes and places notes having a target denomination into pocket 1. The target denomination may be selected automatically by the device to be that of the first note in the stack, or the target denomination may be explicitly selected by the operator. Upon the occurrence of a “stranger” condition (i.e., upon encountering a note not having the target denomination), the device may either present the flagged note into pocket 1 or off-sort the flagged note into pocket 2. Depending upon the set-up selected, the device may either present the off-sorted flagged bill or continue processing bills. Optionally, the device may be similarly programmed to either present or off-sort flagged notes upon the occurrence of the “no call,” “separate series,” or “suspect document” conditions (minor errors). Upon encountering either the “strap limit,” “stacker full,” “chain,” “double,” or “jam” condition, the device stops, requiring the operator to undertake the appropriate corrective action before continuing such as removing bills from a full pocket or clearing a jam.

Stranger 2 (STR 2)

In “Stranger 2” mode, as in “Stranger 1” mode, the device processes the stack and places notes having a target denomination into pocket 1. Upon encountering either the “strap limit” or “stacker full” condition, however, the device automatically begins delivering the target notes to pocket 2 provided that pocket is empty. Thereafter, upon encountering the “strap limit” or “stacker full” conditions again, the device automatically switches pockets and begins delivering bills into the other pocket if the other pocket has been cleared by the operator. If the other pocket has not been cleared, the device stops, requiring the operator remove the bills from either pocket 1 or pocket 2 before continuing. The display may indicate the aggregate value of the notes in the stack and/or the value or number of notes of each denomination in either pocket 1 or pocket 2.

Upon the occurrence of a minor error condition such as “stranger” (when the other pocket has not been cleared), no call, suspect document, or separate series, the device may either present the flagged note into the current pocket or off-sort the flagged note into the other pocket and stop (i.e., present the flagged note in the other pocket). Alternatively, the system may be set to always present flagged notes into a given pocket (e.g., pocket 2) regardless of which pocket is the current pocket. Major errors cause the device to stop and the operator to take appropriate corrective action such as clearing a jam and/or re-processing a stack of notes.

Stranger Facing (STR F)

In “Stranger Facing” mode, the currency processing device is designed to process a stack of notes faced in substantially the same direction (e.g., placed in the input hopper face up) and to detect any notes facing the opposite direction. The ability to detect and correct for reverse-faced notes is important as the Federal Reserve requires the currency it receives to be faced in the same direction. Thus, in “Stranger Facing” mode, the device processes a stack of notes and places notes faced in a target direction and having a target denomination into pocket 1. The target direction and denomination may be selected automatically by the device to be that of the first note in the stack, or the target direction and/or denomination may be explicitly selected by the operator. Upon the occurrence of a “stranger” condition (i.e., upon encountering a note having a denomination other than the target denomination) or upon the occurrence of a “reverse-faced” condition (i.e., upon encountering an opposite-faced note of the target denomination), the device either presents the flagged note into pocket 1 or pocket 2 or off-sorts the flagged note into pocket 2 and continues processing notes. Minor errors such as “suspect document,” “no call,” or “separate series” may be handled as discussed above, such as by presenting a flagged bill into either pocket 1 or pocket 2 or off-sorting into pocket 2 and continuing to process bills. For example, target notes may be delivered to pocket 1 and all other notes (strangers, no calls, suspect, separate series, reverse-faced) may be delivered to pocket 2. These bills may be simply off-sorted to pocket 2 and the device may continue to process successive notes. Alternatively, one or more of the above conditions may be presented into pocket 2 (e.g., no calls and suspects may cause the device to halt and appropriate messages to be displayed while strangers and reverse-faced notes are simply off-sorted but not presented).

According to another embodiment, notes having the target denomination and face orientation are delivered to one pocket (e.g., pocket 1) and notes having the target denomination but not the target face orientation are delivered to the other pocket (e.g., pocket 2). Only notes not having the target denomination are treated as stranger notes and may be handled by being presented into one of the pockets. Likewise, minor errors such as “suspect document,” “no call,” or “separate series” may be handled by presenting a flagged bill into either pocket 1 or pocket 2.

“Stacker full” or “strap limit” conditions may be handled by stopping and waiting for the operator to clear one or both pockets. The “strap limit” may be set up on a pocket by pocket basis or based on the combined contents of pockets 1 and 2. Major errors are handled as discussed above (see, e.g., discussion of the stranger 2 mode).

Stranger Orientation (STR 0)

In “Stranger Orientation” mode, the currency is designed to process a stack of notes faced in substantially the same forward/reverse orientation (e.g., in a predetermined forward or reverse orientation direction.) The forward direction may be defined as the feed direction whereby the top edge of a note is fed first and conversely for the reverse direction. The ability to detect and correct for reverse-oriented notes is important as the United States Federal Reserve may soon require currency it receives to be oriented in the same forward/reverse direction. Thus, in “Stranger Orientation” mode, the device processes a stack of notes and places notes having a target forward/reverse orientation and having a target denomination into pocket 1. The target orientation and denomination may be selected automatically by the device to be that of the first note in the stack, or the target direction and/or denomination may be explicitly selected by the operator. Upon the occurrence of a “stranger” condition (i.e., upon encountering a note having a denomination other than the target denomination) or a “reverse-oriented” condition (i.e., upon encountering an opposite-oriented note of the target denomination), the device either presents the flagged note into pocket 1 or pocket 2 or off-sort the flagged note into pocket 2 and continue processing notes. Minor errors such as “suspect document,” “no call,” or “separate series” may be handled as discussed above, such as by presenting a flagged bill into either pocket 1 or pocket 2 or off-sorting into pocket 2 and continuing to process bills. For example, target notes may be delivered to pocket 1 and all other notes (strangers, no calls, suspect, separate series, reverse-oriented) may be delivered to pocket 2. These bills may be simply off-sorted to pocket 2 and the device may continue to process successive notes. Alternatively, one or more of the above conditions may be presented into pocket 2 (e.g., no calls and suspects may cause the device to halt and appropriate messages to be displayed while strangers and reverse-oriented notes are simply off-sorted but not presented).

According to another embodiment, notes having the target denomination and orientation are delivered to one pocket (e.g., pocket 1) and notes having the target denomination but not the target orientation are delivered to the other pocket (e.g., pocket 2). Only notes not having the target denomination are treated as stranger notes and may be handled by being presented into one of the pockets. Likewise, minor errors such as “suspect document,” “no call,” or “separate series” may be handled by presenting a flagged bill into either pocket 1 or pocket 2.

“Stacker full” or “strap limit” conditions may be handled by stopping and waiting for the operator to clear one or both pockets. The “strap limit” may be set up on a pocket by pocket basis or based on the combined contents of pockets 1 and 2. Major errors are handled as discussed above (see, e.g., discussion of the stranger 2 mode).

B. Sort Modes

Generally, sort modes are designed to accommodate a pre-sorted stack of notes having a “rainbow” configuration, e.g., wherein the stack of notes includes two or more groups of notes, each group having a different denomination but each note within a given group having the same denomination. For example, the stack of notes may be pre-sorted to include a group of $1 bills at the beginning of the stack, followed by a group of $5 bills, followed by a group of $10 bills, etc. Sort modes permit a user to separate such a “rainbow” stack of notes into separate stacks according to denomination. Alternatively, sort modes may be used to sort a mixed stack of notes, e.g., not pre-sorted, into separate stacks according to denomination.

For example, in a sort mode, the currency processing device may process a stack of notes and deposit a first group of “target” notes (e.g., $1 bills) into a selected pocket. Upon encountering a “denomination change” condition (or upon encountering another selected flagging condition), the device may “present” the flagged note into the same pocket as the target note and stop to allow the operator to inspect the note, or the device may be programmed to off-sort the flagged note into the other pocket. Upon off-sorting the denomination change note or other flagged note into pocket 2, the device may be designed to either stop and allow the operator to inspect the note or to continue processing the remaining notes in the stack.

As described in relation to stranger modes above, the currency processing device may include a display to indicate the number or aggregate value of notes of each respective denomination and/or the number or aggregate value of notes in the stack. The currency processing device may include the following sort modes as described below: sort 1, sort 2, sort 3, sort facing and sort orientation.

1. Sort 1 (SRT 1)

In “Sort 1” mode, the currency processing device is designed to process a stack of notes and place notes having a first target denomination (e.g., target denomination 1) into pocket 1 and a second target denomination (e.g., target denomination 2) into pocket 2. The target denominations may be selected by the operator prior to sorting through a stack, or may be selected automatically by the device, e.g., the first encountered denomination being designated target denomination 1 and the second encountered denomination being designated target denomination 2.

Where target denominations are set by the operator, bills of target denomination 1 are delivered into pocket 1 and bills of target denomination 2 are delivered to pocket 2. Bills having a denomination other than target denomination 1 or 2 are flagged. The flagged bills are presented into either pocket 1 or pocket 2.

For example, in one embodiment, the device automatically designates the first target denomination (target note 1) to be that of the first note in the stack, then proceeds to deliver target note 1 to pocket 1. Upon encountering a “denomination change” condition, the device flags the note, designates the flagged note as the second target denomination (target note 2) and delivers target notes 2 to pocket 2. Thereafter, upon encountering another “denomination change” condition, if the appropriate pocket has been cleared by the operator, the device proceeds to deliver the third denomination of bills into pocket 1, the fourth denomination of bills into pocket 2, and so on. If the appropriate pocket has not been cleared, the device stops upon a “denomination change” condition, requiring the operator remove the bills from the appropriate pocket before continuing.

Upon encountering other minor errors such as “no call,” “suspect document,” and “separate series,” the device stops, presenting the flagged bills into one of the pockets. “Stacker full” or “strap limit” conditions may be handled by stopping and waiting for the operator to clear one or both pockets. Major errors are handled as discussed above (see, e.g., discussion of the stranger 2 mode).

For example, in an embodiment in which the currency processing device automatically selects the target denominations, if the first note in the stack is a $1 bill, the device designates target note 1 as a $1 bill and deliver $1 bills into pocket 1 until encountering the first non-$1 bill. The first non-$1 bill, which for example may be a $5 bill, is then designated as target note 2 and is delivered to pocket 2. Then, if and when the device encounters a bill having a third denomination, which for example may be a $10 bill, the device either directs any subsequent $10 bills into pocket 1, or stops if necessary to allow the operator to clear pocket 1. The device may be designed to automatically resume operation delivering subsequent $10 bills into pocket 1 when the operator removes all the bills present in pocket 1. Assuming that pocket 1 is clear, the device then delivers $10 bills into pocket 1 until encountering the next series of bills, and so on until the entire stack has been processed.

2. Sort 2 (SRT 2)

In “Sort 2” mode, the device processes a stack of notes and place notes having a target denomination into pocket 1. The target denomination may be selected automatically by the device to be that of the first note in the stack, or the target denomination may be selected by the operator. Upon the occurrence of the “denomination change” condition (e.g., upon encountering a note not having the target denomination), the device “presents” the flagged note into pocket 1 and stops to allow the operator to inspect the note. Alternatively, the system may be programmed to present “denomination change” notes in pocket 2.

Upon encountering other minor errors such as “no call,” “suspect document,” and “separate series,” the device stops presenting the flagged bills into one of the pockets. Alternatively, one or more of these conditions may cause flagged bills to be off-sorted into pocket 2 without causing the system to stop. The system may permit the operator to select how these bills are to be handled via a set-up option.

“Stacker full” or “strap limit” conditions may be handled by stopping and waiting for the operator to clear one or both pockets. Major errors are handled as discussed above (see, e.g., discussion of the stranger 2 mode).

For example, in an embodiment in which the device automatically selects the target denominations, if the first note in the stack is a $1 bill, the device designates $1 as the target note and delivers $1 bills into pocket 1 until encountering the first non-$1 bill. The first non-$1 bill, which may for example be a $5 bill, is then “presented” into pocket 1. The operator may then remove all $1 bills from pocket 1 and then select an appropriate continuation key. If the first note in the remainder of the stack is also a $5 bill, the device designates $5 as the new target note and proceeds to deliver $5 bills into pocket 1 until encountering the first non-$5 bill, and so on until the entire stack has been processed. If the first note in the remainder of the stack is not a $5 bill, then a denomination change error occurs and the device presents the non-$5 bill into pocket 1, and so on. According to another embodiment, after a denomination change note is presented into pocket 1, the device restarts automatically when the operator removes all the bills in pocket 1. The operator may then separate the bills by denomination (e.g., place all $1 bills into one stack and the last $5 bill into its own stack).

3. Sort 3 (SRT 3)

In “Sort 3” mode, the device processes a stack of notes and place notes having a target denomination into pocket 1, as in the Sort 2 mode. However, upon the occurrence of the “denomination change” condition, the system off-sorts the flagged notes into pocket 2 rather than presents the flagged notes into pocket 1. The device may or may not be designed to stop after encountering non-target notes, i.e., “denomination change” notes.

According to one embodiment notes having a target denomination (target 1) are delivered to pocket 1. Upon encountering a first denomination change, the denomination of the first non-target 1 note is designated as a target 2 denomination (target 2). Target 2 notes and then off-sorted into pocket 2 without causing the device to stop. The device continues to process notes, delivering target 1 notes to pocket 1 and target 2 notes to pocket 2, until the first note having a denomination other than target 1 denomination or target 2 denomination is encountered. At this point this third denomination note is designated as the “new” target 2 denomination and is directed toward pocket 2. According to one embodiment this third denomination note is delivered to pocket 2 and the device is stopped with the display indicating a denomination change in pocket 2. The operator can then take the appropriate action such as removing all notes in pocket 2 (e.g., in an automatic restart configured set up) or remove all bills other than the third denomination bill and press a continuation key. The device then continues processing notes, continuing to deliver original target 1 notes to pocket 1, and delivering “new” target 2 notes to pocket 2, until encountering a bill having a denomination other than target 1 or the present target 2. At this point, a denomination change occurs as described above and a new target 2 denomination is designated.

According to another embodiment, when a new target 2 note is encountered, the transport mechanism stops before the new target 2 note is delivered into the second output receptacle and a denomination change in pocket 2 message is displayed. In this manner, when the device stops, all the bills in pocket 2 have the same denomination. The operator may then remove all the bills in pocket 2 and set them aside. Depending on the set up, the device may either resume operation automatically or resume upon the selection of a continuation key. When the device resumes, the new target note 2 is delivered into the now empty pocket 2 and the device continues processing bills until encountering a “new” target note 2 denomination.

Upon encountering other minor errors such as “no call”, “suspect document”, and “separate series”, the device stops, presenting the flagged bills into one of the pockets. “Stacker full” or “strap limit” conditions may be handled by stopping and waiting for the operator to clear one or both pockets. Major errors are handled as discussed above (see e.g., discussion of the stranger 2 mode).

For example, in an embodiment in which the device automatically selects the target denominations, if the first note in the stack is a $1 bill, the device designates $1 as the target note and delivers $1 bills into pocket 1 until encountering the first non-$1 bill. The first non-$1 bill, which may for example be a $5 bill, is then off-sorted into pocket 2. According to one embodiment, the device then continues to process notes, delivering $1 bills into pocket 1 and $5 bills into pocket 2, until encountering the next denomination change (i.e., a bill other than a $1 or a $5). Thereafter, upon encountering the next denomination change, such as a $10 bill, the $10 bills are designated as the new target 2 denomination and the system halts so that pocket 2 may be cleared. When the system resumes operation, the device continues to process notes, delivering $1 bills into pocket 1 and $10 bills into pocket 2, until encountering the next denomination change (i.e., a bill other than a $1 or a $10), and so on.

4. Sort 4 (SRT 4)

In “Sort 4” mode, the device processes a stack of notes and place notes having a target denomination into pocket 1. All other notes are delivered to pocket 2. Thus, upon the occurrence of the “denomination change” condition, the system off-sorts the flagged note into pocket 2. The device then continues processing any remaining bills without stopping. According to one embodiment, only notes having the target denomination (pocket 1) are counted while all non-target notes are simply delivered to pocket 2 without being counted.

Upon encountering other minor errors such as “no call,” “suspect document,” and “separate series,” the device may be programmed to stop, presenting the flagged bills into one of the pockets such as pocket 2. Alternatively, the device may be programmed to effectively ignore one or more of the minor errors such as “no call,” “suspect document,” and “separate series” and to simply off-sort such bills to pocket 2 and continue processing any remaining bills. For example, the device may be set-up to simply off-sort into pocket 2 and continue processing bills upon encountering a “no call” or “separate series” note while stopping and presenting any “suspect documents” into pocket 2. Thus in this example, the device quickly processes an entire stack of bills, separating bills of a target denomination from all other notes in the stack. Apart from major errors and “stacker full” or “strap limit” conditions, the device only stops if a suspect document is encountered.

“Stacker full” or “strap limit” conditions may be handled by stopping and waiting for the operator to clear one or both pockets. Major errors are handled as discussed above (see, e.g., discussion of the stranger 2 mode).

5. Sort Facing (SRT F)

“Sort Facing” mode is substantially similar to “Stranger Facing” mode, the primary difference being the configuration of the stack of notes prior to processing. In “Sort Facing” mode, the stack of notes is generally pre-sorted into one or more groups of notes, each group being faced in a different direction, but each note within a given group facing the same direction and having the same denomination as other notes in that group, whereas in “Stranger Facing” mode, each note in the stack is expected to be faced in the same direction and have the same denomination. Thus, in “Sort Facing” mode, the device processes the stack and place notes of a target denomination faced in a target direction into pocket 1. Upon encountering a target denomination but reverse-faced note (i.e., a reverse-faced condition), the device either presents the flagged note into pocket 1 or off-sort the flagged note into pocket 2. When the reverse-faced target note is off-sorted to pocket 2, the device may either present this note into pocket 2 or continue processing notes. The device may permit the operator to select how these bills are to be handled via a set-up option (e.g., present into pocket 1, present into pocket 2, or off-sort into pocket 2 and continue).

Upon encountering other minor errors such as “no call,” “suspect document,” and “separate series,” the device stops, presenting the flagged bills into one of the pockets. “Stacker full” or “strap limit” conditions may be handled by stopping and waiting for the operator to clear one or both pockets. The “strap limit” may be set up on a pocket by pocket basis or based on the combined contents of pockets 1 and 2. Major errors are handled as discussed above (see, e.g., discussion of the stranger 2 mode).

6. Sort Orientation (SRT O)

“Sort Orientation” mode is substantially similar to “Stranger Orientation” mode, the primary difference being the configuration of the stack of notes prior to processing. In “Sort Orientation” mode, the stack of notes is pre-sorted into one or more groups of notes, each group being oriented in a different direction, but each note within a given group having the same denomination and being oriented the same as other notes in that group. The device processes the stack and place notes having the target denomination and being oriented in a target direction into pocket 1. Upon encountering a target denomination but reverse-oriented note (i.e., a reverse-oriented condition), the device either presents the flagged note into pocket 1 or off-sort the flagged note into pocket 2. When the reverse-oriented target note is off-sorted to pocket 2, the device may either present this note into pocket 2 or continue processing notes. The device may permit the operator to select how these bills are to be handled via a set-up option (e.g., present into pocket 1, present into pocket 2, or off-sort into pocket 2 and continue).

Upon encountering other minor errors such as “no call,” “suspect document,” and “separate series,” the device stops, presenting the flagged bills into one of the pockets. “Stacker full” or “strap limit” conditions may be handled by stopping and waiting for the operator to clear one or both pockets. The “strap limit” may be set up on a pocket by pocket basis or based on the combined contents of pockets 1 and 2. Major errors are handled as discussed above (see e.g., discussion of the stranger 2 mode).

7. Sort Series (SRT S)

In “Sort Series” mode, the device processes a stack of notes and places notes of a target series or group of series into pocket 1. Upon the occurrence of the “separate series” condition (e.g., upon encountering a note not having the target series), the device off-sorts the flagged note into pocket 2. The device may be programmed to stop or not to stop after encountering non-target notes, i.e., “separate series” notes. Alternatively, upon the occurrence of the “separate series” condition, the device may “present” the flagged note into pocket 1 and stop to allow the operator to inspect the note.

a. Update Pocket 2 Target—Denomination and Series

For example, in an embodiment in which the device automatically selects the target series and denomination, if the first note in the stack is a 1996-series $100 bill, the device designates 1996-series $100 bills as the target note and delivers 1996-series $100 bills into pocket 1 until encountering the first non-1996-series $100 bill. The first non-1996-series $100 bill, which may, for example, be a 1995-series $5 bill, is then off-sorted into pocket 2. According to one embodiment, the device then continues to process notes, delivering 1996-series $100 bills into pocket 1 and 1995-series $5 bills into pocket 2, until encountering the next separate series condition (i.e., a bill other than a 1996-series $100 or a 1995-series $5). Thereafter, upon encountering the next separate series condition, such as a 1995-series $10 bill, the 1995-series $10 bills are designated as the new target 2 series and the device halts so that pocket 2 may be cleared. When the device resumes operation, the device continues to process notes, delivering 1996-series $100 bills into pocket 1 and 1995-series $10 bills into pocket 2, until encountering the next separate series condition (i.e., a bill other than a 1996-series $100 or a 1995-series $10), and so on.

b. Update Target 1—Denomination and Series

According to another embodiment in which target notes are defined in terms of series and denomination and in which the device automatically selects the target series and denomination, if the first note in the stack is a 1996-series $100 bill, the device designates 1996-series $100 as the target series and denomination and delivers 1996-series $100 bills into pocket 1 until encountering the first non-1996-series $100 bill. The first non-1996-series $100 bill, which may for example be a 1995-series $5 bill, is then be “presented” into pocket 1. The operator may then remove all 1996-series $100 bills from pocket 1 and then select an appropriate continuation key. The device then designates 1995-series $5 as the new target note and proceeds to deliver 1995-series $5 bills into pocket 1 until encountering the first non-1995-series $5 bill, and so on until the entire stack has been processed. If a note in the remainder of the stack is not a 1995-series $5 bill, then a separate series error occurs and the device presents the non-1995-series $5 bill into pocket 1, and so on. According to another embodiment, after a separate series note is presented into pocket 1, the device restarts automatically when the operator removes all the bills from pocket 1. The operator may then separate the bills by denomination and series (e.g., place all 1996-series $100 bills into one stack and the last 1995-series $5 bill into its own stack). Minor errors such as “no calls” and “suspect documents” may be presented in pocket 2 or off-sorted into pocket 2 with the device continuing to process bills.

c. Update Pocket 2 Target—Series

According to another embodiment, target notes are defined only by series or group of series regardless of denomination. According to one embodiment, notes having a target series (target 1) are delivered to pocket 1. Upon encountering a first separate series condition, the series of the first non-target 1 note is designated as a target 2 series (target 2). Target 2 notes are then off-sorted into pocket 2 without causing the device to stop. The device continues to process notes, delivering target 1 notes to pocket 1 and target 2 notes to pocket 2, until the first note having a series other than target 1 series or target 2 series is encountered. At this point this third series note is designated as the “new” target 2 series and is directed toward pocket 2. According to one embodiment this third series note is delivered to pocket 2 and the device is stopped with the display indicating a series change in pocket 2. The operator can then take the appropriate action such as removing all notes in pocket 2 (e.g., in an automatic restart configured set up) or remove all bills other than the third series bill and press a continuation key. The device then continues processing notes continuing to deliver original target 1 notes to pocket 1 and delivering “new” target 2 notes to pocket 2, until encountering a bill having a series other than target 1 or the current target 2. At this point, a separate series condition occurs as described above and a new target 2 series is designated.

According to another embodiment, when a new target 2 note is encountered, the transport mechanism stops before the new target 2 note is delivered into the second output receptacle and a series change in pocket 2 message is displayed. In this manner, when the device stops, all the bills in pocket 2 have the same series. The operator may then remove all the bills in pocket 2 and set them aside. Depending on the set up, the device may either resume operation automatically or resume upon the selection of a continuation key. When the device resumes, the new target note 2 is delivered into the now empty pocket 2 and the device continues processing bills until encountering a “new” target note 2 series.

Upon encountering other minor errors such as “no call” and “suspect document,” the device stops presenting the flagged bills into one of the pockets. “Stacker full” or “strap limit” conditions may be handled by stopping and waiting for the operator to clear one or both pockets. Major errors are handled as discussed above (see e.g., discussion of the stranger 2 mode).

For example, in an embodiment in which the device automatically selects the target series, if the first note in the stack is a 1996-series $100 bill, the device designates 1996-series bills as the target series and delivers all 1996-series bills into pocket 1 until encountering the first non-1996-series bill. The first non-1996-series bill, which may for example be a 1995-series $5 bill, is off-sorted into pocket 2. According to one embodiment, the device then continues to process notes, delivering 1996-series bills into pocket 1 and 1995-series bills into pocket 2, until encountering the next separate series condition (i.e., a bill other than a 1996-series or a 1995-series note). Thereafter, upon encountering the next separate series condition, such as a 1993-series $20 bill, 1993-series bills are designated as the new target 2 series and the device halts so that pocket 2 may be cleared. The device then continues to operate in a similar manner as described in the paragraph entitled “Update Pocket 2 Target—Denomination and Series.”

d. Update Target 1—Series

According to another embodiment in which target notes are defined only by series or group of series regardless of denomination and in which the currency processing device automatically selects the target series and denomination, if the first note in the stack is a 1996-series $100 bill, the device designates 1996-series as the target series and delivers all 1996-series bills into pocket 1 until encountering the first non-1996-series bill. The first non-1996-series bill, which may for example be a 1995-series $5 bill, is then “presented” into pocket 1. The device then continues to operate in a similar manner as described in the above paragraph entitled “Update Target 1—Denomination and Series” designating 1995-series notes as the new target series. Minor errors such as “no calls” and “suspect documents” may be presented in pocket 2 or off-sorted into pocket 2 with the device continuing to process bills.

According to another embodiment, target series are defined by series or group of series without regard to denomination. Moreover, factory default or user defined series categories may be defined. For example, a “new series” group may be defined to include all bills having a series of 1996 or later. This group may include for example, 1996-series $100s and 1997-series $50s and $20s). An “old-series” group may be defined as all other bills. Alternatively, a “series 1” group may be defined to include, for example, all 1996-series and later $100s, all 1997-series and later $50s and $20s, and all $1s, $2, $5, and $10 regardless of series). Likewise, an accompanying “series 2” group may be defined to include all pre-1996-series $100s and all pre-1997-series $50s and $20s. Using series 1 or series 2 in one of the above described series mode embodiments permits the separation of all “old” series $100s, $50s, and $20s from all other bills. Such an embodiment facilitates in the culling of all bills that are to be removed from circulation. As additional “new” series bill enter circulation (e.g., a 1999-series $10 bill), the definitions of series 1 and series 2 may then be modified so that all bills that are to be removed from circulation may be easily culled from all other bills.

For example, a series group (Series A) may be defined as all bills having a series of 1995 or later. According to one embodiment, Series A is designated as the target series and all Series A notes are delivered to pocket 1 and all non-Series A bills are off-sorted to pocket 2. The device may or may not be programmed to halt when a non-Series A note is encountered. Where the device is not programmed to halt, a stack of bills may be quickly processed and separated into a group consisting of all 1995 and later series notes (pocket 1) and all pre-1995 series notes (pocket 2).

C. Mixed Modes

Generally speaking, mixed modes are designed to accommodate a stack of notes having a “mixed” configuration, e.g., including two or more denominations of notes in no particular order, where the operator desires to determine the number or aggregate value of notes of each respective denomination and/or the number or aggregate value of notes in the stack. Mixed modes “Mix 1,” “Mix,2” “Mixed Facing,” and “Mixed Orientation,” each of which is described below. As with stranger and sort modes, the currency processing device may include a display to indicate the number or aggregate value of notes of each respective denomination and/or the number or aggregate value of notes in the stack.

Mixed 1 (Mix 1)

In “Mix 1” mode, the currency processing device processes the stack of mixed notes and generally places the notes into pocket 1. However, upon the occurrence of the “no call” or “suspect document” condition, the device flags the note either presents the flagged note into pocket 1 or off-sorts the flagged note into pocket 2. The device may permit the operator to select how these bills are to be handled via a set-up option (e.g., present into pocket 1, present into pocket 2, or off-sort into pocket 2 and continue).

A “Stacker full” condition may be handled by stopping and waiting for the operator to clear the full pocket. Major errors are handled as discussed above (see, e.g., discussion of the stranger 2 mode).

Mixed 2 (Mix 2)

In “Mix 2” mode, as in “Mix 1”mode, the currency processing device processes the stack and begins placing notes into pocket 1 until encountering a “no call” or “suspect document” condition, in which case the device flags the note and presents the flagged note into either pocket 1 or pocket 2. The device may permit the operator to select how these bills are to be handled via a set-up option (e.g., present into pocket 1 or present into pocket 2).

Upon encountering the “stacker full” condition, however, the device does not stop, as in “Mix 1” mode, but instead automatically begins delivering the notes to pocket 2. Thereafter, upon encountering the “stacker full” condition in pocket 2, the device again switches pockets and begins delivering bills into pocket 1 if pocket 1 has been cleared by the operator. If pocket 1 has not been cleared and the “stacker full” condition thereby exists in both pockets 1 and 2, the device stops, requiring the operator to remove the bills from either pocket 1 or pocket 2 before continuing. Major errors are handled as discussed above (see, e.g., discussion of the stranger 2 mode).

Mixed Facing (Mix F)

In “Mixed Facing” mode, the currency processing device processes a stack of mixed notes and place notes faced in a target direction into pocket 1. Upon encountering a reverse-faced note, the device either presents the reversed-faced note into pocket 1 or off-sort the reverse-faced note into pocket 2. The device may permit the operator to select how these bills are to be handled via a set-up option (e.g., present into pocket 1, present into pocket 2, off-sort into pocket 2 and continue).

Upon encountering a “no call” or “suspect document” condition, the device flags the note and either presents the flagged note into pocket 1 or off-sorts the flagged note into pocket 2. The device may permit the operator to select how these bills are to be handled via a set-up option (e.g., present into pocket 1, present into pocket 2, off-sort into pocket 2 and continue). Where reverse-faced notes are being off-sorted into pocket 2 without causing the device to halt, no calls and suspect documents should be presented into either pocket 1 or pocket 2.

The device stops requiring the operator to remove the bills from the appropriate pocket before continuing, upon encountering a “stacker full” condition. Major errors are handled as discussed above (see, e.g., discussion of the stranger 2 mode).

Mixed Orientation (Mix 0)

In “Mixed Orientation” mode, the currency processing device processes a stack of mixed notes and places notes oriented in a target direction into pocket 1. Upon encountering a reverse-oriented note, the device either presents the flagged note into pocket 1 or off-sorts the flagged note into pocket 2. The device may permit the operator to select how these bills are to be handled via a set-up option (e.g., present into pocket 1, present into pocket 2, off-sort into pocket 2 and continue).

Upon encountering a “no call” or “suspect document” condition, the device flags the note and either presents the flagged note into pocket 1 or off-sorts the flagged note into pocket 2. The device may permit the operator to select how these bills are to be handled via a set-up option (e.g., present into pocket 1, present into pocket 2, off-sort into pocket 2 and continue). Where reverse-oriented notes are being off-sorted into pocket 2 without causing the device to halt, no calls, and suspect documents should be presented into either pocket 1 or pocket 2.

The device stops requiring the operator to remove the bills from the appropriate pocket before continuing, upon encountering the “stacker full” condition. Major errors are handled as discussed above (see, e.g., discussion of the stranger 2 mode).

D. Count Mode (CNT)

“Count Mode” is designed to accommodate a stack of notes in any configuration, where the operator desires to determine the number or total value of notes in a stack. The device processes the stack, placing notes into pocket 1 until encountering a “stacker full” or “strap limit” condition, in which case the device automatically begins to place the notes into pocket 2. Thereafter, upon encountering the “stacker full” or “strap limit” condition in pocket 2, the again switches pockets and begin delivering bills into pocket 1 if pocket 1 has been cleared by the operator. If pocket 1 has not been cleared and the “stacker full” or “strap limit” condition thereby exists in both pockets 1 and 2, the device stops requiring the operator to remove the bills from either pocket 1 or pocket 2 before continuing. Count mode may operate in either a unit mode or a value mode. In the unit mode, notes are simply counted and the total number of notes is communicated. In the value mode, the values of notes are totaled and the total value is communicated. Likewise, strap limits may be defined in terms of a unit or piece count (e.g., 100 notes) or in terms of a total value (e.g., $200 notes in notes).

The device also stops requiring the operator to remove the bills from the appropriate pocket, upon encountering a “suspect document” condition. Major errors are handled as discussed above (see, e.g., discussion of the stranger 2 mode).

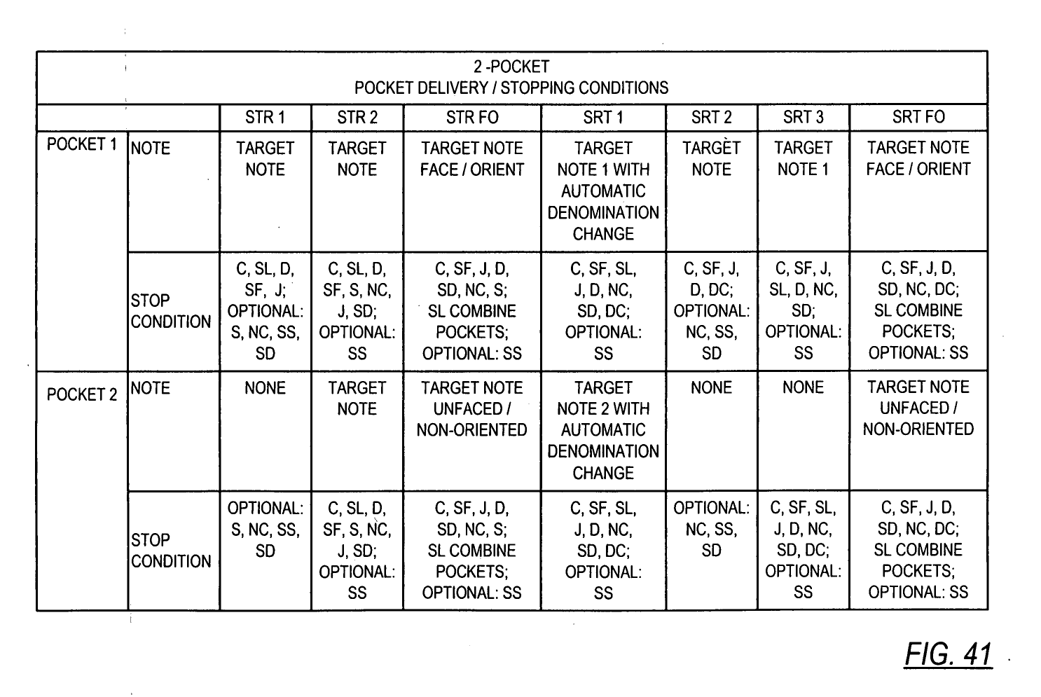

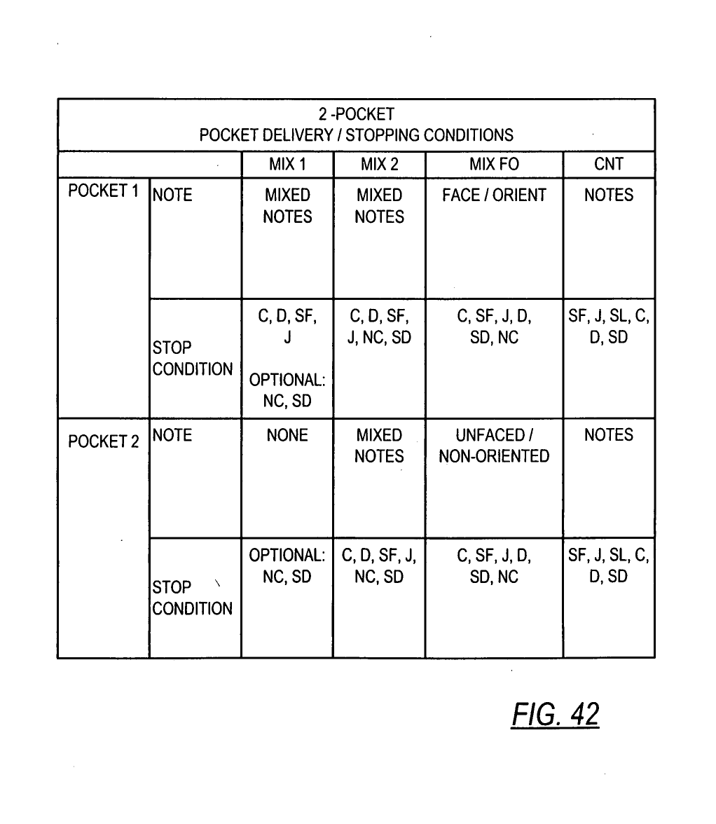

FIGS. 41 and 42 summarize some embodiments of the above described modes of operation for the currency processing device. For example, in Stranger 1 mode (STR 1), bills having a target denomination are delivered into pocket 1. Chains (C), Jams (J), and Doubles (D) cause the device to halt with chain, jammed, and doubled bills being directed to pocket 1. Also, strap limits (SL) and stacker full (SF) errors in pocket 1 cause the device to halt. Strangers (S), No Calls (NC), Separate Series (SS), and Suspect (SD) bills may be optionally directed to either pocket 1 or pocket 2 depending on user selections.

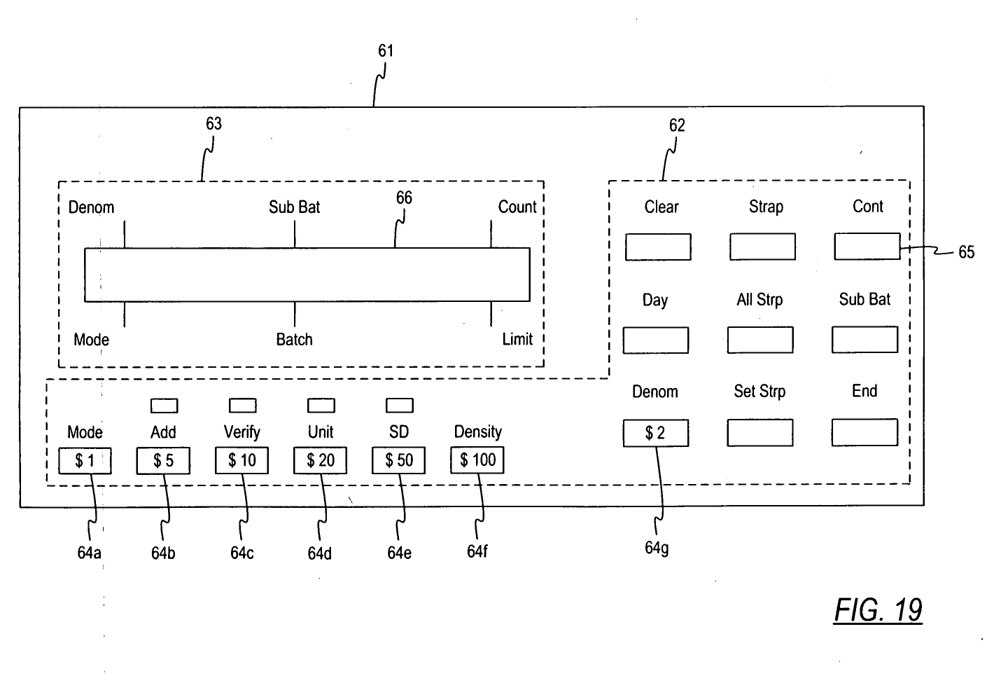

Each of the above operating modes is designed to be selectively activated, either individually or in combination, by an operator. In one embodiment of the present invention, the operating modes may be activated through a control panel. FIG. 19 is a front view of a control panel 61 according to one embodiment of the present invention. The control panel 61 comprises a keypad 62 and a display section 63. The keypad 62 comprises a plurality of keys including seven denomination selection elements 64a-64g, each associated with one of seven U.S. currency denominations, i.e., $1, $2, $5, $10, $20, $50, and $100. For foreign bill processing devices, the denomination selection elements may be labeled according to the currency system that the device is designed to handle, and accordingly, there may be more or less than seven denomination selection elements. The $1 denomination selection key 64a also serves as a mode selection key. The keypad 62 also comprises a “Continuation” selection element 65. Various information such as instructions, mode selection information, authentication and discrimination information, individual denomination counter values, and total batch counter value are communicated to the operator via an LCD 66 in the display section 63.

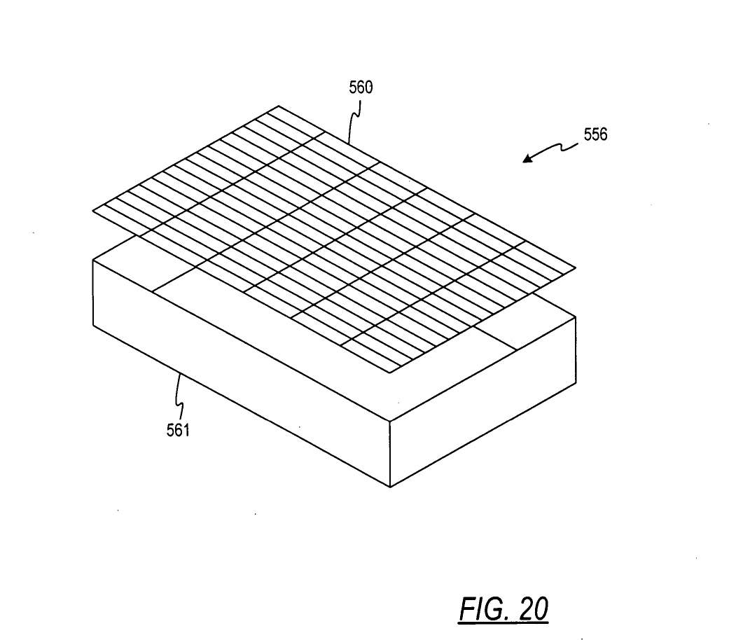

According to another embodiment, a touch screen is employed to display selection elements for selection by the operator as well as to display various messages to the operator including status and error conditions. Additionally, the touch screen input/output device may be employed to provide on-line help information to the operator, for example, to explain an operation feature or how to handle a given error condition. An example of a touch screen is illustrated in FIG. 20. The touch screen I/O device 556 includes a touch screen 560 mounted over a graphics display 561. In one embodiment, the display 561 is a liquid crystal display (LCD) with backlighting. The display may have, for example, 128 vertical pixels and 256 horizontal pixels. The display 561 contains a built-in character generator which permits the display 561 to display text and numbers having font and size pre-defined by the manufacturer of the display. Moreover, a controller such as a CPU is programmed to permit the loading and display of custom fonts and shapes (e.g., key outlines) on the display 561. The display 561 is commercially available as Part No. GMF24012EBTW from Stanley Electric Company, Ltd., Equipment Export Section, of Tokyo, Japan.

The touch screen 560 may be an X-Y matrix touch screen forming a matrix of touch responsive points. The touch screen 560 includes two closely spaced but normally separated layers of optical grade polyester film each having a set of parallel transparent conductors. The sets of conductors in the two spaced polyester sheets are oriented at right angles to each other so when superimposed they form a grid. Along the outside edge of each polyester layer is a bus which interconnects the conductors supported on that layer. In this manner, electrical signals from the conductors are transmitted to the controller. When pressure from a finger or stylus is applied to the upper polyester layer, the set of conductors mounted to the upper layer is deflected downward into contact with the set of conductors mounted to the lower polyester layer. The contact between these sets of conductors acts as a mechanical closure of a switch element to complete an electrical circuit which is detected by the controller through the respective buses at the edges of the two polyester layers, thereby providing a means for detecting the X and Y coordinates of the switch closure. A matrix touch screen 560 of the above type is commercially available from Dynapro Thin Film Products, Inc. of Milwaukee, Wis.

As illustrated in FIG. 20, the touch screen 560 forms a matrix of ninety-six optically transparent switch elements having six columns and sixteen rows. The controller is programmed to divide the switch elements in each column into groups of three to form five switches in each column. Actuation of any one of the three switch elements forming a switch actuates the switch. The uppermost switch element in each column remains on its own and is unused.

Although the touch screen 560 uses an X-Y matrix of optically transparent switches to detect the location of a touch, alternative types of touch screens may be substituted for the touch screen 560. These alternative touch screens use such well-known techniques as crossed beams of infrared light, acoustic surface waves, capacitance sensing, and resistive membranes to detect the location of a touch. The structure and operation of the alternative touch screens that may be used with alternative embodiments of the present invention as are described and illustrated, for example, in U.S. Pat. Nos. 5,317,140; 5,297,030; 5,231,381; 5,198,976; 5,184,115; 5,105,186; 4,931,782; 4,928,094; 4,851,616; 4,811,004; 4,806,709; and 4,782,328; each of which is incorporated herein by reference in its entirety.

As described briefly above, one of the functions of the touch screen display is to display selection elements which may be selected by touching the portion of the screen associated with the selection element. The touch screen thereby serves in one respect as a “keyboard,” wherein the selection elements displayed on the screen represent “keys” that are activated by touching the associated area of the screen. Alternatively, it is appreciated that a conventional keyboard may be used instead of or in addition to the touch screen keyboard to facilitate selection of various selection elements. In embodiments using a touch screen, the touch screen display may display not only selection elements or “keys,” but also may display messages to the operator including status and error conditions of the discrimination system. Preferably, the configuration of the touch screen display is programmably changeable between several configurations, so that at any given time the touch screen displays only those “keys” or status and error conditions that are appropriate with respect to the present status of the discrimination system. For example, the touch screen may display a series of “menus” or “sub-menus,” each menu being associated with a particular mode of operation or status of the discrimination system and thereby including only those keys or display conditions appropriate to the particular mode or status of the discrimination system. The menu-driven approach is designed to simplify the “keyboard” for operators and reduce training times accordingly. The touch screen display may be programmed via computer software including set-up software, operation software, and diagnostic software.

Set-Up Information

The set-up software is designed to enable the operator to customize various operating parameters and engage or disengage various features of the currency processing device. The operating parameters may include, for example, default settings, stopping conditions, off-sort modes, pocket settings, denomination keys, stranger records, or communications port settings. For example, a set-up mode may permit the user to identify which pocket is to receive no calls, suspect documents, mis-faced and mis-oriented documents, strangers, denomination changes, doubles, and chains or other bills or documents causing other types of minor or major errors. This information may be retrieved from the user via a routing interface having a data retrieval device such as a touch-screen. Alternatively, the data retrieval device may be some other kind of input or input/output device such as a keypad, buttons, or switches. Likewise, the set-up mode may permit the user to define which pockets are to receive which kinds of bills and whether the device should stop upon the occurrence of various events, e.g., various minor errors. Information concerning whether the system should stop upon the occurrence of one or more of the above conditions may be retrieved from the user via a flagging control interface having a flagging data retrieval device such as a touch-screen. Alternatively, the flagging data retrieval device may be some other kind of input or input/output device such as a keypad, buttons, or switches. The flagging control interface may be combined with the routing interface. Likewise the same touch-screen or input device may be used both to retrieve data concerning to which pockets various bills are to be directed as well as whether the device should stop upon the occurrence of one or more events such as the occurrence of one or more types of minor errors. The features of the currency processing device which may be engaged or disengaged in the set-up mode include operating modes, operating keys, sub-batching, suspect document authentication tests, stranger records, separate series discrimination, and/or audio alarms.

As described generally above, in a touch screen embodiment, the above-described operating features may be activated by touching selection elements or “keys” in respective “menus” associated with the operating features. Thus, in the set-up mode, the currency processing device may include the following:

a key or keys which allows the customization of user-default settings or the selection of a factory default setting;

a key which engages or disengages sub-batching;

a key or keys which engage or disengage the operating modes, e.g., STR 1, STR 2, STR F, STR O, SRT 1, SRT 2, SRT 3, SRT F, SRT O, Mix 1, Mix 2, MIX F, MIX O and Count;

a key or key which engages or disengages the operating keys “Verify” (permits the device to process bills without affecting existing totals), “Unit” (toggles between unit and value modes), “SD,” “Density,” “Add” (toggles between maintaining running totals and clearing running totals when the input hopper and both output pockets are cleared), or “Mode;”

a key or keys which engages or disengages the audio alarms for the various error conditions, e.g., Jam (J), Doubles (D), Chain (C), Stranger (S), Denomination Change (DC), No Call (NC), Suspect Document (SD), Separate Series (SS), Strap Limit (SL), or Stacker Full (SF);

a key or keys which sets the use of denomination keys for the minor errors of no call (NC) and suspect document (SD);

a key or keys which sets a stranger record (i.e., sets whether the system should “record” or reflect in the appropriate counters the denomination/value of stranger notes);

a key for enabling or disabling the SD minor error condition;

a key for enabling or disabling the SS minor error condition;

a key or keys for setting the configuration of communication ports;

a key or keys for setting pockets for target notes, either manually or automatically;

a key or keys for enabling or disabling the “off-sort” function or customizing stopping conditions related to the off-sort function (e.g., present into pocket 1, present into pocket 2, off-sort and continue); and

a key or keys for engaging or disengaging the “Face” and “Right” keys (the “Right” key is a forward/reverse orientation key).

When engaged in the set-up mode, pressing the “Face” key gives the user the ability to quick-face a stack of bills. The device delivers face-up bills to pocket 1 and face-down bills to pocket 2. Similarly, pressing the “Right” key gives the user the ability to quick-right a stack of bills. The device delivers “readable” bills, e.g., wherein the words of the bill are right-side-up, to pocket 1 and non-readable bills, e.g., . wherein the words of the bill are upside-down, to pocket 2. Accordingly, the “Right” key causes bills having a forward orientation to be delivered to one pocket while causing bills having a reverse orientation to be delivered to the other pocket.

Operation Screens

The operating software is designed to provide the operator with a series of menus or screens, each screen generally being associated with one or more modes of operation, e.g., STR 1, STR 2, etc. As described above, in a touch screen embodiment, each of the screens include selection elements or “keys” which the operator may touch to activate appropriate functions related to the operating mode or status of the device. The screens are further designed to display messages to the operator related to the operating modes such as, for example, batch or sub-batch totals and status or error conditions. Preferably, the touch screen at any given time displays only those “keys” or status and error conditions that are associated with the present status of the currency processing device. FIG. 21 represents a “crossroad” or “main” touch screen associated with the a device operating in “Stranger 1” (STR 1) mode. The hatched keys represent functions that are engaged. The touch screen contains the following keys and displays:

| | |
|---|---|
| END (600) | This key ends either a sub-batch (by pressing |
| | once) or a batch (by pressing twice). |
| ADD (601) | This key engages or disengages the Add |
| | function. |
| VERFY (602) | This key allows for Verify mode operation. |
| SD (603) | This key engages or disengages the Suspect |
| | Document (SD) minor error condition. |
| MODE (604) | This key engages the operating modes. |
| MENU (605) | This key enables the operator to view totals, set |
| | strap limits, and SD and Density thresholds. |
| RIGHT (606) | This key enables the operator to quick-right a |
| | stack of bills when this function is enabled in |
| | the set-up mode. |
| FACE (607) | This key enables the operator to quick-face a |
| | stack of bills when in this function is enabled in |
| | the set-up mode. |
| S-BAT display (608) | This displays aggregate totals associated with a |
| | sub-batch of currency bills. |
| BAT display (609) | This displays aggregate totals associated with a |
| | batch of currency bills. |
| MODE display (610) | This displays the selected mode of operation of |
| | the device. |
| POCKET 1 display (611) | This displays the target note associated with |
| | pocket 1. |
| POCKET 2 display (612) | This displays the notes associated with |
| | pocket 2. |

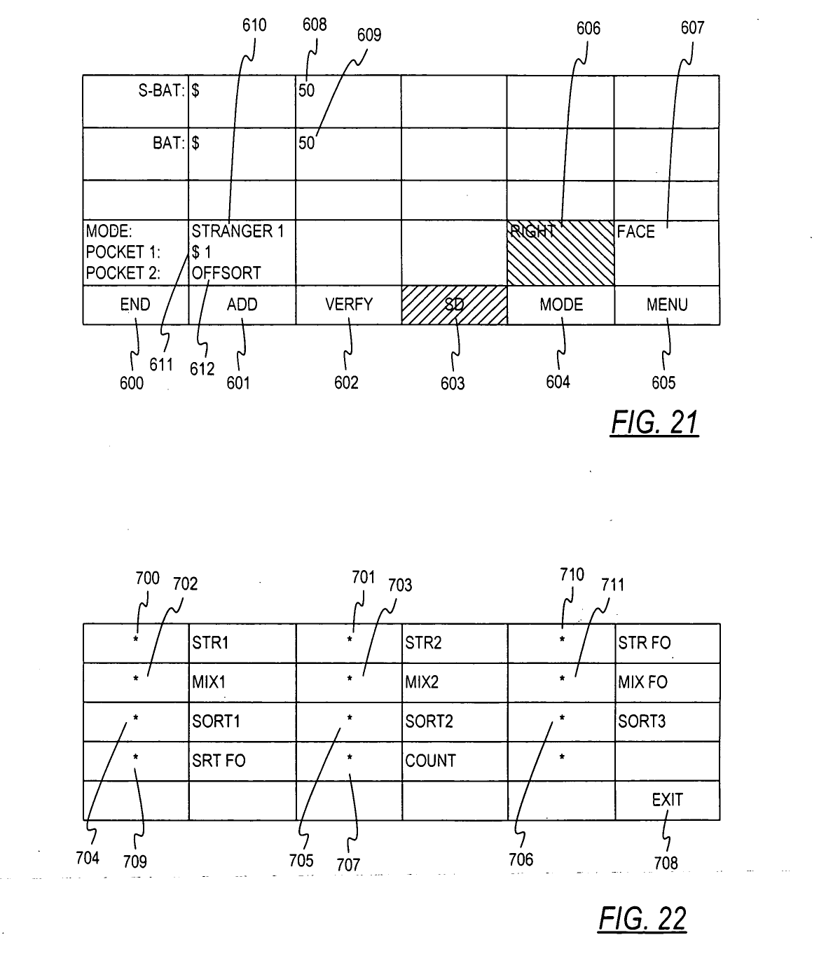

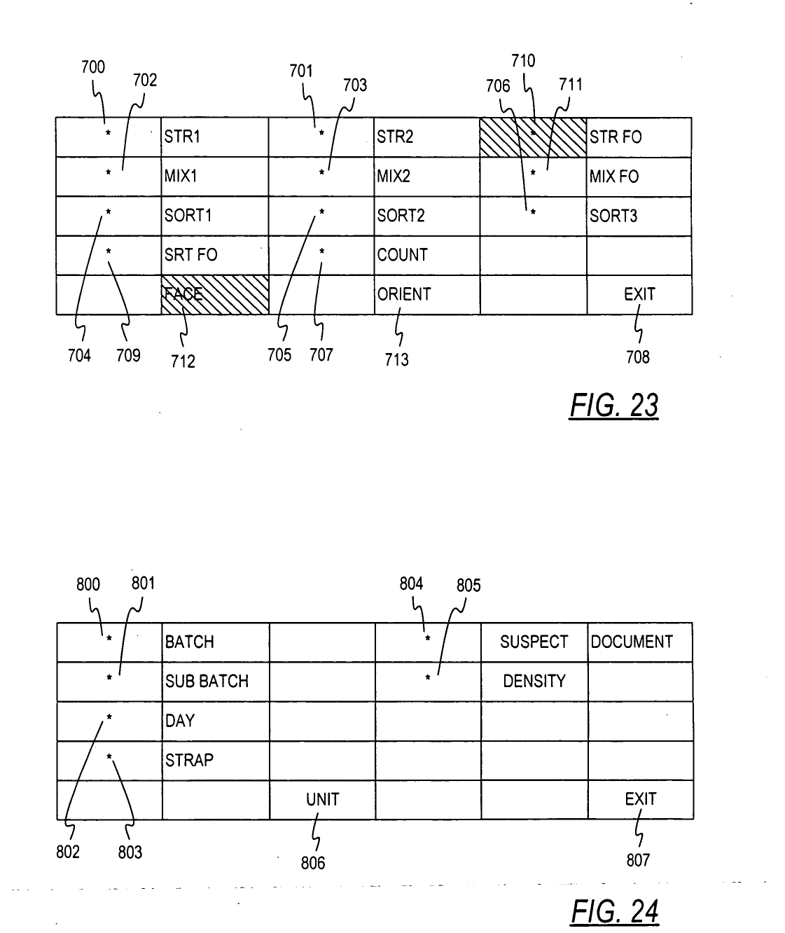

From the screen shown in FIG. 21, in STR 1 mode, pressing the MODE key produces the screen shown in FIG. 22, comprising a series of keys associated with the operating modes. Upon touching one of keys STR 1 (700), STR 2 (701), MIX 1 (702), MIX 2 (703), SORT 1 (704), SORT 2 (705), SORT 3 (706) or COUNT (707), the currency processing device transitions directly to a display associated with the appropriate operating mode. For example, if an operator wishes to return to the STR 1 menu shown in FIG. 21, the operator simply executes a single “key strokes,” touching either the EXIT key (708) or the STR 1 key (700). However, if an operator wishes to select one of the facing or orientation modes, SRT F, SRT O, STR F, STR O, MIX F or MIX O, the operator must execute two “key strokes,” the first of which is to select one of keys SRT FO (709), STR FO (710) or MIX FO (711). Upon selecting one of these keys, the display shown in FIG. 23 appears, prompting the operator to choose FACE (712) or ORIENT (713) in the associated mode. For example, in the display of FIG. 23, the operator has selected STR F mode, first by touching the STR FO key (710), then by touching the FACE key (712).

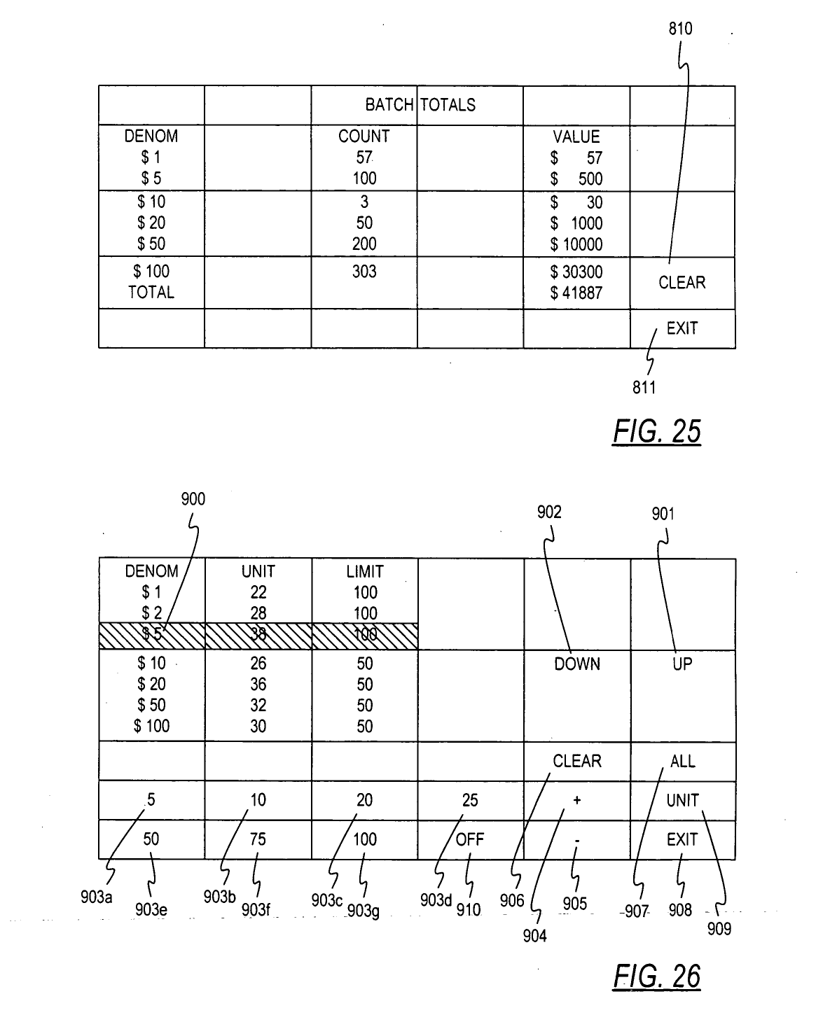

From the screen shown in FIG. 21, in STR 1 mode, pressing the MENU key (605) produces the screen shown in FIG. 24, including BATCH (800), SUB BATCH (801), DAY (802), STRAP (803), SUSPECT DOCUMENT (804), DENSITY (805), UNIT (806), and EXIT (807) keys. Pressing the EXIT key (807) brings the operator back to the main menu of FIG. 21. From this screen, pressing BATCH (800), SUB BATCH (801) or DAY (802) produces a screen indicating totals for the appropriate key. For example, if an operator desires to obtain batch totals, the operator touches the BATCH key (800), which produces the screen shown in FIG. 25. The screen shown in FIG. 25 indicates the number and aggregate value of each denomination of currency in the batch. Pressing the CLEAR key (810) in the screen of FIG. 25 clears the appropriate totals and EXIT (811) brings the operator back to the menu screen of FIG. 24.

From the menu screen (FIG. 24), pressing the STRAP key (803) produces a screen (FIG. 26) within which strap limits may be set for various denominations of currency. Nine denominations can be accommodated for international markets. A highlighted cursor (900), indicated by hatching in FIG. 26, may be moved by the UP (901) and DOWN (902) keys at the right of the display to a particular denomination selected by the operator, e.g., $5 in the example shown. Thereafter, strap limits may be set by touching one or more of the direct access keys (903a-g) at the bottom of the screen. For example, a strap limit of 100 may be selected by touching the “100“key (903g). The “+” (904) and “−” (905) keys allow the operator to program the unit or limit at a custom amount, by incrementing or decrementing the displayed value. For example, the unit limit 38 may have been selected by first touching the “50” key (903e) and then touching the “−” key (905) twelve times. The CLEAR key (906) is designed to clear the limit and unit count associated with the highlighted line. Similarly, all the strap limits may be cleared by pressing ALL (907), then CLEAR (906). Pressing the UNIT key (909) toggles the display between presenting the information in unit form as shown in FIG. 26 and value form (e.g., dollars). For example, if the UNIT key (909) were pressed in FIG. 26, then the word “UNIT” between “DENOM” and “LIMIT” would change to “VALUE” and the “38” for the $5 line would change to “$190” and the “100” for the $5 line would change to “$500”. EXIT (908) brings the operator back to the menu screen of FIG. 24.

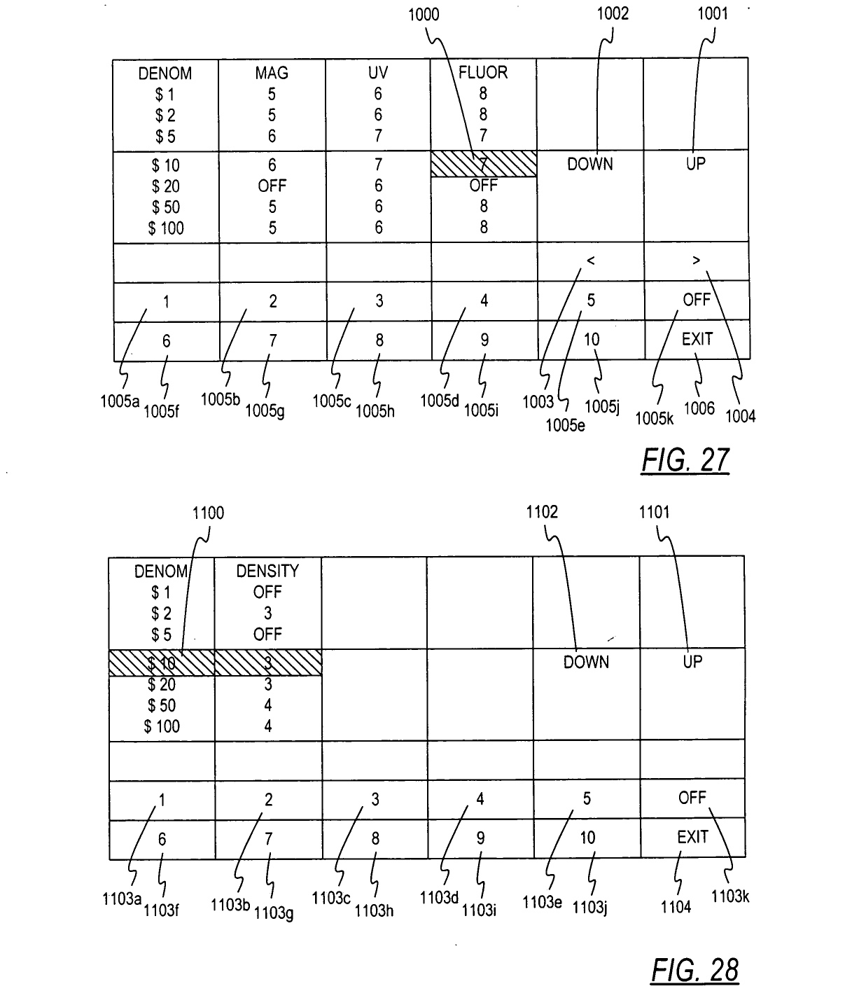

From the menu screen (FIG. 24), pressing the SUSPECT DOCUMENT key (804) produces a screen (FIG. 27) within which an operator may select threshold levels for triggering the “suspect document” minor error condition. Nine denominations can be accommodated for international markets. In the embodiment of FIG. 27, the currency processing device permits adjustment of three types of authentication tests, namely, a magnetic test, an ultraviolet (UV) test, and a fluorescence test. The magnetic test measures the total magnetic content of a document along a scan line. The ultraviolet test measures the amount of ultraviolet light that is reflected off a document when it is illuminated by an ultraviolet light source. The fluorescence test measures the amount of fluorescent light that is emitted from a document when it is illuminated by an ultraviolet light source. These tests and sensitivity adjustments are described in more detail in U.S. Pat. Nos. 5,790,693 and 5,640,463, each of which are incorporated herein by reference in its entirety. Likewise, the currency processing device may additionally include other authentication tests such as thread detection, enhanced magnetics tests including those employing a single and multiple magnetic heads, infrared detection, and color authentication tests including those described in U.S. Pat. No. 5,992,601. These authentication tests may also employ multiple sensitivity setting by denomination and/or series.

A highlighted cursor (1000), indicated by hatching in FIG. 27, may be moved by the UP (1001) and DOWN (1002) keys and/or left and right arrow keys “<” (1003), “>” (1004) at the right of the display to a particular selected threshold. Thereafter, thresholds may be set by touching one or more of the direct access keys (1005a-k) at the bottom of the screen. The OFF key (1005k) disables an authentication test. EXIT (1006) brings the operator back to the menu screen of FIG. 24.

From the menu screen (FIG. 24), pressing the DENSITY key (805) produces the screen shown in FIG. 28 within which an operator may select density levels associated with the various currency denominations. The density levels affects such functions as the detection of two or more bills fed in a stacked manner (Doubles major error). Nine denominations can be accommodated for international markets. A highlighted cursor (1100), indicated by hatching in FIG. 28, may be moved by the UP (1101) and DOWN (1102) keys at the right of the display to a particular selected denomination. Thereafter, density levels may be set by touching one or more of the direct access keys (1103a-j) at the bottom of the screen. The OFF key (1103k) disables density checking for the corresponding denomination. EXIT (1104) brings the operator back to the menu screen of FIG. 24.

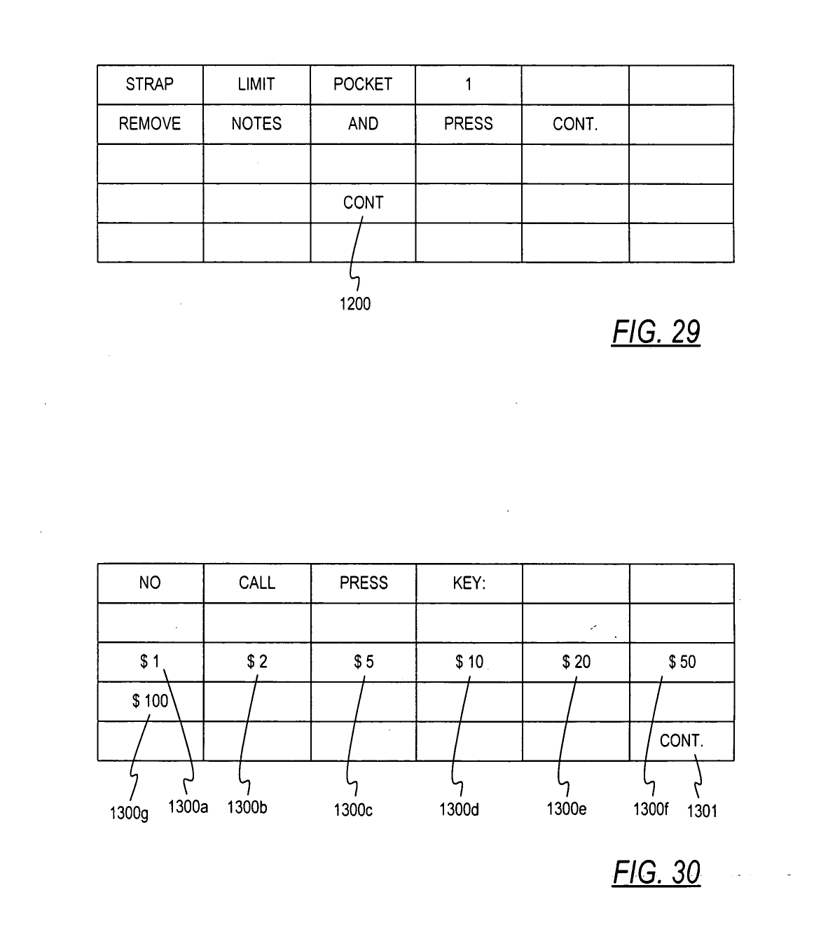

In one embodiment of the present invention, the display may be used to indicate. recovery procedures upon the occurrence of an error condition that has stopped the device. Error conditions can include for example, jam, double, chain, stacker full, strap limit, denomination change, and stranger. Preferably, the recovery procedures are displayed in the form of text indicating both the error condition that has occurred and detailed instructions for the operator to follow to recover from the error condition and resume operation of the device. For example, a jam can be identified by its location in the device such as in pocket 1, pocket 2, infeed area, etc. Likewise, a display associated with a “strap limit” error condition is shown in FIG. 29. The display “STRAP LIMIT POCKET 1” identifies that the device has stopped due to a “strap limit” error condition in pocket 1. The display “REMOVE NOTES AND PRESS CONT.” indicates to the operator that the operator must first remove the notes in pocket 1, then press the “CONT” key (1200) to resume operation of the device.

A further example of a recovery screen is shown in FIG. 30, illustrating a display associated with a “no call” error condition. A screen substantially similar to FIG. 30 may also be used upon the occurrence of a “suspect document” condition. The display “NO CALL PRESS KEY:” indicates to the operator that the device has stopped due to a “no call” condition and that the operator may press one of the keys (1300a-g) in the display, e.g., “$1,” “$2,” “$5,” “$10,” $20,” “$50,” or “$100”, to resume operation of the device. The operator may thereafter observe the denomination of the “no call” document and press the appropriate key (1300a-g) if the operator finds the bills to be acceptable, causing the device to add the appropriate value to the count total and resume processing the remaining notes in the stack. If the operator finds the bill unacceptable (e.g., suspect, a bill from a different country), the operator may press a CONT. key (1301) (Continue key). Generally, the operator first removes the unacceptable bill from the output pocket first and then presses the CONT. key (1301). The device then resumes processing the remaining notes in the stack without improperly disrupting any running totals or counters.

In another embodiment of the present invention, the display may be used to enable the operator to enter data such as, for example, user identification, date, customized labels, check amounts, coin amounts, or manual bill counts. In a touch screen environment, this may be accomplished through data entry software providing a series of menus or screens, each including selection elements or “keys” which the operator may touch to activate appropriate functions related to one or more data entry modes. These features may be engaged in the set-up program described above, or they may be requested on demand. If used on demand, the “keys” should be displayed upon the beginning of processing a batch of notes. FIG. 31 represents a touch screen associated with the a device in data entry mode. The hatched keys represent functions that are engaged. The touch screen contains the following keys and displays:

| | |
|---|---|
| LABEL (1401) | This key enables the operator to customize |
| | labels A, B, C, D through the touch panel |
| | keyboard. |
| ID (1402) | This key prompts the operator to enter a |
| | user identification code. |
| MEDIA (1403) | This key prompts the operator to enter the |
| | media type associated with the data entry, e.g., |
| | coin, check or misc. |
| DATE (1404) | This key prompts the operator to enter the date. |
| DBAL (1405) | This key prompts the operator to enter a |
| | declared balance (Batch and Sub-batch). |
| EXIT (1406) | This key returns the operator to the previous |
| | menu. |
| MODE display (1407) | This displays the selected mode of operation |
| | of the device. |
| STRAP LIMIT display | This displays the strap limit associated with |
| (1408) | the mode of operation. |
| STRAP COUNT display | This displays the current number of a select |
| (1409) | document-type counted |
| DENOM display (1410) | This displays the selected document-type |
| SUB-BATCH display | This displays aggregate totals associated |
| (1411) | with a sub-batch of currency bills. |
| BATCH display (1412) | This displays aggregate totals associated |
| | with a batch of currency bills. |

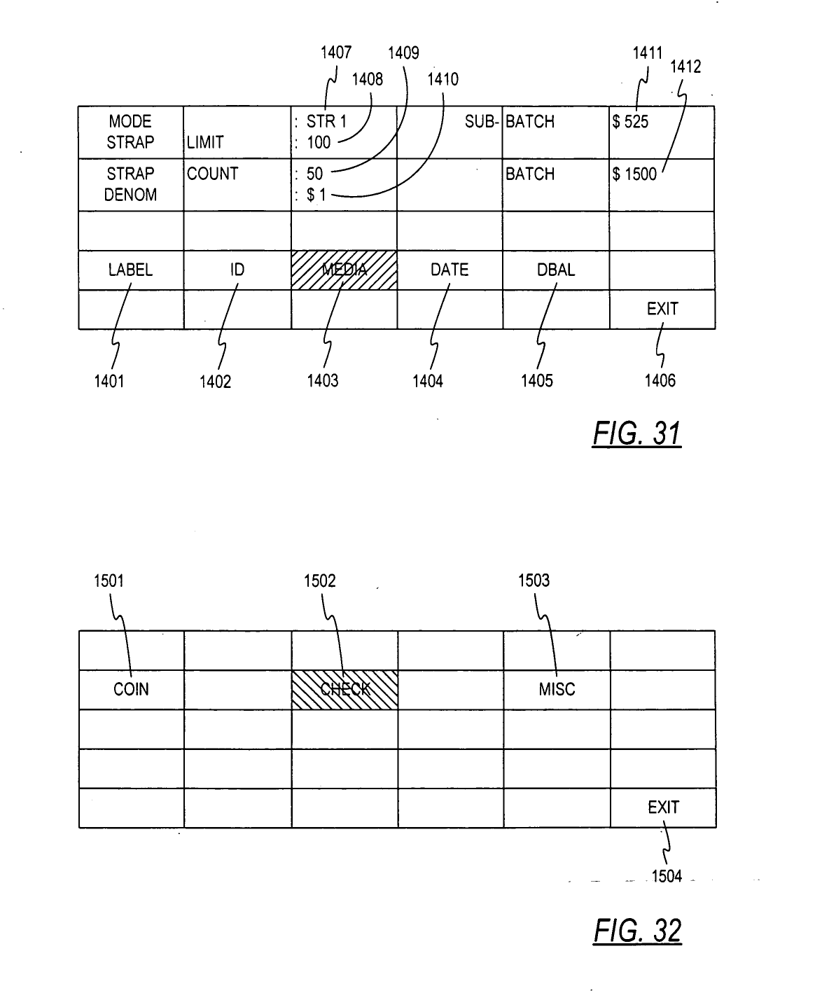

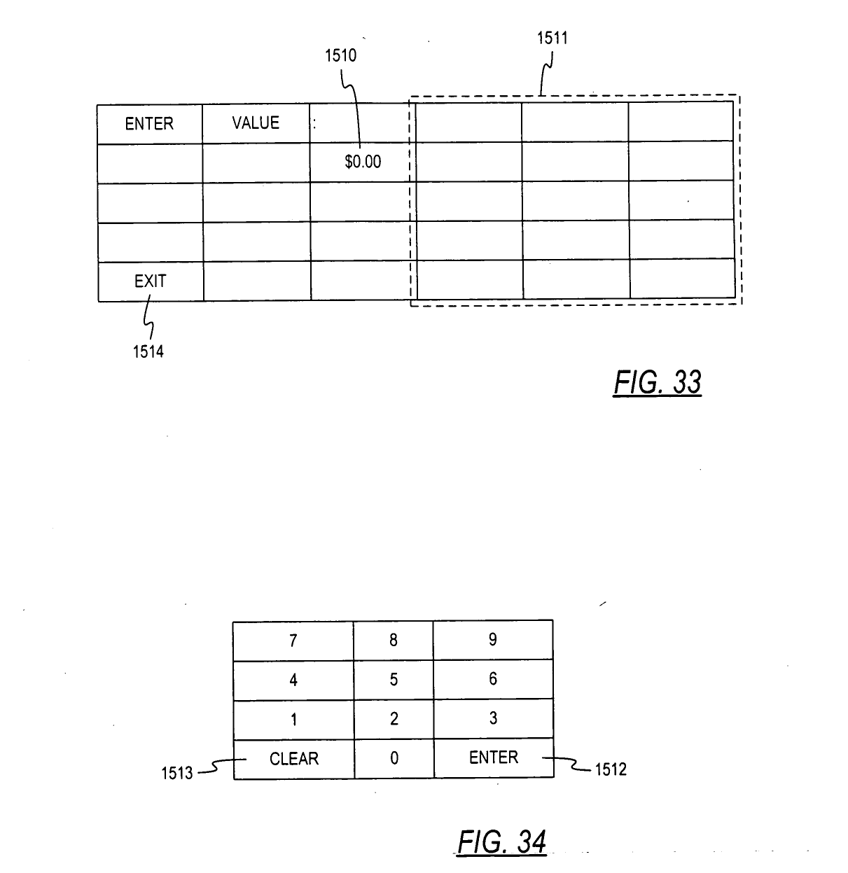

Pressing the MEDIA key (1403) results in the screen shown in FIG. 32 being displayed. At this screen, the operator selects what type of media is to be recorded into the systems memory by selecting either a COIN key (1501), a CHECK key (1502), or a MISC key (1503). To return to the screen of FIG. 31, the operator would select the EXIT key (1504). In the example shown in FIG. 32 the operator has indicated that the amount of a check is to be entered into the systems memory by selecting the CHECK key (1502). At this point, the screen shown in FIG. 33 appears and prompts the operator to enter the value of the check by displaying the message: “ENTER VALUE”. The amount that operator the enters is displayed on the screen (1510). The operator may enter the amount by using a keyboard connected to or integrated into the device such as that shown in FIG. 34. Alternatively, the keyboard of FIG. 34 may be displayed on the touch screen such as at area 1511 of FIG. 33. Once the operator has typed in the correct amount, it is entered into the memory of the currency processing device by selection of the ENTER key (1512). Data entry mistakes may be corrected by pressing the CLEAR key (1513). if the operator wishes to return to the previous screen (FIG. 32) without entering any amount, the EXIT key (1514) is selected. According to one embodiment, data entry as described above may be performed even while the device is processing a stack of notes. However, upon the occurrence of an error that requires presentation of other keys or functions to recover, data entry is suspended until the device resumes operation.

In one embodiment of the present invention, the currency processing device is equipped with a series of communications ports to provide one-way or two-way communications link(s) between the device and remote operators and/or other currency processing devices. This communications link may be established, for example, between another currency processing device, a coin sorting device, a cash settlement system, currency dispensers, or a remote “host” device, such as a computer, for issuing control commands and/or receiving information from the currency processing device.

In embodiments using a “host” device, the following commands may be issued from the host, to which the currency processing device responds operationally:
(1) a “START” command for starting operation of the device;
(2) a “REQUEST INFORMATION” command wherein the host may request information from the device, such as sub-batch, batch, or day totals;
(3) a “MODE SELECTION” command wherein the host may remotely select the mode of operation for the device;
(4) an “ADD SELECTION” command;
(5) an “SD” selection command wherein the host may remotely set sensitivity thresholds for the device;
(6) a “STRAP SETTINGS” command;
(7) a “CLEARING” command;
(8) a “DENSITY SETTING” command;
(9) a “POCKET SELECTION” command; and
(10) an “ENDING BATCH” command.

In return, in embodiments using a “host” device, it is contemplated that the discrimination device may send the following information to the host:
(1) a message or messages indicating the occurrence of minor error condition(s) “NO CALL,” “SUSPECT DOCUMENT,” “DENOMINATION CHANGE,” “STRAP LIMIT,” “STRANGER,” “STACKER FULL,” or “SEPARATE SERIES;”
(2) a message or messages indicating the occurrence of major error conditions “JAM,” “DOUBLE,” or “CHAIN;” and
(3) maintenance messages indicating maintenance requirements or status of the device, such as whether the device requires cleaning or adjustment.

Many types of financial transaction features may be incorporated into the above described devices so that they can act as a cash settlement device. The details of such cash settlement systems are described in more detail in U.S. Pat. No. 5,943,655, which is incorporated herein by reference in its entirety.

While many of the above embodiments have been described in conjunction with U.S. currency, currency processing devices according to the present invention may alternatively or additionally process currency of other countries such as the United Kingdom, France, Germany, Japan, Spain, Canada, Italy, Brazil, Mexico, Taiwan, and Saudi Arabia. Likewise, the above currency processing devices may support the processing of multiple types of documents including, for example, checks, deposit slips, header documents, etc.

Additionally, the systems described above may contain fitness sensors such as density sensors, reflectance sensors, magnetic sensors, correlation, UV and soil sensors, tear detectors, etc. Also the systems may utilize flash memory as mentioned above and E² proms for reliable storage of data and set ups.

Additionally, the currency processing device described above may contain unique customization features such as user-defined keys, user-defined print outs, user-defined modes of operation, user-defined document distribution parameters, and/or user-defined set-ups. The customization features may be controlled or changed through simple input though an interface device such as a keyboard or touch screen.

User Customization

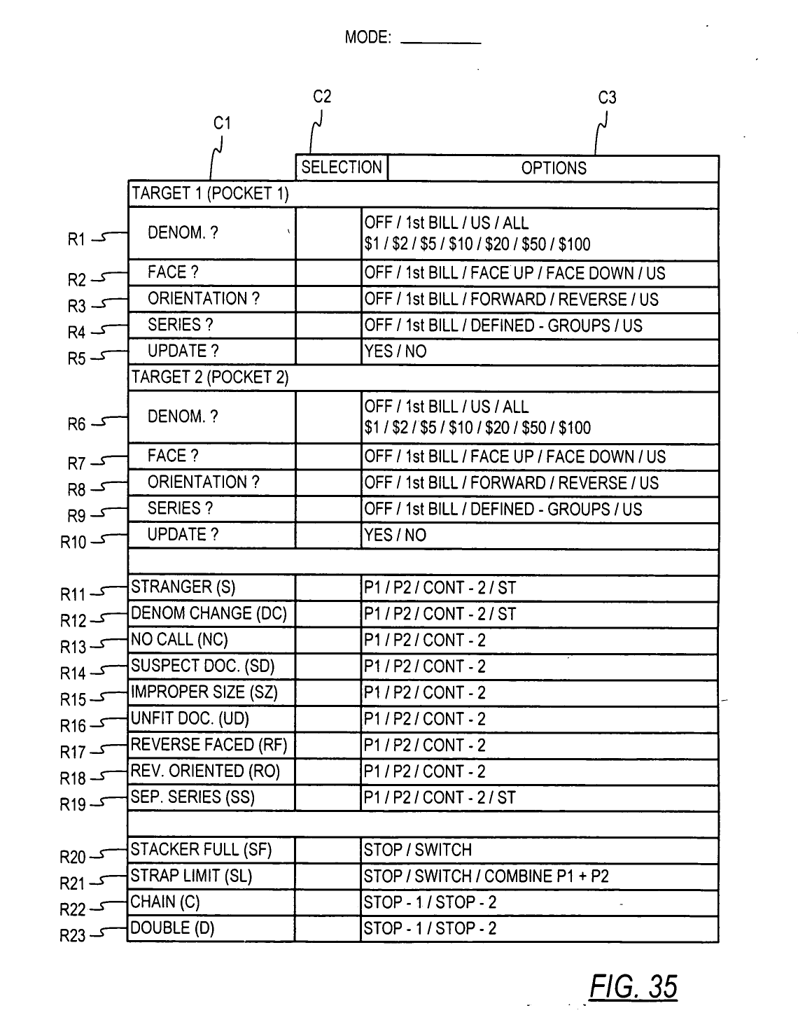

As described above and as further described below, according to embodiments of the present invention, the currency processing device permits the user or operator to customize the operation of the device in a number of ways. For example, in the above described modes of operation, the user may be permitted to designate into which pocket certain bills are delivered and whether the device should stop, e.g., deliver any no calls into pocket 2 and stop the device after each no call is delivered to pocket 2. Additional examples of how the user may customize the device according to the present invention are described in connection with FIGS. 35-40. FIGS. 35-40 illustrate examples of displays designed to aid the operator in tailoring the operation of the device according to the operator's preferences. These figures illustrate displays that may be used to aid in retrieval of routing and flagging information from a user such as via a routing interface having a data retrieval device such as a touch-screen. Alternatively, the data retrieval device may be some other kind of input or input/output device such as a keypad. Additionally or alternatively, information concerning whether the device should stop upon the occurrence of one or more conditions may be retrieved from the user via a flagging control interface having a flagging data retrieval device such as a touch-screen. Alternatively, the flagging data retrieval device may be some other kind of input or input/output device such as a keypad. The flagging control interface may be combined with the routing interface into a single interface system.

FIG. 35 illustrates an example of an operating parameters selection screen in which no selections have been made. The left-hand column (C1) lists various features and conditions for which the operator may make selections. The right-hand column (C3) lists the available selection choices or options associated with each feature or condition and the middle column (C2) displays the selected option for each feature or condition (in FIG. 35 no selections have been made).

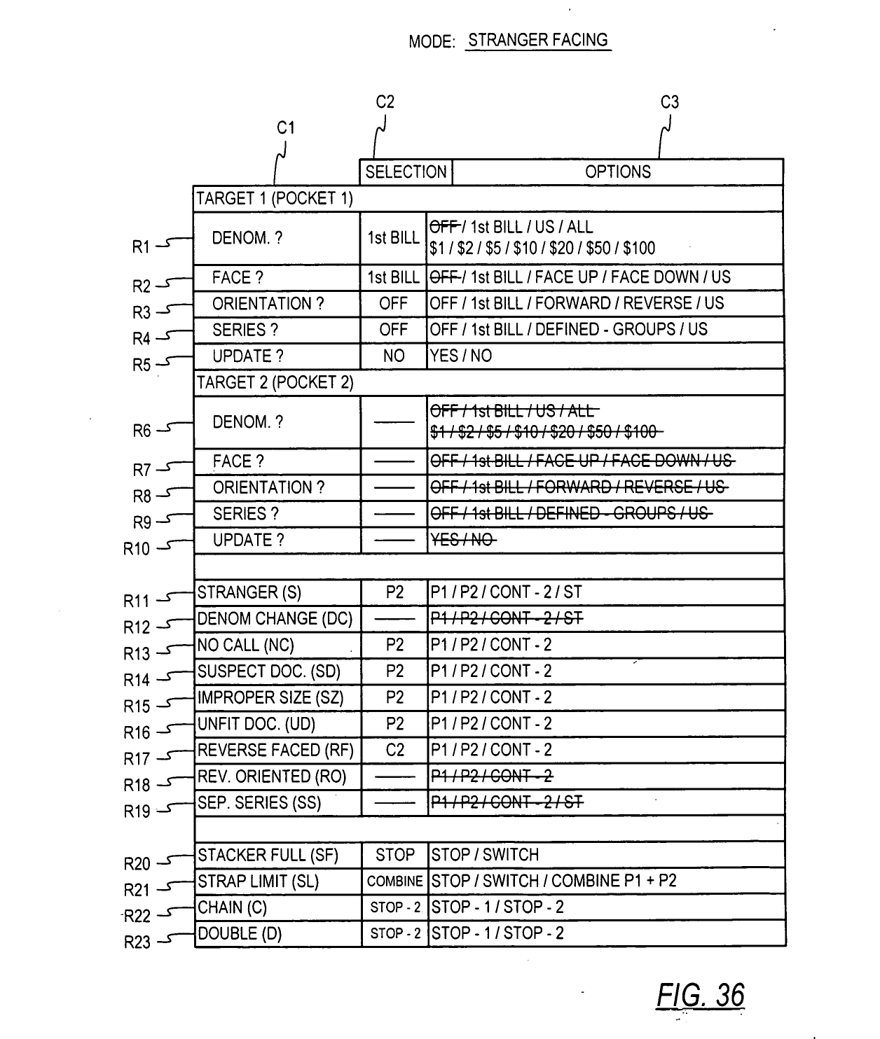

Turning to FIG. 36, an example of the operating parameters selection screen for a Stranger Facing mode is illustrated. In general, options which are not available are displayed in a non-highlighted or dim manner, illustrated in FIG. 36 via striking through unavailable options, e.g., the “OFF” and “ALL” selection choices for the Target 1 denomination. Based on the selections displayed in FIG. 36, the currency processing device delivers to pocket 1 bills having the same denomination and face orientation as the first bill in a stack. This is evident with reference to box C2,R1 which designates the target denomination as that of the “1st BILL.” Additionally, box C2,R2 designates a target face orientation as the face orientation of the “1st BILL.” Neither forward/reverse orientation (“orientation”) nor “series” has been activated so bills are not distinguished on those bases. With respect to the designation of the Target 1 denomination, the operator may change the selection from “1st BILL” to a specific denomination, $1-$100 or to User Select (US). If User Select is chosen, at the time the mode is invoked, the operator is prompted as to the desired selection. In the case of selecting a denomination, any available option may be chosen such as “1st BILL” or a specific denomination. This may be accomplished, for example, by pressing the screen in box C2,R1 in a touch screen environment that causes the displayed selection to scroll through the available options. Likewise, with respect to the designation of the target face orientation, the operator may scroll through the options of “1st BILL,” “FACE UP,” “FACE DOWN,” and “US.” In boxes C3, R1 and C3,R2 the option “OFF” is not available in a Stranger Facing mode.

With respect to forward/reverse orientation, the operator may choose either “OFF,” “1st BILL,” FORWARD,” “REVERSE,” or “US.” With respect to series selection, the operator may choose either “OFF,” “1st BILL,” “US,” or scroll through any defined series groups such as those described above, e.g., in connection with the Sort Series modes. These series groups may include factory-defined series groups and user-defined groups. Additionally, the operator may be given the option to simply designate a given series or range of series, e.g., “1996+” for all bills of a 1996 or later series or “1990-1996” for all bills having a series from 1990 to 1996.

In box C2,R5, the operator may designate whether the parameters defining Target 1 should be updated upon the occurrence of a relevant condition such as a denomination change, stranger, or separate series condition. The updating may be permitted, for example, for all activated parameters defining a target denomination (e.g., denomination and face orientation in the example of FIG. 36) or alternatively, the user may elect to update only certain ones of the activated parameters (e.g., update upon a stranger condition (new denomination) but not on a reverse face condition). As displayed in FIG. 36, the Target 1 parameters are not updated during the processing of a stack of bills.

In the Stranger Facing modes, the operator is not permitted to designate a second set of target parameters and accordingly this section (C2,R6-C3,R10) of the display is dimmed.

Boxes C2,R11-C2,R19 permit the operator to designate how certain minor error conditions are to be handled, i.e., by presenting the flagged bill in pocket 1 (P1), presenting the flagged bill in pocket 2 (P2), or delivering the flagged bill to pocket 2 and continuing to process any remaining bills (CONT-2).

Additionally, for strangers, denomination changes, and separate series, the operator is also given the option of having the transport mechanism stopped with the flagged bill being maintained within the transport mechanism (ST), i.e., before the flagged bill is delivered into a pocket. Positional information obtained from an encoder may be employed to stop a bill in a controlled manner and so that the bill is stopped in a predetermined position or identifiable location. For example, the transport mechanism may be stopped such that a flagged minor error bill is located after a diverter and before a next diverter or output receptacle such as between diverter 260 and output receptacle 217b such as being adjacent to plate 278 of FIG. 2. Alternatively, using the embodiment of FIG. 2 as an example, a flagged minor error bill may be stopped before reaching diverter 260 such as being adjacent to plate 262. One embodiment of a stopping mechanism employing an interconnected CPU, optical encoder, transport mechanism, and drive motor is described in U.S. Pat. No. 5,295,196, which is incorporated herein by reference in its entirety. Likewise on a currency evaluation device having only a single output receptacle such as that describe in U.S. Pat. No. 5,295,196, a flagged minor error bill such as a stranger, denomination change, or separate series bill may be stopped so that it is located at a predetermined or identifiable position within the transport mechanism (i. e., before being transport to the output receptacle).

As illustrated in FIG. 36, stranger bills, no calls, suspect documents, documents having an improper size, and unfit documents are all presented into pocket 2. Additionally, reverse faced notes are delivered to pocket 2 but do not cause the currency processing device to halt operation. Accordingly, bills having the target denomination and target face orientation are delivered into pocket 1 while bills having the target denomination but not the target face orientation are delivered to pocket 2. The error conditions of denomination change, reverse forward-reverse orientation, and separate series have been disabled by the choices selected above, i.e., a denomination change error can not occur in a stranger mode, and by turning off orientation and series selections in boxes C2,R3-C2,R4 orientation and series error conditions do not occur.

Boxes C2,R20-C2,R23 permit the operator to set how stacker full, strap limit, chain, and double error conditions are handled. As illustrated in FIG. 36, the currency processing device stops upon the occurrence of a stacker full condition. Another option includes switching delivery of target notes to the non-current pocket when the current pocket becomes full provided there are no bills in the non-current pocket. Otherwise the device halts until one of the pockets is cleared. Box C2,R2 1 indicates that strap limits are counted using the contents of both output pockets, i.e., a strap limit occurs when the combined number of target denomination bills delivered to pocket 1 (having the target face orientation) and target denomination bills delivered to pocket 2 (having a reverse face orientation) reaches the limit associated with the target denomination. When either a chain or a double error condition occurs, the device stops with any chain or double bills being delivered into pocket 2.

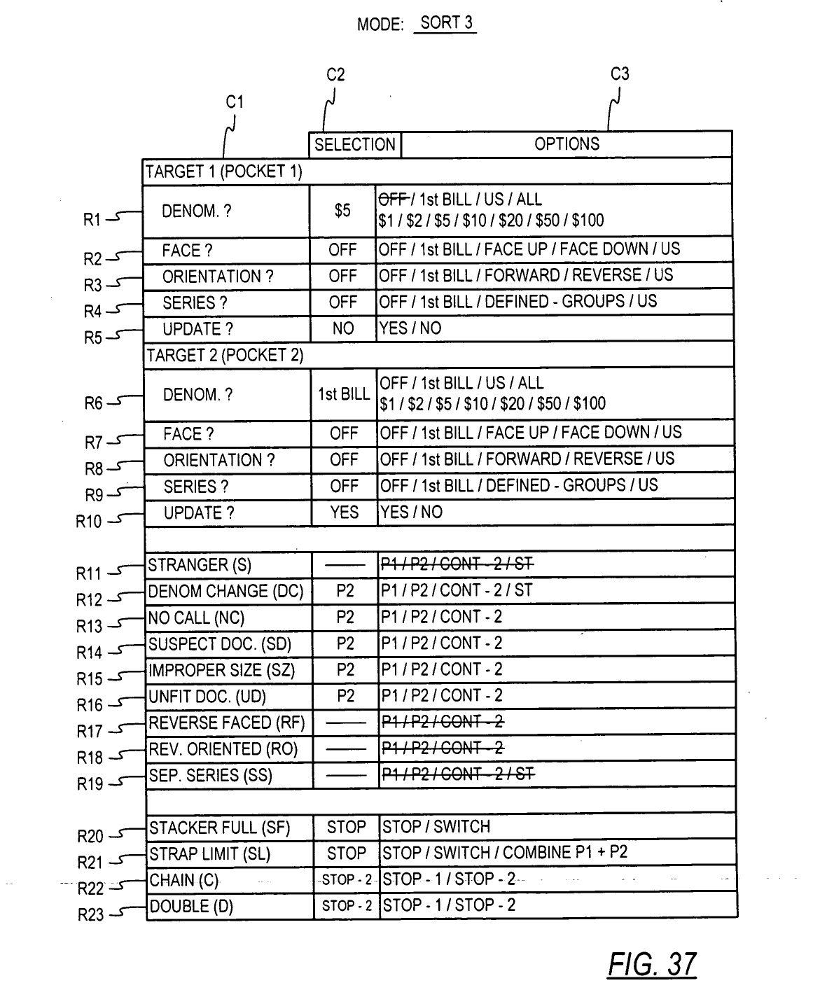

Turning to FIG. 37, an example of the operating parameters selection screen for a Sort 3 mode is illustrated. Here $5 bills (having any face orientation, any forward/reverse orientation, or any series) are delivered to pocket 1 while the first non-$5 bill becomes the second target denomination and is off-sorted into pocket 2. Thereafter $5 bills are delivered to pocket 1 and target 2 denominated bills are delivered to pocket 2. Upon the occurrence of a denomination change, the denomination change is presented into pocket 2 (C2,R12) and the denomination of the flagged bill becomes the new target 2 denomination (C2,R10). The target 1 denomination remains $5 as box C2,R5 indicates that this denomination should not be updated.

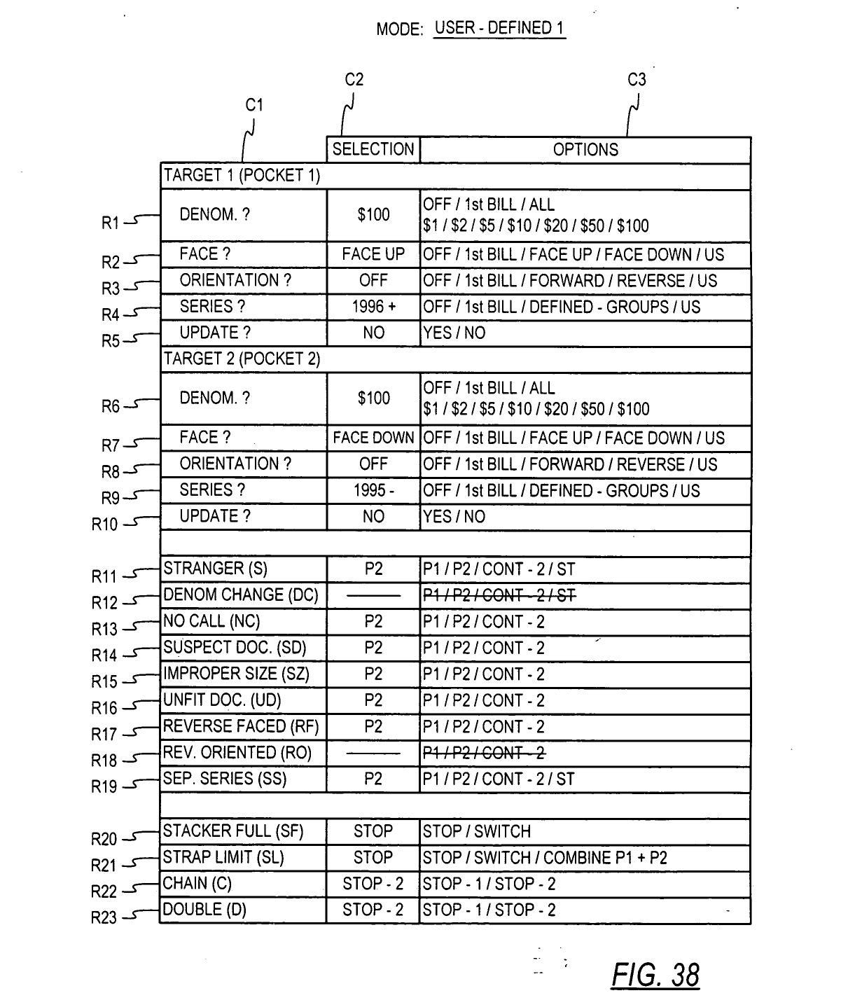

Turning to FIG. 38, an example of the operating parameters selection screen for a first user-defined mode is illustrated. The system may permit the operator to set a number of personalized operating modes (e.g., user-defined 1, user-defined 2, etc.) Likewise the device may permit user to define the name of the modes, e.g, “Acme Bank Closing Mode”, “Acme Bank Commercial Mode”). According to the selections made in FIG. 38, all face up $100 bills having a series of 1996 or later are delivered into pocket 1 while all face down $100 bills having a series of 1995 or earlier are delivered to pocket 2. When any possible minor error listed in rows R11-R19 occurs, the flagged bill is presented in pocket 2.

Information concerning user-defined modes is stored in a memory such as an E² PROM so that it can be recalled in the future such as on days subsequent to the day that it is original defined. This information is stored in such a manner that it is not lost after the power switch of the currency processing device is turned off as in a nonvolatile memory. The definition of particular user-defined mode remains unchanged until it is re-defined by a user of the currency processing device. In this manner a user may define a mode of operation that is particularly adapted to the needs of the user and repeatedly recall that mode of operation whenever the user desires to operate the device in that mode. For example, the operate could desire to process a stack of currency bills using one of the factory default modes such as the Mixed 1 mode of operation and then process of second stack of bills using an user-defined mode. In such a case, the operator would first select the factory mode desired such as Mixed 1, process the first stack of bills, then select the desired user-defined mode, and process the second stack of bills. The definitions of the factory-defined or default modes may also be stored in an E² PROM.

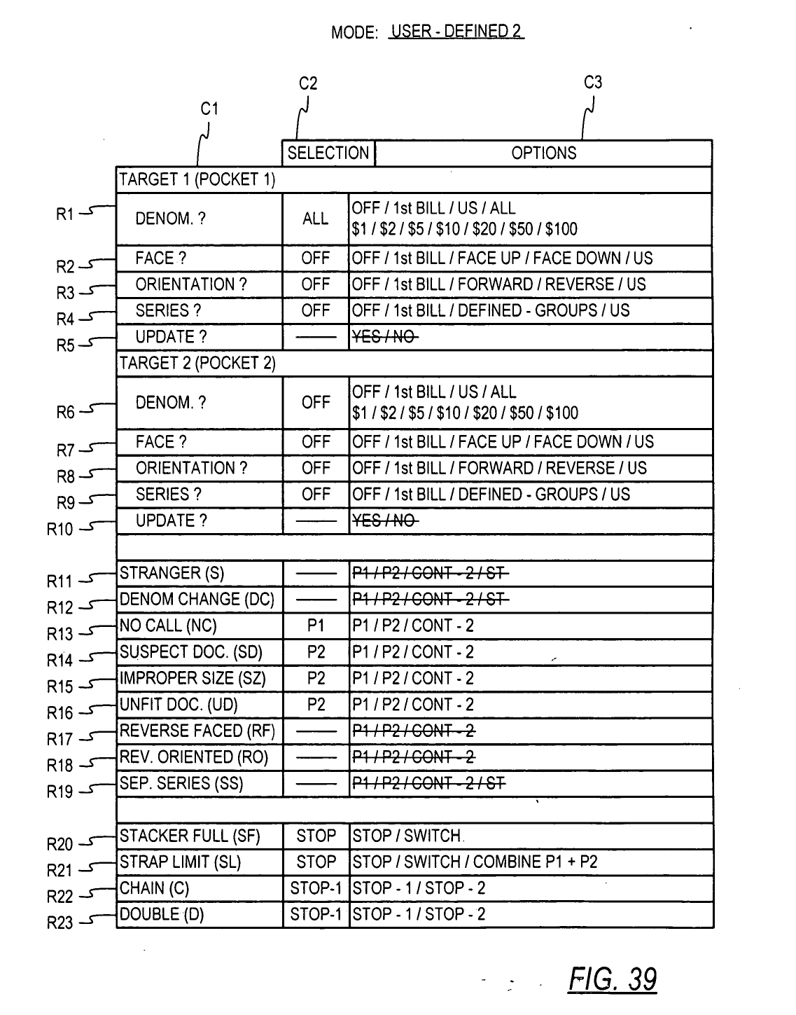

Turning to FIG. 39, an example of the operating parameters selection screen for a second user defined mode is illustrated. According to the selections made in FIG. 39, bills of all denominations (as in a mixed mode), are delivered into pocket 1. This is indicated by the selection of “ALL” in box C2,R1. No calls are presented in pocket 1 while suspects, improperly size bills and unfit document are presented in pocket 2. Chains and doubles are directed to pocket 1 and the device stops.

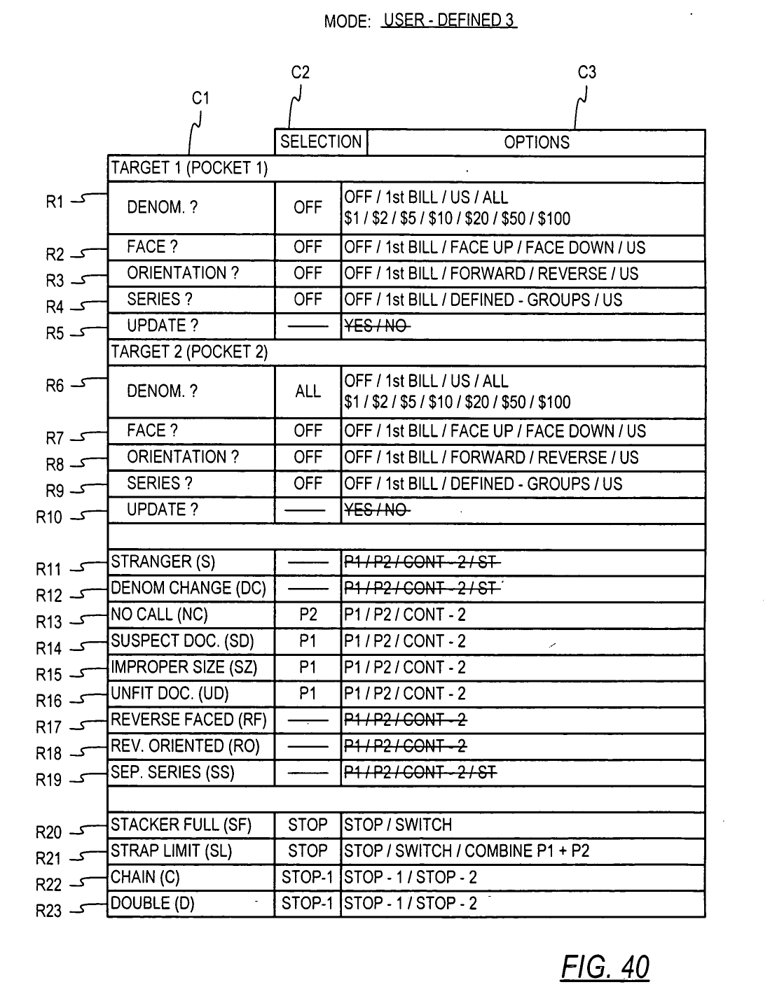

Turning to FIG. 40, an example of the operating parameters selection screen for a third user-defined mode is illustrated. According to the selections made in FIG. 40, bills of all denominations (as in a mixed mode) are delivered into pocket 2. No calls are presented in pocket 2 while suspects, improperly size bills and unfit document are presented in pocket 1. Chains and doubles are directed to pocket 1 and the device stops.

Transport Control

As is discussed above, during the operation of the currency processing device 10 having two output receptacles 217a,b (FIGS. 1a-2), currency bills are routed to either of the two output receptacles 217a,b depending on various information determined by the currency processing device 10. For example, currency bills triggering error conditions (e.g., no call, suspect document, etc.) may be routed to the second output receptacle 217b while bills that are identified, authenticated, or both are routed to the first output receptacle 217a. It other applications, such as sorting U.S. $20 bills from a stack of mixed U.S. bills, the U.S. $20 bills are routed to the first output receptacle 217a and all other bills are routed to the second output receptacle 217b.

As is discussed in the Background Section, processing errors can occur where two consecutive bills are targeted for delivery to different output receptacles 217a,b and the currency processing device 10 detects that the two consecutive bills are being transported too close to one another or detects that or one or more of the bills is being transported in a skewed fashion. This situation sometimes causes the prior art two-pocket currency processing device to deliver the bills to the same output receptacle 217a,b and report an error condition because there is not enough space between the bills to permit proper actuation of the diverter.

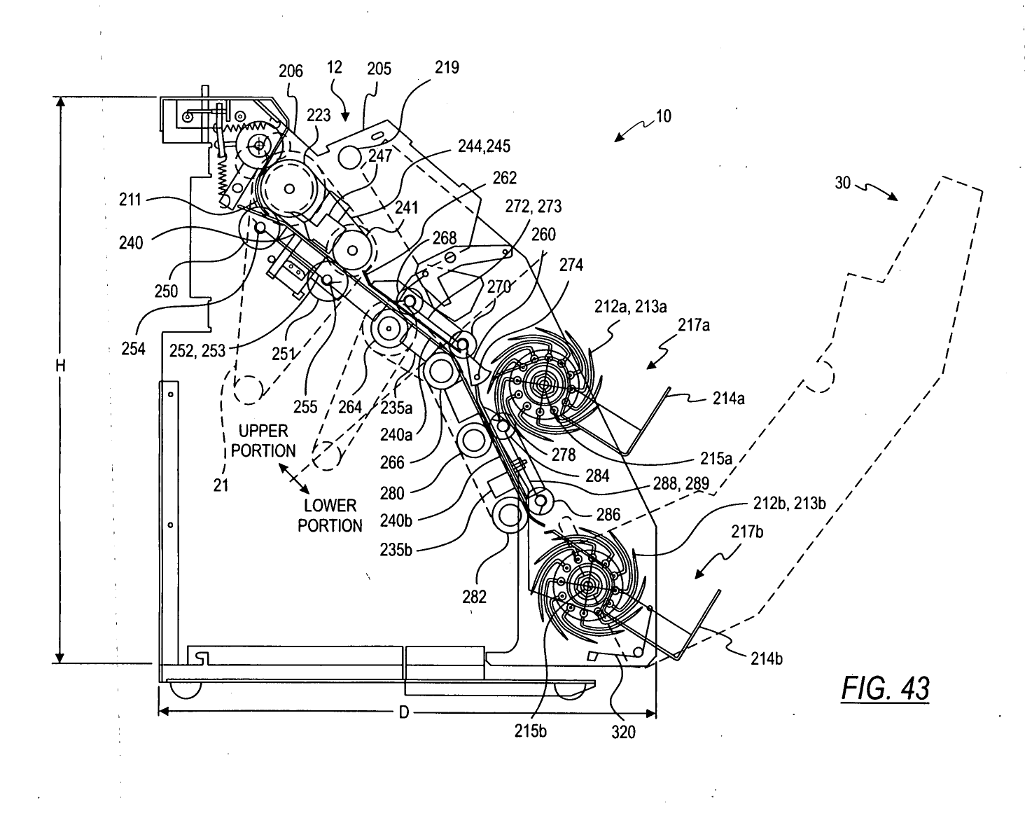

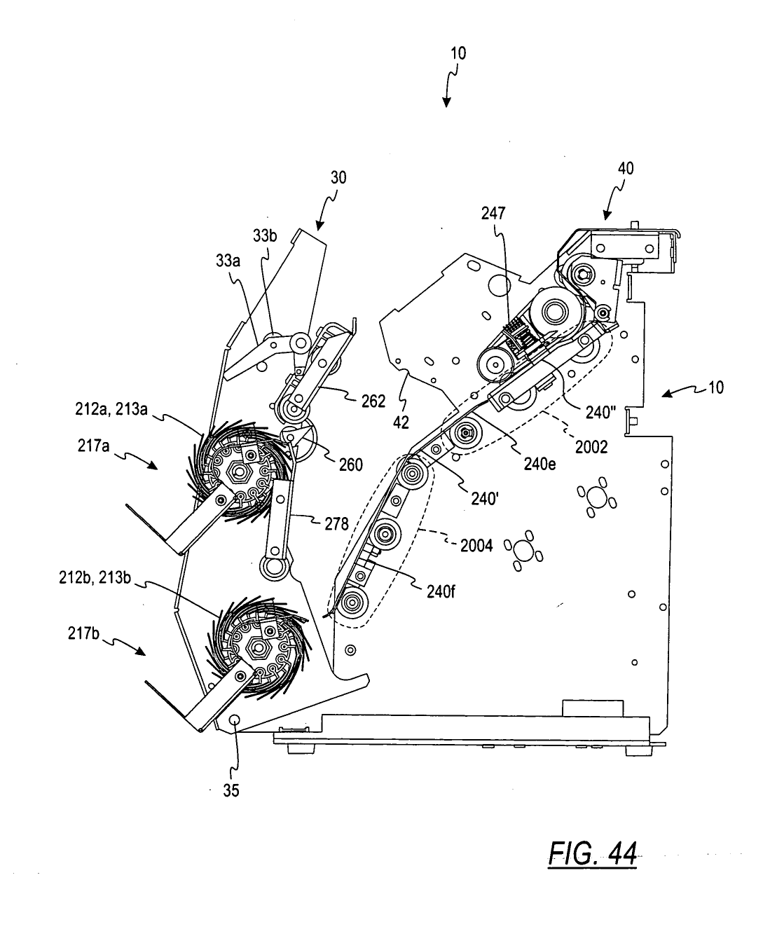

Referring now to FIGS. 43 and 44, the transport mechanism of the two-pocket currency processing device 10 is adapted to vary the speed at which the currency bills are transported to the output receptacles 217a,b according to one embodiment of the present invention. The transport mechanism includes an upstream portion 2002 (“upper portion”) and a downstream portion 2004 (“lower portion”), which are referred to with dashed lines in FIG. 44. The upper portion 2002 of the transport mechanism includes the portion of the transport mechanism upstream of the driven rollers 264. Thus, the upper portion 2002 includes driven rollers 264, driven rollers 241, and driven rollers 223, as well as the passive rollers corresponding to those driven rollers. The lower portion 2004 of the transport mechanism includes driven rollers 266, 280, and 282, as well as the passive rollers corresponding to those driven rollers.

The driven rollers 223, 241, and 264 of the upper portion 2002 are driven by one or more upper transport motors, and the driven rollers 266, 280, and 282 of the lower portion are driven by one or more lower transport motors. The upper transport motor and the lower transport motor operate independently of one another and are capable of moving bills through the upper and lower portions 2002, 2004, respectively, of the transport mechanism at different rates of speed. In embodiments where two or more transport motors drive a particular portion of the transport mechanism, the transport motors for that portion are electronically geared so that all the transport motors driving that portion move a bill through the portion of the transport mechanism at a substantially uniform rate of speed. In other embodiments, belts are used to drive the driven rollers when a single motor is used for the upper portion 2002 or for the lower transport portion 2004.

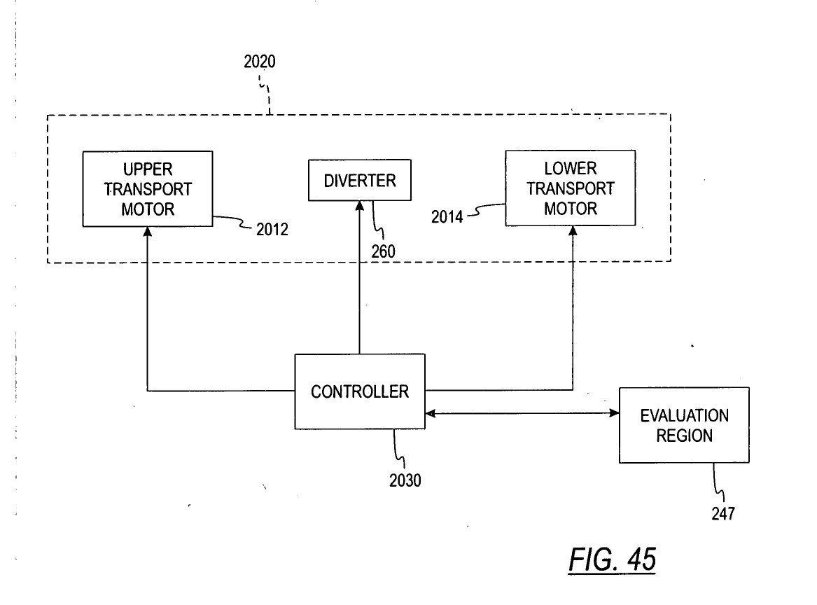

Referring also to FIG. 45, the upper transport motor 2012 and the lower transport motor 2014 of the transport mechanism 2020 are coupled to a controller 2030 that controls the operation of each of the upper and lower transport motors 2012, 2014 for moving bills through the upper and lower portions 2002, 2004 of the transport mechanism. According to one embodiment, the controller 2030 also controls the actuation of the diverter 260 for routing bills to either of the two output receptacles 217a,b. Upon the detection of certain conditions, it is necessary to operate the upper and lower portions 2002, 2004 of the transport mechanism at different speeds. The controller 2030 is also the controller that controls the operation of the currency handling device 10 according to one embodiment of the present invention. Alternatively, the controller 2030 is a local controller that performs low-level operations relating to the operation of the transport mechanism 2020 and is coupled to a main processor, or central processing unit, that handles the high-level operations relating the overall operation of the currency handling device 10.

According to one embodiment of the currency processing device 10, the evaluation unit 247 determines or evaluates the distance between consecutive bills. As discussed above, it is desirable to have an appropriate amount of spacing between consecutive bills for actuation of the diverter. In other alternative embodiments of the present invention, the time between bills or the number of encoder counts produced by an encoder coupled to the transportation mechanism are measured and used to determine the “distance” between consecutive currency bills. If consecutive bills are overlapping or doubled, a “Chain” or “Double” error signals is generated and those chained or doubled bills are routed to an output receptacle as described above according to one embodiment of the present invention. If, however, consecutive bills are spaced apart but are still relatively close together, the evaluation unit 247 generates an error signal indicating that the bills are being transported too close to one another. The threshold for defining whether bills are too close can vary in alternative embodiments of the present invention. According to one embodiment of the present invention, the bills should be approximately 2.5 inches (about 6.35 cm) apart, and the evaluation device triggers a “proximity” error condition when it is determined that the bills are less than approximately 1 inch (about 2.54 cm) apart. Additionally or alternatively, the evaluation unit 247 also evaluates whether the bills being transported are skewed relative to the transport path.

Upon receipt of a “proximity” error signal-when consecutive bills are transported too close to each other-generated by the evaluation unit 247, the controller 2030 then slows the operating speed of upper transport motor 2012 to slow the speed at which documents are transported in the upper portion 2002 of the transport mechanism. The speed of the lower transport motor 2013 is maintained. This difference in transportation speeds between the upper and lower portions 2002, 2004 of the transport mechanism, causes the downstream bill to be pulled away from the upstream bill. The separation between the two consecutive bills that were originally too closely spaced is now sufficient to allow the diverter to actuate for routing the bills between different output receptacles 217a,b. Additionally, the transportation speed of the upper transport motor 2012 is slowed when the evaluation unit 247 detects that a bill is being transported by the transport mechanism 2020 in a skewed fashion (e.g., angled, not square, etc.) relative to the transport mechanism 2020 in alternative embodiments of the present invention.

After the bill or bills triggering the error condition(s) that led to the decrease in the transportation speed of the upper portion 2002 of the transport mechanism 2020 are delivered to the appropriate output receptacles 217a,b, the transportation speed to of the upper portion 2002 of the transport mechanism 2020 is increased back to the speed at which it was transporting bills prior to being slowed down. Put another way, the transport speed of the upper portion 2002 is brought back to the level of the lower portion 2004 of the transportation mechanism 2002 such that the upper and lower portions 2002, 2004 are transporting bills at substantially the same speed.

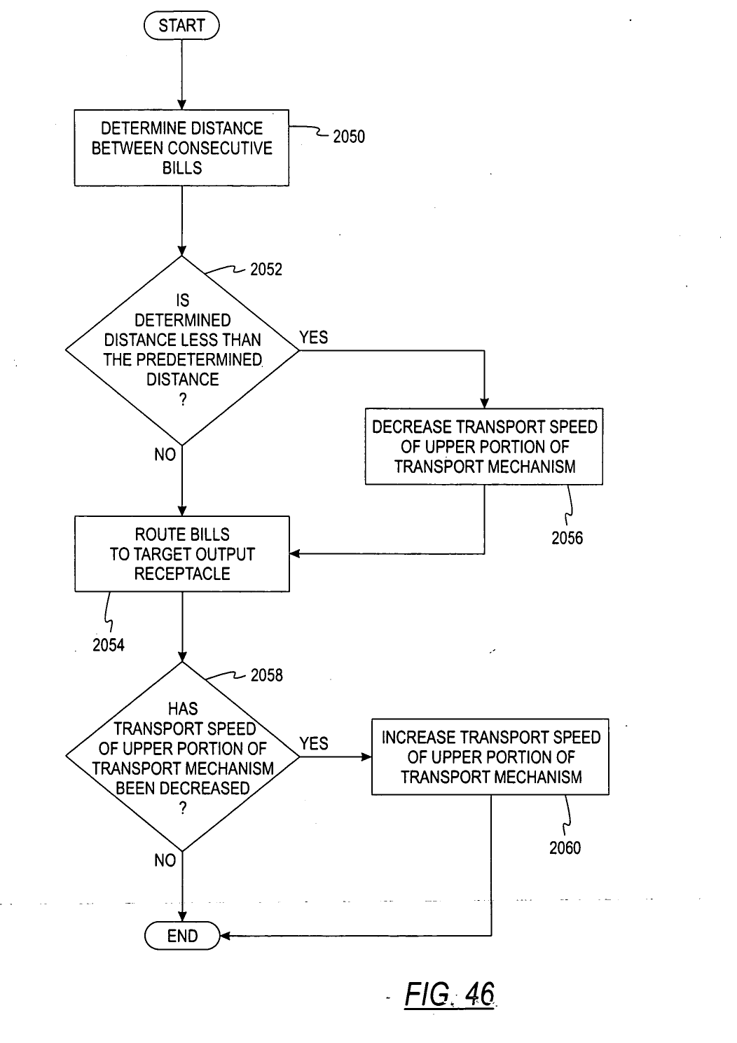

Referring also to FIG. 46, the operation of the currency processing device 10 is described according to one embodiment of the present invention. As currency bills are being processed, the evaluation region 247 determines the distance between consecutive bills at step 2050. That determined distance is compared to a threshold or minimum predetermined distance at step 2052. If the determined distance favorably compares (e.g., is equal to or exceeds), the bills are routed to a target output receptacle 217a,b (step 2054) based upon information determined by the evaluation unit at step 2054 consistent with the operating mode of the currency processing device 10. If, however, the determined distance does not favorably compare to the predetermined distance (e.g., is less than), the transportation speed of the upper portion 2002 of the transport mechanism 2020 is decreased at step 2056. The slowing of the transportation speed of the upper portion 2002 while maintaining the transportation speed of the lower portion 2004 increases the spacing between the consecutive bills as described above, which provides the diverter 260 with sufficient spacing so that the bills can be routed to the target output receptacles 217a,b at step 2054. If the transport speed of the upper portion 2002 of the transport mechanism has been decreased (step 2058), the transportation speed of the transport mechanism upper portion 2002 is then increased to transport bills at substantially the same speed as the transportation mechanism second portion 2004 at step 2060. Alternatively, the transport speed of the upper portion 2002 of the transport mechanism is maintained at the decreased speed if the evaluation unit determines distance between the previous consecutive bill (i.e., the second consecutive bill) and the subsequent consecutive (i.e., the third consecutive bill) bill does not favorably compare to the predetermined distance.

According to another embodiment of the present invention, upon receipt of a “proximity” error signal—when consecutive bills are transported too close to each other—generated by the evaluation unit 247, the controller 2030 then increases the operating speed of lower transport motor 2013 to increase the speed at which documents are transported in the lower portion 2004 of the transport mechanism. The speed of the upper transport motor 2012 is maintained. This difference in transportation speeds between the upper and lower portions 2002, 2004 of the transport mechanism, causes the downstream bill to be pulled away from the upstream bill. The separation between the two consecutive bills that were originally too closely spaced is now sufficient to allow the diverter to actuate for routing the bills between different output receptacles 217a,b. It is also contemplated that the currency processing device may contain more than two output receptacles, such as the currency processing devices illustrated in FIGS. 12a-c.

After the bill or bills triggering the error condition(s) that led to the increase in the transportation speed of the lower portion 2004 of the transport mechanism 2020 are delivered to the appropriate output receptacles 217a,b, the transportation speed to of the lower portion 2004 of the transport mechanism 2020 is decreased back to the speed at which it was transporting bills prior to being sped up. Put another way, the transport speed of the lower portion 2004 is brought back to the level of the upper portion 2002 of the transportation mechanism 2020 such that the upper and lower portions 2002, 2004 are transporting bills at substantially the same speed.

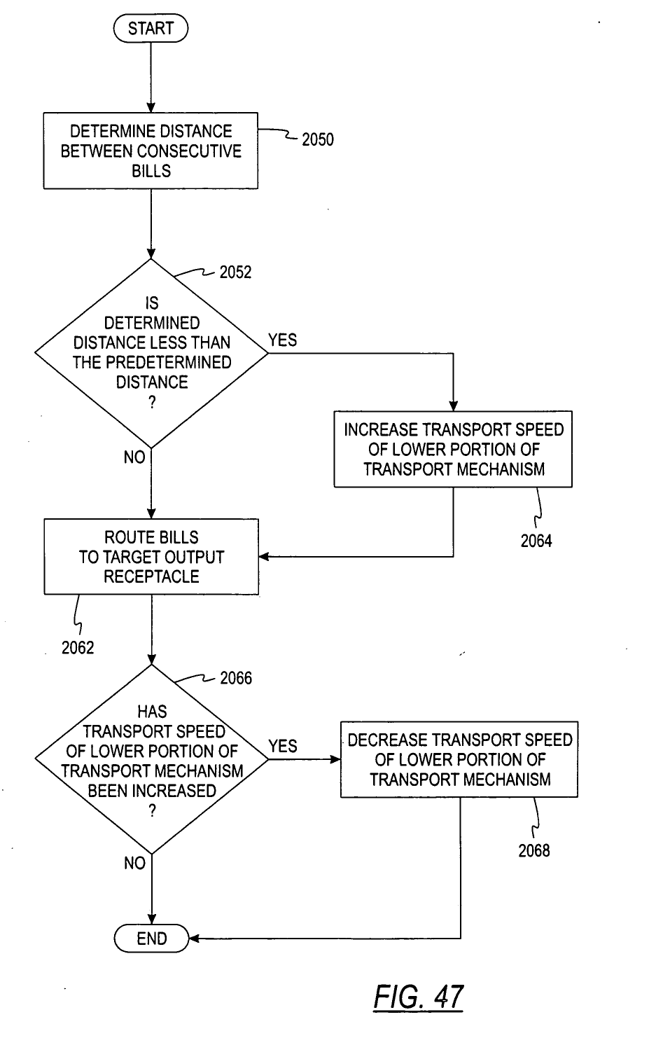

Turning to FIG. 47, the operation of the currency processing device 10 is described according to another embodiment of the present invention. As currency bills are being processed, the evaluation region 247 determines the distance between consecutive bills at step 2050. That determined distance is compared to a threshold or minimum predetermined distance at step 2052. If the determined distance favorably compares (e.g., is equal to or exceeds), the bills are routed to a target output receptacle 217a,b (step 2062) based upon information determined by the evaluation unit at step 2062 consistent with the operating mode of the currency processing device 10. If, however, the determined distance does not favorably compare to the predetermined distance (e.g., is less than), the transportation speed of the lower portion 2004 of the transport mechanism 2020 is increased at step 2064. The increasing of the transportation speed of the lower portion 2004 while maintaining the transportation speed of the upper portion 2002 increases the spacing between the consecutive bills as described above, which provides the diverter 260 with sufficient spacing so that the bills can be routed to the target output receptacles 217a,b at step 2062. If the transport speed of the lower portion 2004 of the transport mechanism 2020 has been increased (step 2066), the transportation speed of the transport mechanism lower portion 2004 is then decreased to transport bills at substantially the same speed as the transportation mechanism upper portion 2002 at step 2068. Alternatively, the transport speed of the lower portion 2004 of the transport mechanism is maintained at the increased speed if the evaluation unit determines distance between the previous consecutive bill (i.e., the second consecutive bill) and the subsequent consecutive (i.e., the third consecutive bill) bill does not favorably compare to the predetermined distance. It is also contemplated that the currency processing device may contain more than two output receptacles, such as the currency processing devices illustrated in FIGS. 12a-c.

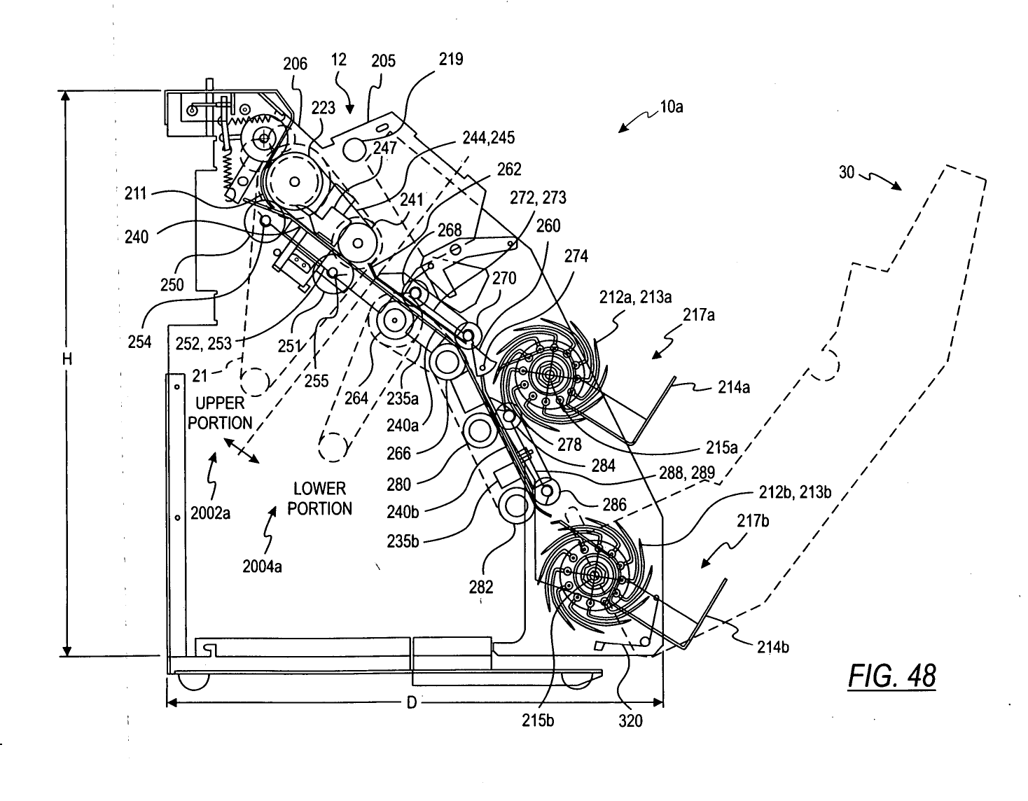

Referring now to FIG. 48, the transport mechanism of the two-pocket currency processing device 10a is adapted to vary the speed at which the currency bills are transported to the output receptacles 217a, b according to some embodiments of the present invention. The transport mechanism includes an upstream portion 2002a (“upper portion”) and a downstream portion 2004a (“lower portion”). The upper portion 2002a of the transport mechanism includes the portion of the transport mechanism upstream of the driven rollers 264. Thus, the upper portion 2002 includes driven rollers 241, and driven rollers 223, as well as the passive rollers corresponding to those driven rollers. The lower portion 2004a of the transport mechanism includes driven rollers 264, 266, 280, and 282, as well as the passive rollers corresponding to those driven rollers. Both the upstream portion 2002a and the downstream portion 2004a are located before the diverter 260.

The driven rollers 223 and 241 of the upper portion 2002a are driven by one or more upper transport motors, and the driven rollers 264, 266, 280, and 282 of the lower portion are driven by one or more lower transport motors. The upper transport motor and the lower transport motor operate independently of one another and are capable of moving bills through the upper and lower portions 2002a, 2004a, respectively, of the transport mechanism at different rates of speed. In embodiments where two or more transport motors drive a particular portion of the transport mechanism, the transport motors for that portion are electronically geared so that all the transport motors driving that portion move a bill through the portion of the transport mechanism at a substantially uniform rate of speed. In other embodiments, belts are used to drive the driven rollers when a single motor is used for the upper portion 2002a or for the lower transport portion 2004a.

Referring back to FIG. 45, the upper transport motor 2012 and the lower transport motor 2014 of the transport mechanism 2020 are coupled to a controller 2030 that controls the operation of each of the upper and lower transport motors 2012, 2014 for moving bills through the upper and lower portions 2002a, 2004a of the transport mechanism. According to one embodiment, the controller 2030 also controls the actuation of the diverter 260 for routing bills to either of the two output receptacles 217a,b. Upon the detection of certain conditions, it is necessary to operate the upper and lower portions 2002a, 2004a of the transport mechanism at different speeds. According to some embodiments, the controller 2030 is also the controller that controls the operation of the currency handling device 10a according to one embodiment of the present invention. Alternatively, the controller 2030 is a local controller that performs low-level operations relating to the operation of the transport mechanism 2020 and is coupled to a main processor, or central processing unit, that handles the high-level operations relating the overall operation of the currency handling device 10a.

As previously described, if consecutive bills are spaced apart but are still relatively close together, the evaluation unit 247 generates a “proximity” error condition error signal indicating that the bills are being transported too close to one another. The spacing between consecutive bills may then be adjusted in similar fashion to that previously described in connection with either FIG. 45 or FIG. 46. It is also contemplated that the currency processing device may contain more than two output receptacles, such as the currency processing devices illustrated in FIGS. 12a-c.

According to yet another alternate embodiment of the present invention, it is contemplated that a single output pocket currency processing device may be used. According to this alternate embodiment the transport mechanism includes an upstream portion (“upper portion”) and a downstream portion (“lower portion”). The upper portion and the lower portion are both located upstream of the evaluation region of the currency processing device. The controller determines the distance between consecutive currency bills and adjusts the relative speed of the upper and lower transport portions so that the lower portion's speed is greater than the upper portion's speed. This may be accomplished by decreasing the speed of the upper transport portion, increasing the speed of the lower transport portion, or some combination thereof. The device is thus capable of correcting the spacing of consecutive currency bills prior to the currency bills reaching the evaluation region, thus increasing the likelihood that the evaluation region will properly evaluate the currency bills. It is contemplated that the upper portion and the lower portion are controlled by separate transport motors so that the speeds of the upper portion and the lower portion of the transport mechanism may be independently controlled.

According to yet a further alternate embodiment of the present invention, it is contemplated that a multiple output pocket currency processing device may be used. According to this alternate embodiment the transport mechanism includes an upstream portion (“upper portion”) and a downstream portion (“lower portion”). The upper portion and the lower portion are both located upstream of the evaluation region of the currency processing device. This embodiment may somewhat resemble the embodiment depicted in FIG. 48, except both the upper portion 2002a and the lower portion 2004a would be located upstream the evaluation region 247. In order for both the upper and lower portion to be located upstream of the evaluation region, the transport path may require an extension. The controller determines the distance between consecutive currency bills and adjusts the relative speed of the upper and lower transport portions so that the lower portion's speed is greater than the upper portion's speed. This may be accomplished by decreasing the speed of the upper transport portion, increasing the speed of the lower transport portion, or some combination thereof. The device is thus capable of correcting the spacing of consecutive currency bills prior to the currency bills reaching the evaluation region, thus increasing the likelihood that the evaluation region will properly evaluate the currency bills. It is contemplated that the upper portion and the lower portion are controlled by separate transport motors so that the speeds of the upper portion and the lower portion of the transport mechanism may be independently controlled. It is further contemplated that the currency processing device may contain more than two output receptacles, such as the currency processing devices illustrated in FIGS. 12a-c.

While the invention is susceptible to various modifications and alternative forms, specific embodiments thereof have been shown by way of example in the drawings and described in detail herein. It should be understood, however, that it is not intended to limit the invention to the particular forms disclosed, but on the contrary, the intention is to cover all modifications, equivalents, and alternatives falling within the spirit and scope of the invention as defined by the appended claims.

1. A currency processing device, comprising:
an input receptacle adapted to receive a stack of currency bills to be processed;
a plurality of output receptacles for receiving currency bills that have been processed;
an evaluation unit for determining information concerning each of the currency bills;
a transportation mechanism adapted to transport each of the currency bills, one at a time, from the input receptacle past the evaluation unit to the plurality of output receptacles, the transportation mechanism including a first portion adapted to transport bills at a first speed and a second portion adapted to transport bills at a second speed; and
a controller adapted to control the operation of the of the transport mechanism, the controller being adapted to cause the transport mechanism to transport each of the bills to one of the plurality of output receptacles in response to the information concerning each of the bills determined by evaluation unit, the controller being adapted to cause the first portion and the second portion of the transport mechanism to transport bills at substantially the same speed when the distance between consecutive bills transported by the transport mechanism is at least a predetermined distance, the controller being adapted to cause the second portion of the transport mechanism to increase the speed at which bills are transported such that the second speed is more than the first speed when the evaluation unit determines when the distance between two consecutive bills transported by the transport mechanism is less than the predetermined distance.

2. The currency processing device of claim 1 wherein the predetermined distance is less than about one inch.

3. The currency processing device of claim 1 wherein the first portion of the transportation mechanism includes a plurality driven rollers for transporting each of the currency bills.

4. The currency processing device of claim 3 further comprising a first motor electrically coupled to the controller, the first motor being adapted to drive the driven rollers of the first portion of the transportation mechanism.

5. The currency processing device of claim 1 wherein the second portion of the transportation mechanism includes a plurality driven rollers for transporting each of the currency bills.

6. The currency processing device of claim 4 further comprising a second motor electrically coupled to the controller, the second motor being adapted to drive the driven rollers of the second portion of the transportation mechanism.

7. The currency processing device of claim 1 wherein the plurality of output receptacles comprises two output receptacles.

8. The currency processing device of claim 7 wherein the transport mechanism includes a diverter for directing bills into one of the two output receptacles.

9. The currency processing device of claim 8 wherein the diverter is included in the second portion of the transport mechanism.

10. The currency processing device of claim 8 wherein the diverter is located downstream of the first portion and the second portion of the transport mechanism.

11. The currency processing device of claim 1 wherein the evaluation unit is disposed along the first portion of the transport mechanism.

12. The currency processing device of claim 1 wherein the controller is adapted to cause the second portion of the transport mechanism to resume transporting bills at substantially the same speed as the first portion of the transport mechanism upon transporting the two consecutive bills separated by a distance of at least the predetermined distance past the evaluation unit.

13. The currency processing device of claim 1 wherein the first portion of the transport mechanism is upstream of the second portion of the transport mechanism.

14. The currency processing device of claim 1 wherein the plurality of output receptacles comprises three or more output receptacles.

15. A method for processing currency bills with a currency processing device, the currency processing device having a transport mechanism adapted to transport bills from an input receptacle past an evaluation unit to a plurality of output receptacles, the transport mechanism including a first portion adapted to transport bills at a first speed and a second portion adapted to transport bills at a second speed, the method comprising the acts of:
determining information concerning each of the bills with an evaluation unit;
designating a target output receptacle from a plurality of output receptacles for each of the bills based on the determined information for each bill;
transporting each bill to the designated target output receptacle;
determining the distance between consecutive currency bills being transported by the transport mechanism with the evaluation unit; and
increasing the speed at which the second portion of the transport mechanism transports bills when the determined distance between consecutive first and second currency bills transported by the transport mechanism is less than a predetermined distance.

16. The currency handling device of claim 15 comprising decreasing the speed at which the second portion of the transport mechanism transports bills after each of the first and second currency are transported to one of the plurality of output receptacles.

17. The method of claim 16 wherein decreasing comprises decreasing the speed at which the second portion of the transport mechanism transports bills such that the first and second portions of the transport mechanism transport bills at substantially the same speed.

18. The method of claim 15 wherein the predetermined distance is less than about one inch.

19. The method of claim 15 wherein increasing further comprises increasing the speed at which the second portion of the transport mechanism transports bills when the designated target output receptacle for the first currency bill is different than the designated target output receptacle for the second currency bill.

20. A currency processing device, comprising:
an input receptacle adapted to receive a stack of currency bills to be processed;
a first output receptacle and a second output receptacle for receiving currency bills that have been processed;
a transport path extending between the input receptacle and the first and second output receptacles along which the currency bills are transported;
an evaluation unit disposed along the transport path for determining information concerning each of the currency bills;
a transportation mechanism adapted to transport each of the currency bills, one at a time, from the input receptacle past the evaluation unit to the first and second output receptacles, the transportation mechanism including a first portion adapted to transport bills at a first speed and a second portion adapted to transport bills at a second speed;
a diverter disposed along the transport path between the first portion of the transport mechanism and the second portion of the transport mechanism, the diverter being adapted to divert bills being transported from the transport path toward the first output receptacle;
a controller adapted to control the operation of the of the transport mechanism and the diverter, the controller being adapted to cause the transport mechanism to transport each of the currency bills to one of the first and second output receptacles in response to the information concerning each of the currency bills determined by evaluation unit, the controller being adapted to cause the first portion and the second portion of the transport mechanism to transport bills at substantially the same speed when the distance between consecutive bills transported by the transport mechanism is at least a predetermined distance, the controller being adapted to cause the second portion of the transport mechanism to increase the speed at which bills are transported such that the first speed is less than the second speed when the evaluation unit determines that the distance between two consecutive bills transported by the transport mechanism is less than the predetermined distance.

21. The currency processing device of claim 20 wherein the predetermined distance is less than about one inch.

22. The currency processing device of claim 20 wherein the first portion of the transportation mechanism includes a plurality driven rollers for transporting each of the currency bills.

23. The currency processing device of claim 22 further comprising a first motor electrically coupled to the controller, the first motor being adapted to drive the driven rollers of the first portion of the transportation mechanism.

24. The currency processing device of claim 20 wherein the second portion of the transportation mechanism includes a plurality driven rollers for transporting each of the currency bills.

25. The currency processing device of claim 24 further comprising a second motor electrically coupled to the controller, the second motor being adapted to drive the driven rollers of the second portion of the transportation mechanism.

26. The currency processing device of claim 20 wherein the plurality of output receptacles comprises two output receptacles.

27. The currency processing device of claim 26 wherein the transport mechanism includes a diverter for directing bills into one of the two output receptacles.

28. The currency processing device of claim 27 wherein the diverter is included in the second portion of the transport mechanism.

29. The currency processing device of claim 20 wherein the evaluation unit is disposed along the first portion of the transport mechanism.

30. The currency processing device of claim 20 wherein the controller is adapted to cause the second portion of the transport mechanism to resume transporting bills at substantially the same speed as the first portion of the transport mechanism upon transporting the two consecutive bills separated by a distance of at least the predetermined distance past the evaluation unit.

31. The currency processing device of claim 20 wherein the first portion of the transport mechanism is upstream of the second portion of the transport mechanism.

32. The currency processing device of claim 20 wherein the first portion of the transport mechanism is adapted to transport bills, one at a time, from the input receptacle to the second portion of the transport mechanism

33. The currency processing device of claim 20 wherein the second portion of the transport mechanism is adapted to receive bill from the first portion of the transport mechanism and to transport bills to the second output receptacle.

34. A currency processing device, comprising:
an input receptacle adapted to receive a stack of currency bills to be processed;
a plurality of output receptacles for receiving currency bills that have been processed;
an evaluation unit for determining information concerning each of the currency bills;
a transportation mechanism adapted to transport each of the currency bills, one at a time, from the input receptacle past the evaluation unit to the plurality of output receptacles, the transportation mechanism including a first portion adapted to transport bills at a first speed and a second portion adapted to transport bills at a second speed; and
a controller adapted to control the operation of the of the transport mechanism, the controller being adapted to cause the transport mechanism to transport each of the bills to one of the plurality of output receptacles in response to the information concerning each of the bills determined by evaluation unit, the controller being adapted to cause the first portion and the second portion of the transport mechanism to transport bills at substantially the same speed when the distance between consecutive bills transported by the transport mechanism is at least a predetermined distance, the controller being adapted to cause the first portion of the transport mechanism to decrease the speed at which bills are transported and to cause the second portion of the transport mechanism to increase the speed at which bills are transported such that the second speed is more than the first speed when the evaluation unit determines the distance between two consecutive bills transported by the transport mechanism is less than the predetermined distance.

35. The currency processing device of claim 34 further comprising a diverter, the diverter diverting bills to one of the plurality of output receptacles and being located downstream of the first and second portion of the transport mechanism.
